(19) United States
(12) Patent Application Publication
(10) Pub. No.: US 2026/0213667 A1
(43) Pub. Date: Jul. 23, 2026

(54) HIGH-FREQUENCY CHAIN-TYPE MICRO INVERTER, AND SIGNAL MODULATION METHOD AND APPARATUS THEREFOR

(71) Applicants: SHANGHAI CHINT POWER SYSTEMS CO., LTD., Shanghai (CN); XI'AN JIAOTONG UNIVERSITY, Shaanxi (CN)

(72) Inventors: Xuewen LI, Shaanxi (CN); Jia LIU, Shaanxi (CN); Yue WANG, Shaanxi (CN); Xueqian CAO, Shanghai (CN); Bo YANG, Shanghai (CN); Xu ZHOU, Shanghai (CN); Jinjun LIU, Shaanxi (CN); Yulin ZHANG, Shanghai (CN)

(73) Assignees: SHANGHAI CHINT POWER SYSTEMS CO., LTD., Shanghai (CN); XI'AN JIAOTONG UNIVERSITY, Shaanxi (CN)

(21) Appl. No.: 19/144,824

(22) PCT Filed: Apr. 25, 2024
(86) PCT No.: PCT/CN2024/089839

§ 371 Date: Jun. 30, 2025

(30) Foreign Application Priority Data
Apr. 26, 2023 (CN) 202310465551.4
Mar. 19, 2024 (CN) 202410315202.9
Mar. 19, 2024 (CN) 202410315204.8
Mar. 19, 2024 (CN) 202410315207.1

(51) Int. Cl. H02M 3/335; H02M 1/00; H02M 1/14

(52) U.S. Cl. CPC H02M 3/33573; H02M 1/0012; H02M 1/0054; H02M 1/14; H02M 3/33576

(57) ABSTRACT

A high-frequency-link micro inverter, and a signal modulation method and apparatus for a high-frequency-link micro inverter. The method is applied to the high-frequency-link micro inverter and includes: forming an intermediate signal according to a carrier signal and a modulation signal; obtaining a reference signal according to the carrier signal; and forming a drive signal according to the carrier signal, the reference signal, and the intermediate signal, where the drive signal is used for driving a primary-side full-bridge circuit and a secondary-side conversion circuit to cause the high-frequency-link micro inverter to output at least a two-phase alternating-current voltage.

This application claims priority to Chinese Patent Application No. 202310465551.4 filed with the China National Intellectual Property Administration (CNIPA) on Apr. 26, 2023, Chinese Patent Application No. 202410315207.1 filed with the CNIPA on Mar. 19, 2024, Chinese Patent Application No. 202410315202.9 filed with the CNIPA on Mar. 19, 2024, and Chinese Patent Application No. 202410315204.8 filed with the CNIPA on Mar. 19, 2024, the disclosures of which are incorporated herein by reference in their entireties.

### TECHNICAL FIELD

Embodiments of the present application relate to the field of photovoltaic power generation, for example, a high-frequency-link micro inverter, and a signal modulation method and apparatus for a high-frequency-link micro inverter.

### BACKGROUND

When the drive signal output by the existing signal modulation method for a single-stage high-frequency-link micro inverter drives a topology of the single-stage high-frequency-link micro inverter, a zero voltage switching (ZVS) loss may occur, which leads to a narrow zero current switching operational range and a low utilization rate of transformer windings in such a single-stage high-frequency-link micro inverter. FIG. 1 is a structural diagram of a single-stage full-bridge high-frequency-link inverter in the related art. As shown in FIG. 1, the single-stage full-bridge high-frequency-link inverter achieves boost conversion through a transformer. When the range of an input voltage is wide, the transformer needs to be set to have a large transformation ratio. Under such a condition, the parasitic parameters of the transformer increase, inducing additional efficiency losses and thus degrading the efficiency of the single-stage full-bridge high-frequency-link inverter. Furthermore, the transformation ratio of the transformer becomes nonadjustable. Therefore, a stage of the boost circuit may be added on the basis of the topology of the single-stage full-bridge high-frequency-link inverter to form a two-stage boost structure so that the requirements for the transformation ratio of the transformer can be lowered. However, topology complexity and overall costs of the single-stage full-bridge high-frequency-link inverter are increased. Moreover, the instantaneous power imbalance between the direct current and alternating current sides of the high-frequency-link inverter is raised, resulting in the twice-power-frequency power ripple on the direct current side. In the related art, a high-capacity electrolytic capacitor may be connected to the direct current side to suppress the twice-power-frequency ripple. However, the bulky size and low reliability of the electrolytic capacitor inevitably cause an increase in the volume and a reduction in the service life of the high-frequency-link inverter.

The topology of a conventional half-wave high-frequency-link inverter (shown in FIG. 36) includes a high-frequency transformer. A full-bridge conversion topology circuit is connected to the primary-side side of the high-frequency transformer, a rectifier circuit is connected to the secondary-side side, and an output is generated through an LC filter circuit. In the half-wave high-frequency-link inverter shown in FIG. 36, only the energy of the high-frequency square wave generated on the primary-side side during the positive half-cycle is transferred to the output side, resulting in reduced voltage utilization efficiency.

### SUMMARY

The present application provides a high-frequency-link micro inverter and a signal modulation method and apparatus for a high-frequency-link micro inverter to solve the problems of a narrow zero current switching operational range and a low voltage utilization efficiency in the existing high-frequency-link micro inverter and effectively suppress the twice-power-frequency power ripple, thereby enabling both grid-connected and off-grid operation modes and split-phase output.

An embodiment of the present application provides a high-frequency-link micro inverter. The high-frequency-link micro inverter includes a primary-side full-bridge circuit, a transformer module, and a secondary-side conversion circuit. The primary-side full-bridge circuit is connected to a primary-side winding of the transformer module, and the primary-side full-bridge circuit is configured to provide a first voltage signal for the primary-side winding of the transformer module. The transformer module is configured to perform second-stage voltage conversion on the first voltage signal. The secondary-side conversion circuit is connected to a secondary-side winding of the transformer module, and the secondary-side conversion circuit is configured to perform waveform conversion on a voltage signal output by the secondary-side winding of the transformer module.

An embodiment of the present application provides a signal modulation method for a high-frequency-link micro inverter. The signal modulation method for a high-frequency-link micro inverter is applied to the high-frequency-link micro inverter and includes the following steps: an intermediate signal is formed according to a carrier signal and a modulation signal, a reference signal according to the carrier signal is obtained, and a drive signal is formed according to the carrier signal, the reference signal, and the intermediate signal, where the drive signal is used for driving the primary-side full-bridge circuit and the secondary-side conversion circuit to cause the high-frequency-link micro inverter to output at least a two-phase alternating-current voltage.

An embodiment of the present application provides a signal modulation apparatus for a high-frequency-link micro inverter. The signal modulation apparatus for a high-frequency-link micro inverter is connected to the high-frequency-link micro inverter and includes an intermediate signal determination module, a reference signal determination module, and a drive signal generation module. The intermediate signal determination module is configured to form an intermediate signal according to a carrier signal and a modulation signal. The reference signal determination module is configured to obtain a reference signal according to the carrier signal. The drive signal generation module is configured to generate a drive signal according to the carrier signal, the reference signal, and the intermediate signal, where the drive signal is used for driving the primary-side full-bridge circuit and the secondary-side conversion circuit to cause the high-frequency-link micro inverter to output at least a two-phase alternating-current voltage.

### BRIEF DESCRIPTION OF DRAWINGS

FIG. 1 is a structural diagram of a single-stage full-bridge high-frequency-link inverter in the related art;

FIG. 2 is a flowchart of a signal modulation method for a high-frequency-link micro inverter according to an embodiment of the present application;

FIG. 3 is a structural diagram of a high-frequency-link micro inverter according to an embodiment of the present application;

FIG. 4 is a schematic diagram of the waveforms of drive signals of the structure of a high-frequency-link micro inverter according to an embodiment of the present application;

FIG. 5 is a flowchart of another signal modulation method for a high-frequency-link micro inverter according to an embodiment of the present application;

FIG. 6 is a flowchart of another signal modulation method for a high-frequency-link micro inverter according to an embodiment of the present application;

FIG. 7 is a flowchart of another signal modulation method for a high-frequency-link micro inverter according to an embodiment of the present application;

FIG. 8 is a flowchart of another signal modulation method for a high-frequency-link micro inverter according to an embodiment of the present application;

FIG. 9 is a flowchart of another signal modulation method for a high-frequency-link micro inverter according to an embodiment of the present application;

FIG. 10 is a flowchart of another signal modulation method for a high-frequency-link micro inverter according to an embodiment of the present application;

FIG. 11 is a flowchart of another signal modulation method for a high-frequency-link micro inverter according to an embodiment of the present application;

FIG. 12 is a schematic diagram of the signal waveforms during a switch cycle under a signal modulation method for a high-frequency-link micro inverter according to an embodiment of the present application;

FIG. 13A is a structural diagram of a high-frequency-link micro inverter in an operating mode 1 [t₀-t₁] according to an embodiment of the present application;

FIG. 13B is a structural diagram of a high-frequency-link micro inverter in an operating mode 2 [t₁-t₂] according to an embodiment of the present application;

FIG. 13C is a structural diagram of a high-frequency-link micro inverter in an operating mode 3 [t₂ -t₃] according to an embodiment of the present application;

FIG. 13D is a structural diagram of a high-frequency-link micro inverter in an operating mode 4 [t₃ -t₄] according to an embodiment of the present application;

FIG. 13E is a structural diagram of a high-frequency-link micro inverter in an operating mode 5 [t₄ -t₅] according to an embodiment of the present application;

FIG. 13F is a structural diagram of a high-frequency-link micro inverter in an operating mode 6 [t₅ -t₆] according to an embodiment of the present application;

FIG. 13G is a structural diagram of a high-frequency-link micro inverter in an operating mode 7 [t₆ -t₇] according to an embodiment of the present application;

FIG. 13H is a structural diagram of a high-frequency-link micro inverter in an operating mode 8 [t₇-t₈] according to an embodiment of the present application;

FIG. 13I is a structural diagram of a high-frequency-link micro inverter in an operating mode 9 [t₈ -t₉] according to an embodiment of the present application;

FIG. 14 is a schematic diagram of related simulation waveforms under a signal modulation method for a high-frequency-link micro inverter according to an embodiment of the present application;

FIG. 15 is a schematic diagram of soft switching waveforms under a signal modulation method for a high-frequency-link micro inverter according to an embodiment of the present application;

FIG. 16 is a flowchart of a signal modulation method for a high-frequency-link micro inverter according to an embodiment of the present application;

FIG. 17 is a structural diagram of a high-frequency-link micro inverter according to an embodiment of the present application;

FIG. 18 is a structural diagram of another high-frequency-link micro inverter according to an embodiment of the present application;

FIG. 19 is a structural diagram of another high-frequency-link micro inverter according to an embodiment of the present application;

FIG. 20 is a structural diagram of another high-frequency-link micro inverter according to an embodiment of the present application;

FIG. 21 is a schematic diagram of the waveforms of drive signals of a high-frequency-link micro inverter according to an embodiment of the present application;

FIG. 22 is a flowchart of another signal modulation method for a high-frequency-link micro inverter according to an embodiment of the present application;

FIG. 23 is a flowchart of another signal modulation method for a high-frequency-link micro inverter according to an embodiment of the present application;

FIG. 24 is a flowchart of another signal modulation method for a high-frequency-link micro inverter according to an embodiment of the present application;

FIG. 25 is a flowchart of another signal modulation method for a high-frequency-link micro inverter according to an embodiment of the present application;

FIG. 26 is a schematic diagram of the waveforms of different signals of a high-frequency-link micro inverter during a positive half-cycle of a power frequency voltage according to an embodiment of the present application;

FIG. 27 is a structural diagram of a high-frequency-link micro inverter in an operating mode 1 [t₀-t₁] according to an embodiment of the present application;

FIG. 28 is a structural diagram of a high-frequency-link micro inverter in an operating mode 2 [t₁-t₂] according to an embodiment of the present application;

FIG. 29 is a structural diagram of a high-frequency-link micro inverter in an operating mode 3 [t₂ -t₃] according to an embodiment of the present application;

FIG. 30 is a structural diagram of a high-frequency-link micro inverter in an operating mode 4 [t₃ -t₄] according to an embodiment of the present application;

FIG. 31 is a structural diagram of a high-frequency-link micro inverter in an operating mode 5 [t₄ -t₅] according to an embodiment of the present application;

FIG. 32 is a structural diagram of a high-frequency-link micro inverter in an operating mode 6 [t₅ -t₆] according to an embodiment of the present application;

FIG. 33 is a structural diagram of a high-frequency-link micro inverter in an operating mode 7 [t₆ -t₇] according to an embodiment of the present application;

FIG. 34 is a schematic diagram of waveform simulation of a high-frequency-link micro inverter according to an embodiment of the present application;

FIG. 35 is a structural diagram of a signal modulation apparatus for a high-frequency-link micro inverter according to an embodiment of the present application;

FIG. 36 is a structural diagram of a conventional half-wave high-frequency-link inverter in the related art;

FIG. 37 is a structural diagram of a high-frequency-link micro inverter of a first form according to an embodiment of the present application;

FIG. 38 shows the state of the circuit topology shown in FIG. 37 when the circuit topology is grid-connected;

FIG. 39 shows the state of the circuit topology shown in FIG. 37 when the circuit topology is off-grid and split-phase loaded;

FIG. 40 is a structural diagram of a high-frequency-link micro inverter of a second form according to an embodiment of the present application; and

FIG. 40 is a structural diagram of a high-frequency-link micro inverter of a third form according to an embodiment of the present application; and

FIG. 41 is a structural diagram of another high-frequency-link micro inverter according to an embodiment of the present application.

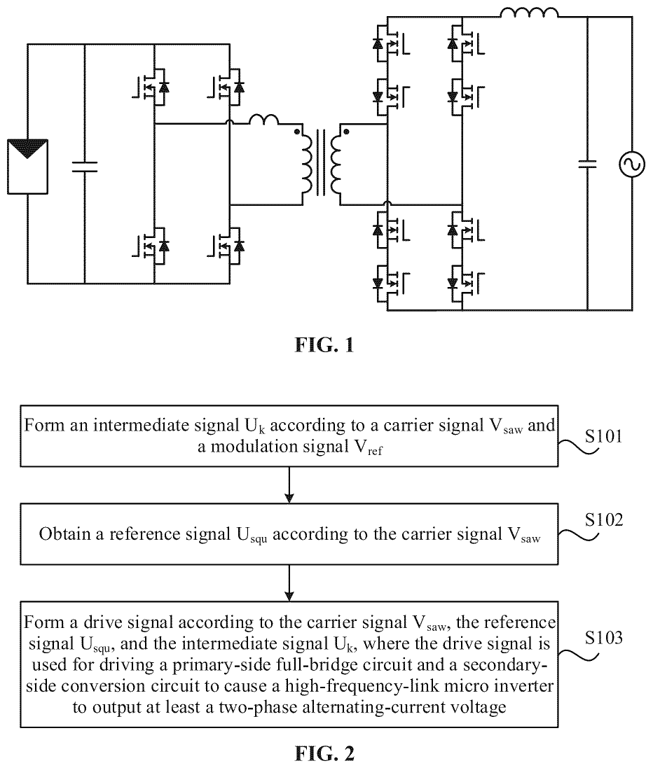

### DETAILED DESCRIPTION

The present application is described below in conjunction with drawings and embodiments. It is to be understood that the embodiments described herein are intended to illustrate the present application and not to limit the present application. Additionally, it is to be noted that for ease of description, only part of the structures related to the present application are illustrated in the drawings.

### Embodiment One

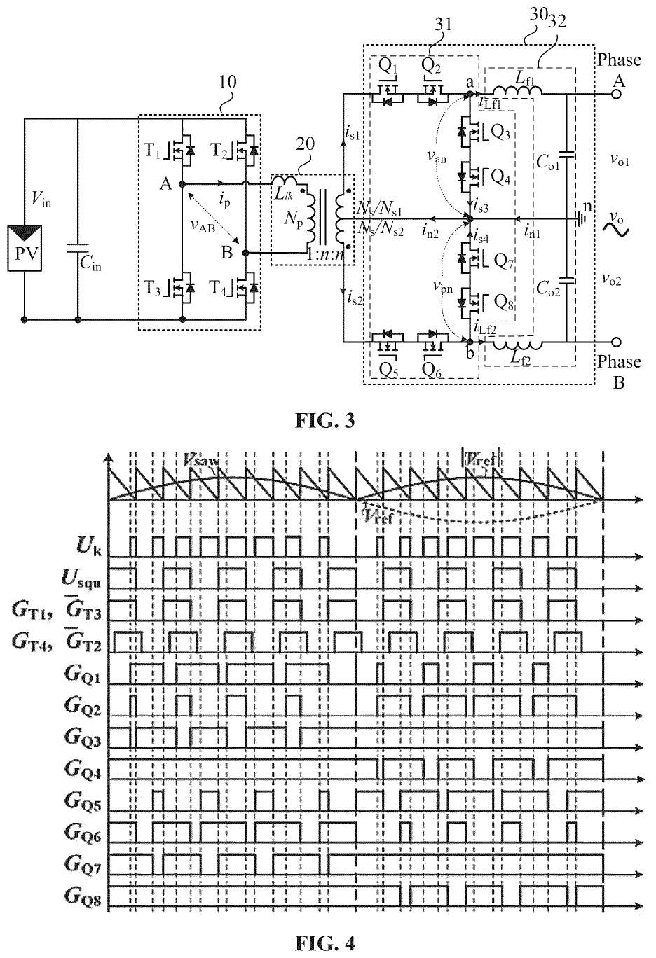

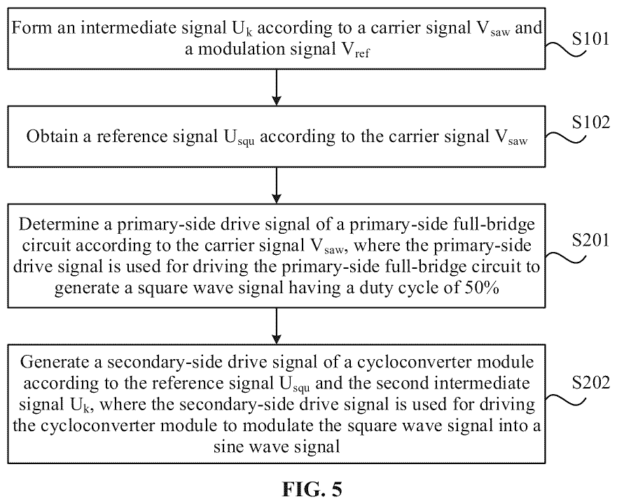

FIG. 2 is a flowchart of a signal modulation method for a high-frequency-link micro inverter according to an embodiment of the present application. FIG. 3 is a structural diagram of the high-frequency-link micro inverter according to an embodiment of the present application. FIG. 4 is a schematic diagram of the waveforms of drive signals of the high-frequency-link micro inverter according to an embodiment of the present application.

An embodiment of the present application provides a signal modulation method for a high-frequency-link micro inverter. The method is performed by a signal modulation apparatus for a high-frequency-link micro inverter, and the signal modulation apparatus for a high-frequency-link micro inverter is connected to the high-frequency-link micro inverter. Referring to FIG. 3, the high-frequency-link micro inverter includes a primary-side full-bridge circuit 10, a transformer module 20, and a secondary-side conversion circuit 30. The primary-side full-bridge circuit 10 is connected to the primary-side winding Nₚ of the transformer module 20. The secondary-side conversion circuit 30 is connected to the secondary-side winding Nₛ of the transformer module 20.

In conjunction with FIGS. 2 to 4, the signal modulation method for a high-frequency-link micro inverter in the embodiment of the present application includes steps S101 to S103.

In S101, an intermediate signal Uₖ is formed according to a carrier signal V_{saw} and a modulation signal V_{ref}.

The carrier signal may include a triangular wave signal, a sawtooth wave signal or the like. The modulation signal may include a sine wave signal. An intermediate signal is modulated according to the carrier signal and the modulation signal. The intermediate signal may be a square wave signal with different pulse widths.

In S102, a reference signal U_{squ} is obtained according to the carrier signal V_{saw}.

The reference signal U_{squ} is a reference waveform of a drive signal of the secondary-side conversion circuit 30 connected to the secondary-side winding of the transformer module 20. For example, the reference signal U_{squ} may be obtained by performing a frequency division by two on the carrier signal V_{saw}.

In S103, a drive signal is formed according to the carrier signal V_{saw},the reference signal U_{squ}, and the intermediate signal Uₖ, where the drive signal is used for driving the primary-side full-bridge circuit 10 and the secondary-side conversion circuit 30 to cause the high-frequency-link micro inverter to output at least a two-phase alternating-current voltage.

Since the primary-side full-bridge circuit 10 and the secondary-side conversion circuit 30 on the side of the secondary-side winding of the transformer module 20 in the topology of the high-frequency-link micro inverter require different drive signals, a primary-side drive signal for driving the primary-side full-bridge circuit 10 and a secondary-side drive signal for driving the secondary-side conversion circuit 30 are generated according to the carrier signal V_{saw},the reference signal U_{squ}, and the intermediate signal Uₖ.The drive signals in the embodiment herein may drive the primary-side full-bridge circuit 10 and the secondary-side conversion circuit 30 to work so that the high-frequency-link micro inverter outputs at least a two-phase alternating current voltage.

In the signal modulation method for a high-frequency-link micro inverter in the embodiment herein, an intermediate signal Uₖ may be formed according to a carrier signal V_{saw} and a modulation signal V_{ref}, a reference signal U_{squ} may be obtained according to the carrier signal V_{saw},and a drive signal may be generated according to the carrier signal V_{saw},the reference signal U_{squ}, and the intermediate signal Uₖ, where the drive signal may be used for driving the primary-side full-bridge circuit 10 and the secondary-side conversion circuit 30 to work to cause the high-frequency-link micro inverter to output at least a two-phase alternating-current voltage, thereby improving the winding utilization rate of the transformer module. The signal modulation method for a high-frequency-link micro inverter is applied to the topology of the high-frequency-link micro inverter. The drive signal generated in the signal modulation method for a high-frequency-link micro inverter in the embodiment herein enables the primary-side switching transistors in the primary-side full-bridge circuit 10 to achieve full-range zero voltage switching (ZVS), thereby achieving primary-side circulating current elimination, obtaining a voltage spike suppression capability, and improving the energy transmission efficiency and power density of the high-frequency-link micro inverter. Through the signal modulation method for a high-frequency-link micro inverter in the embodiment herein, the problems of a narrow ZCS operational range and a low winding utilization rate of the transformer module caused when the drive signal generated in the existing signal modulation method for a single-stage high-frequency-link micro inverter drives the high-frequency-link micro inverter are solved.

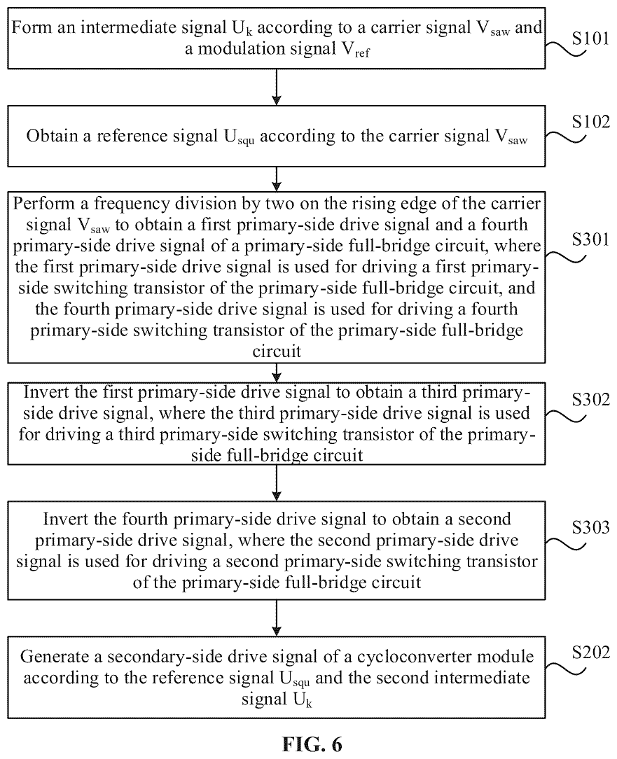

Optionally, FIG. 5 is a flowchart of another signal modulation method for a high-frequency-link micro inverter according to an embodiment of the present application. On the basis of the preceding embodiment and in conjunction with FIGS. 3 and 5, the secondary-side conversion circuit 30 includes a cycloconverter module 31 and a filter module 32. The cycloconverter module 31 is connected to the secondary-side winding Nₛ of the transformer module 20, and the filter module 32 is connected to the cycloconverter module 31. The signal modulation method for a high-frequency-link micro inverter in the embodiment of the present application includes steps S101, S102, and S201.

In S101, an intermediate signal Uₖ is formed according to a carrier signal V_{saw} and a modulation signal V_{ref}.

In S102, a reference signal U_{squ} is obtained according to the carrier signal V_{saw}.

In S201, a primary-side drive signal of the primary-side full-bridge circuit 10 is determined according to the carrier signal V_{saw},where the primary-side drive signal is used for driving the primary-side full-bridge circuit 10 to generate a square wave signal having a duty cycle of 50%.

A divide-by-two processing or a corresponding logical operation is performed according to the carrier signal V_{saw} to calculate a primary-side drive signal of the primary-side full-bridge circuit 10. The primary-side drive signal may drive the primary-side full-bridge circuit 10 to generate a square wave signal having a duty cycle of 50%, thereby reducing the primary-side circulating current of the primary-side full-bridge circuit 10 and obtaining a voltage spike suppression capability.

In S202, a secondary-side drive signal of the cycloconverter module 31 is generated according to the reference signal U_{squ} and the second intermediate signal Uₖ, where the secondary-side drive signal is used for driving the cycloconverter module 31 to modulate the square wave signal into a sine wave signal.

A logical calculation is performed on the reference signal U_{squ} and the second intermediate signal Uₖ to generate a secondary-side drive signal of the cycloconverter module 31. Since the secondary-side drive signal is transmitted to the control terminal of the cycloconverter module 31, the cycloconverter module 31 modulates a square wave signal transmitted from the primary-side winding Nₚ of the transformer module 20 into a sine wave signal.

For example, continuing to refer to FIG. 3, the cycloconverter module 31 may include a double-half-wave cycloconverter module. The phase A and the phase B output by the cycloconverter module 31 through the filter module 32 may be loaded separately or simultaneously and may simultaneously output two voltage levels with an identical amplitude and opposite phases: the voltage vₒ₁(or vₒ₂) of the phase A (or the phase B) to ground and the inter-phase voltage vₒ between the phases A and B, where the amplitude of the voltage of the phase A (or the phase B) to ground equals half of the amplitude of the inter-phase voltage between the phases A and B.

Optionally, FIG. 6 is a flowchart of another signal modulation method for a high-frequency-link micro inverter according to an embodiment of the present application. On the basis of the preceding embodiments, continuing to refer to FIG. 3, the primary-side full-bridge circuit 10 includes a first primary-side switching transistor T₁, a second primary-side switching transistor T₂, a third primary-side switching transistor T3, and a fourth primary-side switching transistor T₄. The first primary-side switching transistor T₁ and the third primary-side switching transistor T₃ are connected to a series bridge arm whose midpoint is a first node A, the second primary-side switching transistor T₂ and the fourth primary-side switching transistor T₄ are connected to a series bridge arm whose midpoint is a second node B, and the primary-side winding Nₚ of the transformer module 20 is connected to the first node A and the second node B.

In conjunction with FIGS. 2 to 6, the signal modulation method for a high-frequency-link micro inverter in the embodiment of the present application includes steps S101 to S102, S301 to S303, and S202.

In S101, an intermediate signal Uₖ is formed according to a carrier signal V_{saw} and a modulation signal V_{ref}.

In S102, a reference signal U_{squ} is obtained according to the carrier signal V_{saw}.

In S301, the rising edge of the carrier signal V_{saw} is subjected to a frequency division by two to obtain a first primary-side drive signal G_{T1} and a fourth primary-side drive signal G_{T4} of the primary-side full-bridge circuit 10, where the first primary-side drive signal G_{T1} is used for driving the first primary-side switching transistor T₁ of the primary-side full-bridge circuit 10, and the fourth primary-side drive signal G_{T4} is used for driving the fourth primary-side switching transistor T₄ of the primary-side full-bridge circuit 10.

In S302, the first primary-side drive signal G_{T1} is inverted to obtain a third primary-side drive signal G_{T3}, where the third primary-side drive signal G_{T3} is used for driving the third primary-side switching transistor T₃ of the primary-side full-bridge circuit 10.

In S303, the fourth primary-side drive signal G_{T4} is inverted to obtain a second primary-side drive signal G_{T2}, where the second primary-side drive signal G_{T2} is used for driving the second primary-side switching transistor T₂ of the primary-side full-bridge circuit 10.

In S202, a secondary-side drive signal of the cycloconverter module 31 is generated according to the reference signal U_{squ} and the second intermediate signal Uₖ.

It is to be noted that the signal obtained by inverting the second primary-side drive signal G_{T2} and the signal obtained by inverting the third primary-side drive signal G_{T3} are illustrated in FIG. 3 as an example, which is not limited herein.

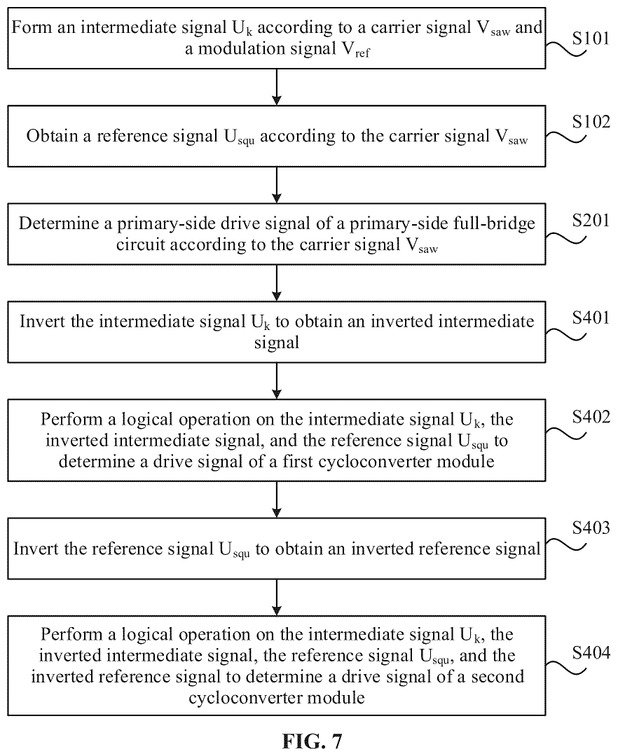

Optionally, FIG. 7 is a flowchart of another signal modulation method for a high-frequency-link micro inverter according to an embodiment of the present application. On the basis of the preceding embodiments, continuing to refer to FIG. 3, the secondary-side winding Nₛ of the transformer module 20 includes a first secondary-side winding Nₛ₁ and a second secondary-side winding Nₛ₂ that are connected in series, and the cycloconverter module 31 includes a first cycloconverter module and a second cycloconverter module. The first cycloconverter module is connected to the first secondary-side winding Nₛ₁, the second cycloconverter module is connected to the second secondary-side winding Nₛ₂, and the first secondary-side winding Nₛ₁ and the second secondary-side winding Nₛ₂ are connected to a ground terminal. It is to be noted that the first secondary-side winding Nₛ₁ and the second secondary-side winding Nₛ₂ may be connected in series, and the first secondary-side winding Nₛ₁ and the second secondary-side winding Nₛ₂ may be two secondary-side windings of a single three-winding transformer or may be secondary-side windings of two discrete double-winding transformers, which is not limited herein.

The first cycloconverter module is a half-wave cycloconverter module. The second cycloconverter module is a half-wave cycloconverter module.

In conjunction with FIGS. 3, 4, and 7, the signal modulation method for a high-frequency-link micro inverter in the embodiment of the present application includes steps S101 to S102, S201, and S401 to S404.

In S101, an intermediate signal Uₖ is formed according to a carrier signal V_{saw} and a modulation signal V_{ref}.

In S102, a reference signal U_{squ} is obtained according to the carrier signal V_{saw}.

In S201, a primary-side drive signal of the primary-side full-bridge circuit 10 is determined according to the carrier signal V_{saw}.

In S401, the intermediate signal Uₖ is inverted to obtain an inverted intermediate signal.

In S402, a logical operation is performed on the intermediate signal Uₖ, the inverted intermediate signal, and the reference signal U_{squ} to determine a drive signal of the first cycloconverter module.

In S403, the reference signal U_{squ} is inverted to obtain an inverted reference signal.

In S404, a logical operation is performed on the intermediate signal Uₖ, the inverted intermediate signal, the reference signal U_{squ}, and the inverted reference signal to determine a drive signal of the second cycloconverter module.

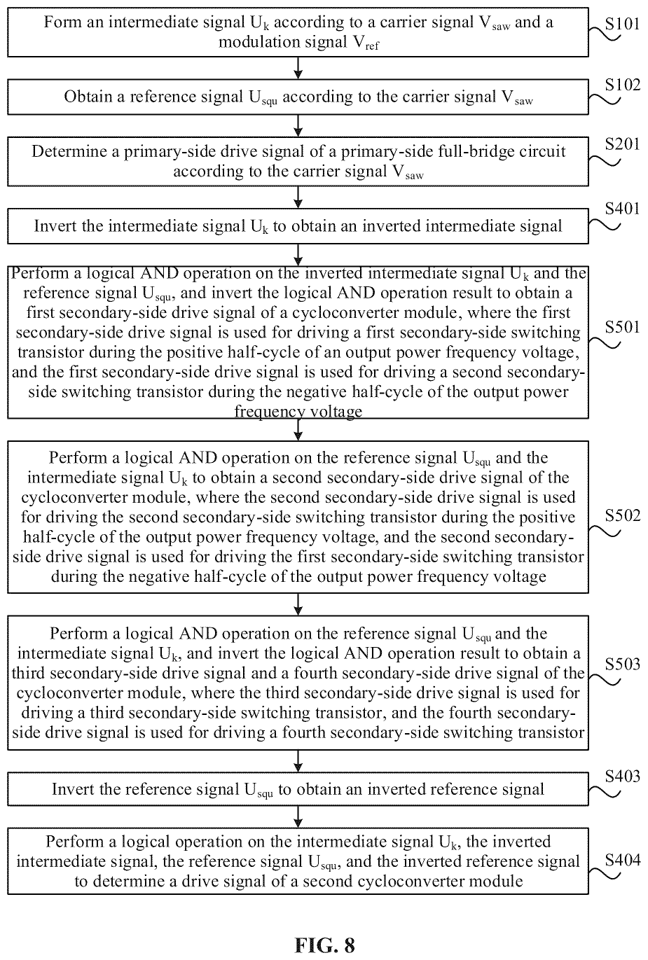

Optionally, FIG. 8 is a flowchart of another signal modulation method for a high-frequency-link micro inverter according to an embodiment of the present application. On the basis of the preceding embodiments, continuing to refer to FIG. 3, the first cycloconverter module includes a first secondary-side switching transistor Q₁, a second secondary-side switching transistor Q₂, a third secondary-side switching transistor Q₃, and a fourth secondary-side switching transistor Q₄. The first secondary-side switching transistor Q₁ is connected between the first secondary-side winding and the second secondary-side switching transistor Q₂, the second secondary-side switching transistor Q₂ and the third secondary-side switching transistor Q₃ are connected to a third node a, and the fourth secondary-side switching transistor Q₄ is connected between the third secondary-side switching transistor Q₃ and the ground terminal.

In conjunction with FIGS. 3, 4, and 8, the signal modulation method for a high-frequency-link micro inverter in the embodiment of the present application includes steps S101 to S102, S201, S401, S501 to S503, and S403 to S404.

In S101, an intermediate signal Uₖ is formed according to a carrier signal V_{saw} and a modulation signal V_{ref}.

In S102, a reference signal U_{squ} is obtained according to the carrier signal V_{saw}.

In S201, a primary-side drive signal of the primary-side full-bridge circuit 10 is determined according to the carrier signal V_{saw}.

In S401, the intermediate signal Uₖ is inverted to obtain an inverted intermediate signal.

In S501, a logical AND operation is performed on the inverted intermediate signal Uₖ and the reference signal U_{squ}, and the logical AND operation result is inverted to obtain a first secondary-side drive signal of the cycloconverter module 31, where the first secondary-side drive signal is used for driving the first secondary-side switching transistor Q₁ during the positive half-cycle of an output power frequency voltage, and the first secondary-side drive signal is used for driving the second secondary-side switching transistor Q₂ during the negative half-cycle of the output power frequency voltage.

In S502, a logical AND operation is performed on the reference signal U_{squ} and the intermediate signal Uₖ to obtain a second secondary-side drive signal of the cycloconverter module 31, where the second secondary-side drive signal is used for driving the second secondary-side switching transistor Q₂ during the positive half-cycle of the output power frequency voltage, and the second secondary-side drive signal is used for driving the first secondary-side switching transistor Q₁ during the negative half-cycle of the output power frequency voltage.

In S503, a logical AND operation is performed on the reference signal U_{squ} and the intermediate signal Uₖ and the logical AND operation result is inverted to obtain a third secondary-side drive signal and a fourth secondary-side drive signal of the cycloconverter module 31, where the third secondary-side drive signal is used for driving the third secondary-side switching transistor Q₃, and the fourth secondary-side drive signal is used for driving the fourth secondary-side switching transistor Q₄.

In S403, the reference signal U_{squ} is inverted to obtain an inverted reference signal.

In S404, a logical operation is performed on the intermediate signal Uₖ the inverted intermediate signal, the reference signal U_{squ}, and the inverted reference signal to determine a drive signal of the second cycloconverter module.

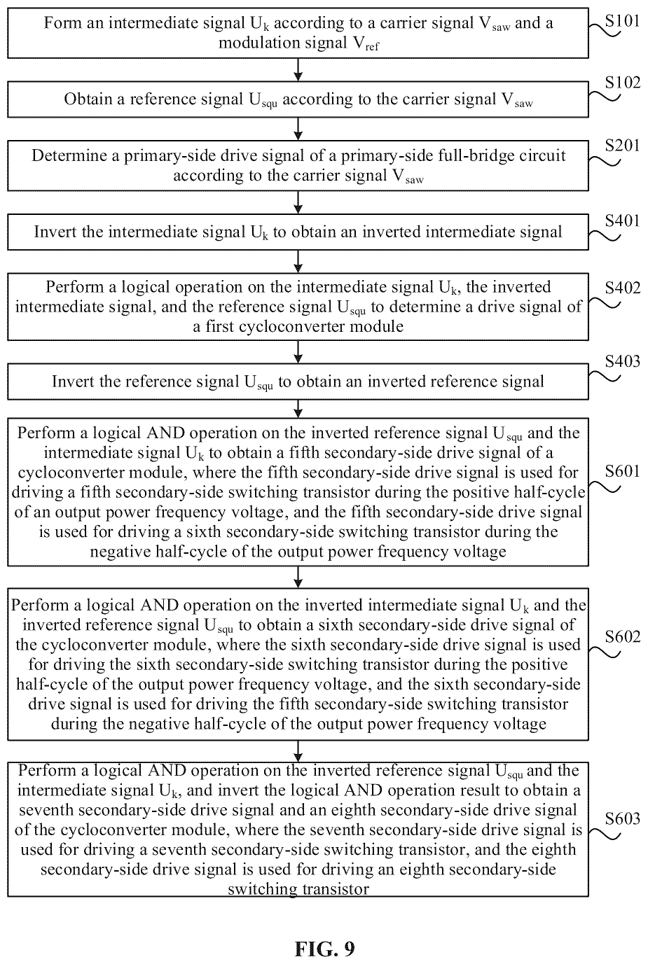

Optionally, FIG. 9 is a flowchart of another signal modulation method for a high-frequency-link micro inverter according to an embodiment of the present application. On the basis of the preceding embodiments, continuing to refer to FIG. 3, the second cycloconverter module includes a fifth secondary-side switching transistor Q₅, a sixth secondary-side switching transistor Q₆, a seventh secondary-side switching transistor Q₇, and an eighth secondary-side switching transistor Q₈. The fifth secondary-side switching transistor Q₅ is connected between the second secondary-side winding and the sixth secondary-side switching transistor Q₆, the sixth secondary-side switching transistor Q₆ and the eighth secondary-side switching transistor Q₈ are connected to a fourth node b, and the seventh secondary-side switching transistor Q₇ is connected between the eighth secondary-side switching transistor Q₈ and the ground terminal.

In conjunction with FIGS. 3, 4, and 9, the signal modulation method for a high-frequency-link micro inverter in the embodiment herein includes steps S101 to S102, S201, S401 to S403, and S601 to S603.

In S101, an intermediate signal Uₖ is formed according to a carrier signal V_{saw} and a modulation signal V_{ref}.

In S102, a reference signal U_{squ} is obtained according to the carrier signal V_{saw}.

In S201, a primary-side drive signal of the primary-side full-bridge circuit 10 is determined according to the carrier signal V_{saw}.

In S401, the intermediate signal Uₖ is inverted to obtain an inverted intermediate signal.

In S402, a logical operation is performed on the intermediate signal Uₖ the inverted intermediate signal, and the reference signal U_{squ} to determine a drive signal of the first cycloconverter module.

In S403, the reference signal U_{squ} is inverted to obtain an inverted reference signal.

In S601, a logical AND operation is performed on the inverted reference signal U_{squ} and the intermediate signal Uₖ to obtain a fifth secondary-side drive signal of the cycloconverter module 31, where the fifth secondary-side drive signal is used for driving the fifth secondary-side switching transistor Q₅ during the positive half-cycle of the output power frequency voltage, and the fifth secondary-side drive signal is used for driving the sixth secondary-side switching transistor Q₆ during the negative half-cycle of the output power frequency voltage.

In S602, a logical AND operation is performed on the inverted intermediate signal Uₖ and the inverted reference signal U_{squ} to obtain a sixth secondary-side drive signal of the cycloconverter module 31, where the sixth secondary-side drive signal is used for driving the sixth secondary-side switching transistor Q₆ during the positive half-cycle of the output power frequency voltage, and the sixth secondary-side drive signal is used for driving the fifth secondary-side switching transistor Q₅ during the negative half-cycle of the output power frequency voltage.

In S603, a logical AND operation is performed on the inverted reference signal U_{squ} and the intermediate signal Uₖ and the logical AND operation result is inverted to obtain a seventh secondary-side drive signal and an eighth secondary-side drive signal of the cycloconverter module 31, where the seventh secondary-side drive signal is used for driving the seventh secondary-side switching transistor Q₇, and the eighth secondary-side drive signal is used for driving the eighth secondary-side switching transistor Q₈.

It is to be noted that the case where G_{Q1} represents a drive signal of the first secondary-side switching transistor Q₁, G_{Q2} represents a drive signal of the second secondary-side switching transistor Q₂, G_{Q3} represents a drive signal of the third secondary-side switching transistor Q₃, GQ₄ represents a drive signal of the fourth secondary-side switching transistor Q₄, G_{Q5} represents a drive signal of the fifth secondary-side switching transistor Q₅, GQ₆ represents a drive signal of the sixth secondary-side switching transistor Q₆, G_{Q7} represents a drive signal of the seventh secondary-side switching transistor Q₇, and G_{Q8} represents a drive signal of the eighth secondary-side switching transistor Q₈ is illustrated in FIG. 4 as an example.

For example, continuing to refer to FIG. 4, the drive signal G_{Q1} of the first secondary-side switching transistor Q₁ includes the first secondary-side drive signal during the positive half-cycle of the output power frequency voltage, and the drive signal G_{Q1} of the first secondary-side switching transistor Q₁ includes the second secondary-side drive signal during the negative half-cycle of the output power frequency voltage.

Optionally, on the basis of the preceding embodiments, continuing to refer to FIG. 4, the fourth secondary-side drive signal and the eighth secondary-side drive signal are maintained at a turn-on level during the positive half-cycle of the output power frequency voltage to control the fourth secondary-side switching transistor Q₄ and the eighth secondary-side switching transistor Q₈ to be in an on-state during the positive half-cycle of the output power frequency voltage.

The third secondary-side drive signal and the seventh secondary-side drive signal are maintained at a turn-on level during the negative half-cycle of the output power frequency voltage to control the third secondary-side switching transistor Q₃ and the seventh secondary-side switching transistor Q₇ to be in an on-state during the negative half-cycle of the output power frequency voltage.

The drive waveforms of the secondary-side switching transistors Q₇ and Q₈ coincide with the drive waveform of the reference signal U_{squ}, and the drive waveforms of the secondary-side switching transistors Q₃ and Q₄ are opposite to the drive waveform of the reference signal U_{squ}. During the positive half-cycle of the output power frequency voltage, the secondary-side switching transistors Q₁ and Q₆ are maintained on, and the secondary-side switching transistors Q₂ and Q₅ are maintained off, during the negative half-cycle of the output power frequency voltage, the secondary-side switching transistors Q₂ and Q₅ are maintained on, and the secondary-side switching transistors Q₁ and Q₆ are maintained off. In addition, the secondary-side switching transistors Q₄ and Q₈ are maintained on all the time during the positive half-cycle of the output power frequency voltage, and secondary-side switching transistors Q₃ and Q₇ are maintained off all the time during the negative half-cycle of the output power frequency voltage, thereby reducing the switching loss of the secondary-side switching transistors.

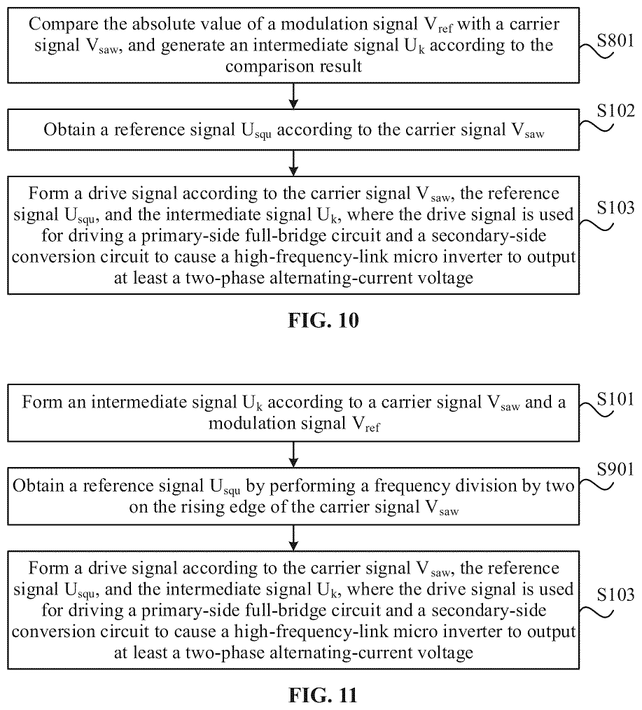

Optionally, FIG. 10 is a flowchart of another signal modulation method for a high-frequency-link micro inverter according to an embodiment of the present application. On the basis of the preceding embodiments, continuing to refer to FIG. 10, the signal modulation method for a high-frequency-link micro inverter in the embodiment herein includes steps S801, S102, and S103.

In S801, the absolute value of a modulation signal V_{ref} is compared with a carrier signal V_{saw}, and an intermediate signal Uₖ is generated according to the comparison result.

The modulation signal V_{ref} may be, for example, a sine modulation signal. The carrier signal V_{saw} may be, for example, a sawtooth wave signal. The absolute value |V_{ref}| of the modulation signal V_{ref} is compared with the carrier signal V_{saw}. When |V_{ref}| is greater than the carrier signal V_{saw}, the intermediate signal Uₖ is 1; when |V_{ref}| is not greater than the carrier signal V_{saw},the intermediate signal Uₖ is 0. In this manner, the intermediate signal Uₖ is generated.

In S102, a reference signal U_{squ} is determined according to the carrier signal V_{saw}.

In S103, a drive signal is formed according to the carrier signal V_{saw}, the reference signal U_{squ}, and the intermediate signal Uₖ where the drive signal is used for driving the primary-side full-bridge circuit 10 and the secondary-side conversion circuit 30 to cause the high-frequency-link micro inverter to output at least a two-phase alternating-current voltage.

Optionally, FIG. 11 is a flowchart of another signal modulation method for a high-frequency-link micro inverter according to an embodiment of the present application. On the basis of the preceding embodiments, continuing to refer to FIG. 11, the signal modulation method for a high-frequency-link micro inverter in the embodiment herein includes steps S101, S901, and S103.

In S101, an intermediate signal Uₖ is formed according to a carrier signal V_{saw} and a modulation signal V_{ref}.

In S901, a reference signal U_{squ} is obtained by performing a frequency division by two on the rising edge of the carrier signal V_{saw}.

The reference signal U_{squ} is a reference waveform of the drive waveform of the cycloconverter circuit of the secondary-side conversion circuit and may be obtained by performing a frequency division by two on the rising edge of the carrier signal V_{saw} (for example, a sawtooth wave signal).

In S103, a drive signal is formed according to the carrier signal V_{saw}, the reference signal U_{squ}, and the intermediate signal Uₖ where the drive signal is used for driving the primary-side full-bridge circuit 10 and the secondary-side conversion circuit 30 to cause the high-frequency-link micro inverter to output at least a two-phase alternating-current voltage.

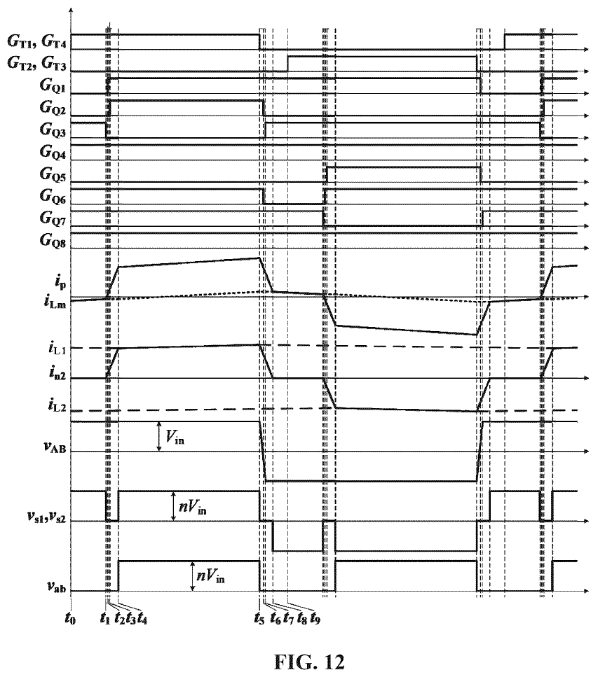

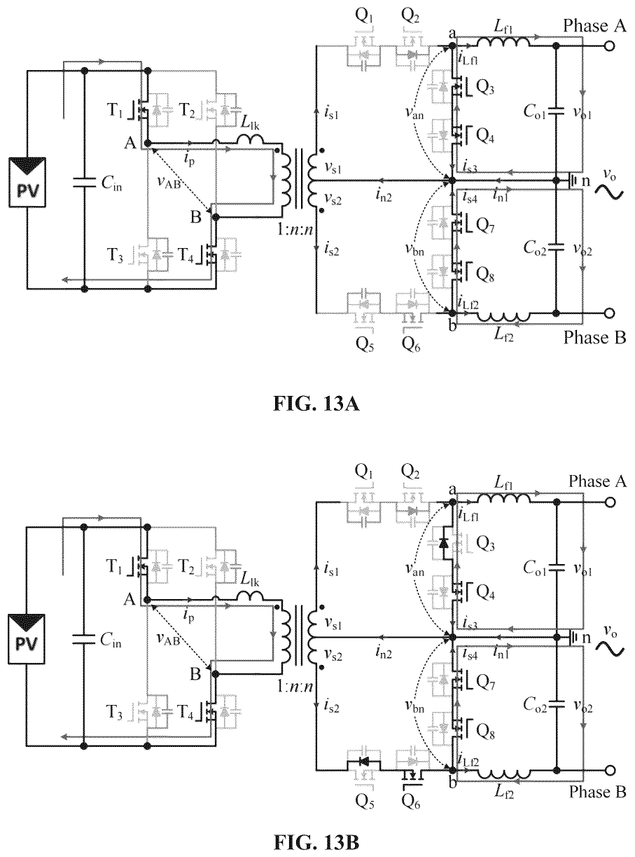

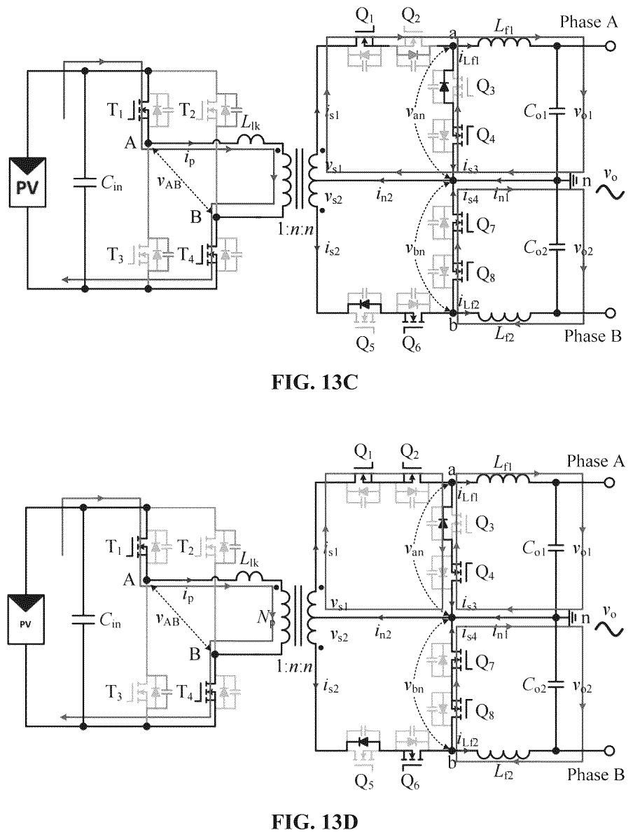

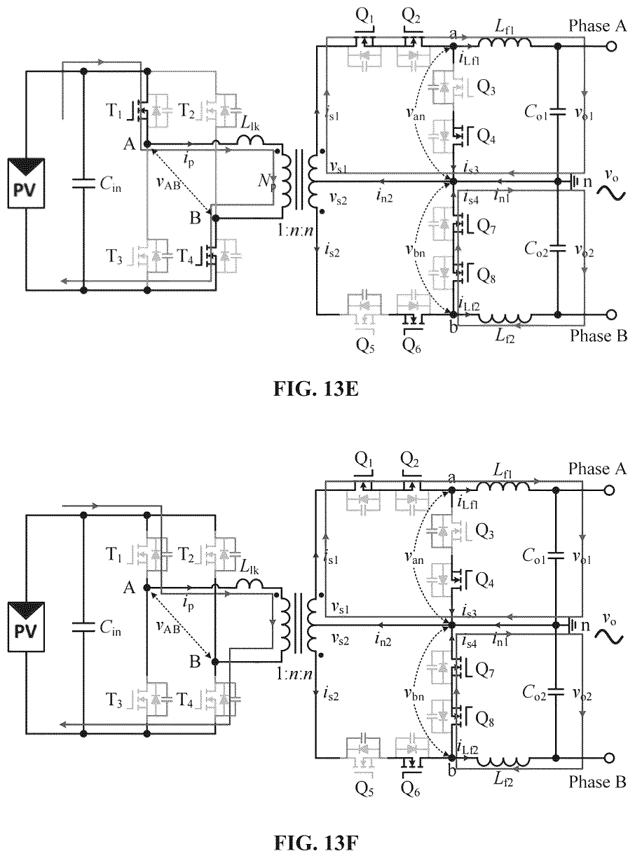

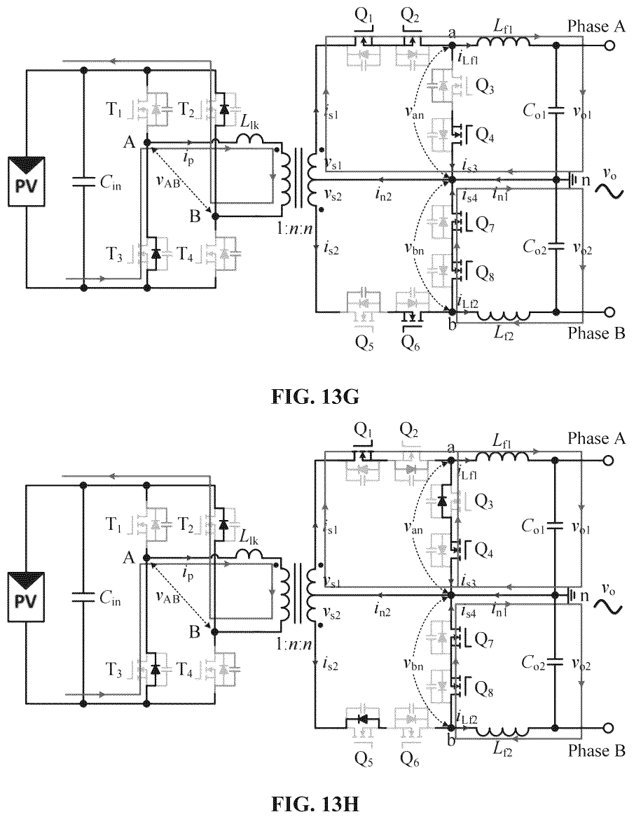

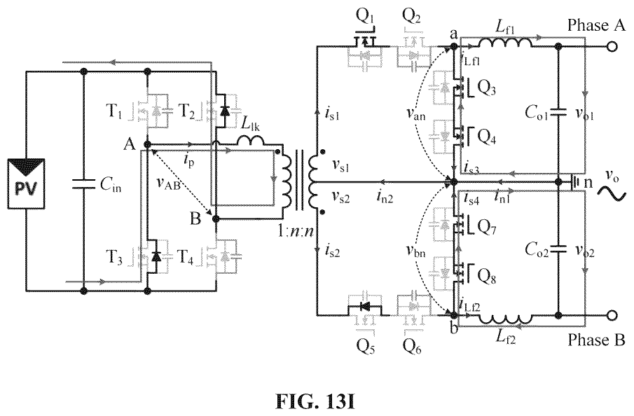

FIG. 12 is a schematic diagram of the signal waveforms during the switch cycle under a signal modulation method for a high-frequency-link micro inverter according to an embodiment of the present application. FIG. 13A is a structural diagram of a high-frequency-link micro inverter in an operating mode 1 [t₀-t₁] according to an embodiment of the present application. FIG. 13B is a structural diagram of the high-frequency-link micro inverter in an operating mode 2 [t₁-t₂] according to an embodiment of the present application. FIG. 13C is a structural diagram of the high-frequency-link micro inverter in an operating mode 3 [t₂-t₃] according to an embodiment of the present application. FIG. 13D is a structural diagram of the high-frequency-link micro inverter in an operating mode 4 [t₃-t₄] according to an embodiment of the present application. FIG. 13E is a structural diagram of the high-frequency-link micro inverter in an operating mode 5 [t₄-t₅] according to an embodiment of the present application. FIG. 13F is a structural diagram of the high-frequency-link micro inverter in an operating mode 6 [t₅-t₆] according to an embodiment of the present application. FIG. 13G is a structural diagram of the high-frequency-link micro inverter in an operating mode 7 [t₆-t₇] according to an embodiment of the present application. FIG. 13H is a structural diagram of the high-frequency-link micro inverter in an operating mode 8 [t₇-t₈] according to an embodiment of the present application. FIG. 13I is a structural diagram of the high-frequency-link micro inverter in an operating mode 9 [t₈-t₉] according to an embodiment of the present application.

On the basis of the preceding embodiments, the first primary-side drive signal G_{T1} to the fourth primary-side drive signal G_{T4} generated in the signal modulation method for a high-frequency-link micro inverter in the preceding embodiments are transmitted to the primary-side full-bridge circuit 10 of the topology of the high-frequency-link micro inverter, and the first secondary-side drive signal G_{Q1} to the eighth secondary-side drive signal G_{Q8} are transmitted to the control terminals of the switching transistors in the first cycloconverter module and the second cycloconverter module, respectively, so that the high-frequency-link micro inverter has operating states corresponding to the mode 1 [t₀-t₁] to the mode 9 [t₈-t₉].

For example, in conjunction with the schematic diagram of the signal waveforms during the switch cycle under the signal modulation method for a high-frequency-link micro inverter shown in FIG. 12, the major operating modes during the positive half-cycle of the output power frequency voltage are shown in FIGS. 13A to 13I.

In the mode 1 [t₀-t₁], as shown in FIG. 13A, before the time to, the micro inverter of the present application has already reached a steady state. The junction capacitors of the second primary-side switching transistor T₂ and the third primary-side switching transistor T₃ have been fully charged, that is, Vds_T₂(t₀)=Vds_T₃(t₀)=Vᵢₙ. The junction capacitors of the first secondary-side switching transistor Q₁ and the fifth secondary-side switching transistor Q₅ have been fully charged, that is, Vds_Q₂(t₀)=Vds_Q₃(t₀)=nVᵢₙ. In this mode, the first primary-side switching transistor T₁, the fourth primary-side switching transistor T₄, the third secondary-side switching transistor Q₃, the fourth secondary-side switching transistor Q₄, the seventh secondary-side switching transistor Q₇, the eighth secondary-side switching transistor Q₈, and the sixth secondary-side switching transistor Q₆ are in an on-state. The primary-side leakage inductance current iₚ and the magnetizing inductance current i_{Lm} freewheel through the first primary-side switching transistor T₁, the fourth primary-side switching transistor T₄, and the primary-side winding, the secondary-side output inductance current i_{Lf1} freewheels through the third secondary-side switching transistor Q₃ and the fourth secondary-side switching transistor Q₄, and the secondary-side output inductance current i_{Lf2} freewheels through the seventh secondary-side switching transistor Q₇ and the eighth secondary-side switching transistor Q₈. The whole circuit is in a freewheeling state, and the output voltage v_{ab} is at a zero level. At the time t₁, the third secondary-side switching transistor Q₃ is turned off, and then the mode 1 ends.

In the mode 2 [t₁-t₂], as shown in FIG. 13B, the first primary-side switching transistor T₁, the fourth primary-side switching transistor T₄, the fourth secondary-side switching transistor Q₄, the seventh secondary-side switching transistor Q₇, the eighth secondary-side switching transistor Q₈, and the sixth secondary-side switching transistor Q₆ are still in an on-state. At the time t₁, the third secondary-side switching transistor Q₃ is turned off, the body diode of the third secondary-side switching transistor Q₃ is turned on, the freewheeling state is maintained, and the third secondary-side switching transistor Q₃ completes ZVS turn-off. The operating states of other switching transistors are consistent with the operating states in the mode 1, and the circuit is still in the freewheeling state. At the time t₂, the first secondary-side switching transistor Q₁ is turned on, and then the mode 2 ends.

In the mode 3 [t₂-t₃], as shown in FIG. 13C, the first primary-side switching transistor T₁, the fourth primary-side switching transistor T₄, the fourth secondary-side switching transistor Q₄, the seventh secondary-side switching transistor Q₇, the eighth secondary-side switching transistor Q₈, and the sixth secondary-side switching transistor Q₆ are still in an on-state. At the time t₂, the first secondary-side switching transistor Q₁ is turned on, and then the mode 3 [t₂-t₃] starts. The body diode of the second secondary-side switching transistor Q₂ is turned on under the action of a forward bias voltage, and the circuit starts to transfer energy from the primary-side side. The inductance current starts to rise under the action of an input voltage, the secondary-side current in 2 starts to rise from 0, the branch current iₛ₃ gradually decreases, and the secondary-side winding voltages vₛ₁ and vₛ₂ are clamped to zero, so this mode leads to the loss of duty cycle.

It is to be noted that although the first secondary-side switching transistor Q₁ is in the hard switching mode herein, since the current flowing through the first secondary-side switching transistor Q₁ increases from zero and the rate of current increase is much lower than the rate at which the switching transistor is turned on, it can be approximately considered that the first secondary-side switching transistor Q₁ achieves zero current switching (ZCS) turn-on during the zero current switching.

In the mode 4 [t₃-t₄], as shown in FIG. 13D, at the time t₃, the second secondary-side switching transistor Q₂ is turned on. Since the body diode of the second secondary-side switching transistor Q₂ has already been turned on in the previous mode, the second secondary-side switching transistor Q₂ achieves ZVS turn-on, and the operating states of other switching transistors are still consistent with the operating states in the mode 3 [t₂-t₃]. At the time t₄, the current in the branches of the third secondary-side switching transistor Q₃ and the fourth secondary-side switching transistor Q₄ is completely transferred to the branches of the first secondary-side switching transistor Q₁ and the second secondary-side switching transistor Q₂, the current iₙ₂ is equal to i_{Lf1}, and the current iₛ₃ drops to 0. Since the value of the output inductance is very large, the inductance current may be considered constant during the switch cycle. It is to be noted that the current ripple of the output inductance may be ignored herein.

In the mode 5 [t₄-t₅], as shown in FIG. 13E, the circuit enters the energy transfer mode. Due to the existence of the junction capacitors of the third secondary-side switching transistor Q₃ and the fifth secondary-side switching transistor Q₅, resonance occurs with the leakage inductor Lₗₖ.

In the practical circuit, due to the existence of parasitic resistances of the circuit, the resonant voltage and current gradually attenuate, the voltages Vds_Q₃ and Vds_Q₅ across the third secondary-side switching transistor Q₃ and the fifth secondary-side switching transistor Q₅ respectively will be eventually stabilized at nVᵢₙ, and iₙ₂ will be eventually stabilized at i_{Lf1}.

In the mode 6 [t₅-t₆], as shown in FIG. 13F, at the time t₅, the first primary-side switching transistor T₁ and the fourth primary-side switching transistor T₄ are turned off. The junction capacitor Coss_T₁ of the first primary-side switching transistor T₁ and the junction capacitor Coss_T₄ of the fourth primary-side switching transistor T₄ start to charge, and the voltages across the first primary-side switching transistor T₁ and the fourth primary-side switching transistor T₄ start to be raised. The junction capacitor Coss_T₂ of the second primary-side switching transistor T₂ and the junction capacitor Coss_T₃ of the third primary-side switching transistor T₃ start to discharge, and the voltages across the second primary-side switching transistor T₂ and the third primary-side switching transistor T₃ start to drop. Meanwhile, the junction capacitors of the third secondary-side switching transistor Q₃ and the fifth secondary-side switching transistor Q₅ start to discharge.

In the mode 7 [t₆-t₇], as shown in FIG. 13G, at the time t₅, the current starts to flow through the body diodes of the second primary-side switching transistor T₂ and the third primary-side switching transistor T₃, and the square wave voltage amplitude v_{AB} generated by the primary-side full-bridge circuit 10 is equal to −Vᵢₙ. The output capacitors of the third secondary-side switching transistor Q₃ and the fifth secondary-side switching transistor Q₅ have been fully discharged, and the voltages Vₛ₁ and Vₛ₂ are clamped to zero. According to the analysis of the above two modes, the dead time of the switching bridge arm of the primary-side full-bridge circuit 10 may be set to be longer than the duration of the above two modes to ensure that the primary-side switching transistors achieve ZVS in the whole output load range and reduce the switching loss of the primary-side full-bridge circuit 10.

In the mode 8 [t₇-t₈], as shown in FIG. 13H, at the time t₇, the second secondary-side switching transistor Q₂ and the sixth secondary-side switching transistor Q₆ are turned off, the current iₛ₁ flowing through the second secondary-side switching transistor Q₂ is transferred to the body diode of the second secondary-side switching transistor Q₂, the neutral current iₙ₂ continues to decrease, and the body diode of the third secondary-side switching transistor Q₃ is turned on under the action of a forward bias voltage, thereby creating a zero voltage turn-on condition for the third secondary-side switching transistor Q₃.

In the mode 9 [t₈-t₉], as shown in FIG. 13I, at the time t₈, the third secondary-side switching transistor Q₃ achieves zero voltage turn-on, and the operating states of other switching transistors are consistent with the operating states in the mode 8. Since the body diodes of the second primary-side switching transistor T₂ and the third primary-side switching transistor T₃ have been turned on, at the time to, the second primary-side switching transistor T₂ and the third primary-side switching transistor T₃ achieve zero voltage turn-on. The circuit then enters the negative half-cycle of the switch cycle of the output of the primary-side full-bridge circuit 10, and its corresponding operating modes are similar to the operating modes during the positive half-cycle of the output power frequency voltage, which is not repeated herein.

It is to be noted that the case where the transformer module 20 employed in the topology of the high-frequency-link micro inverter is a single three-winding high-frequency transformer is illustrated in FIGS. 13A to 13I as an example. The single three-winding high-frequency transformer includes one primary-side winding Nₚ and two secondary-side windings Nₛ₁ and Nₛ₂. The two secondary-side windings Nₛ₁ and Nₛ₂ have one terminal shorted together, while their other terminals are connected to the pin 1 of the primary-side side as dotted terminals. The output sides of the secondary-side windings Nₛ₁ and Nₛ₂ are connected to the first cycloconverter module and the second cycloconverter module, respectively. The single three-winding high-frequency transformer in the transformer module 20 may be replaced with two discrete two-winding high-frequency transformers, which is not limited herein.

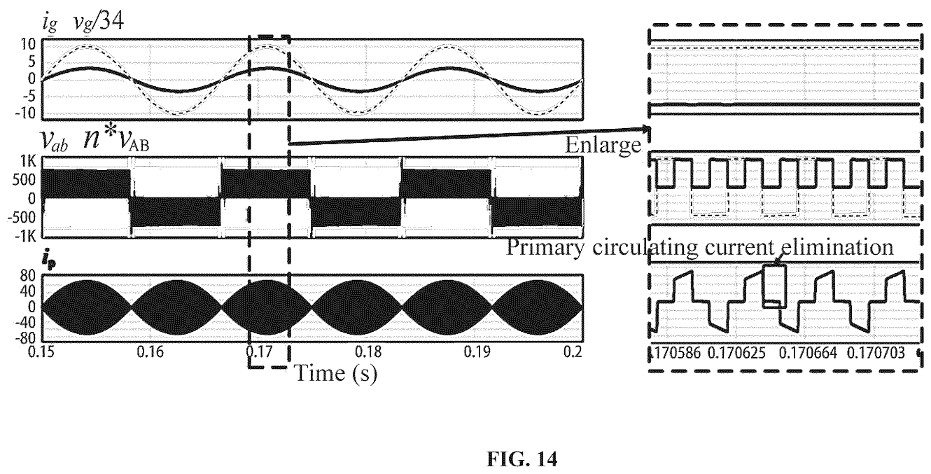

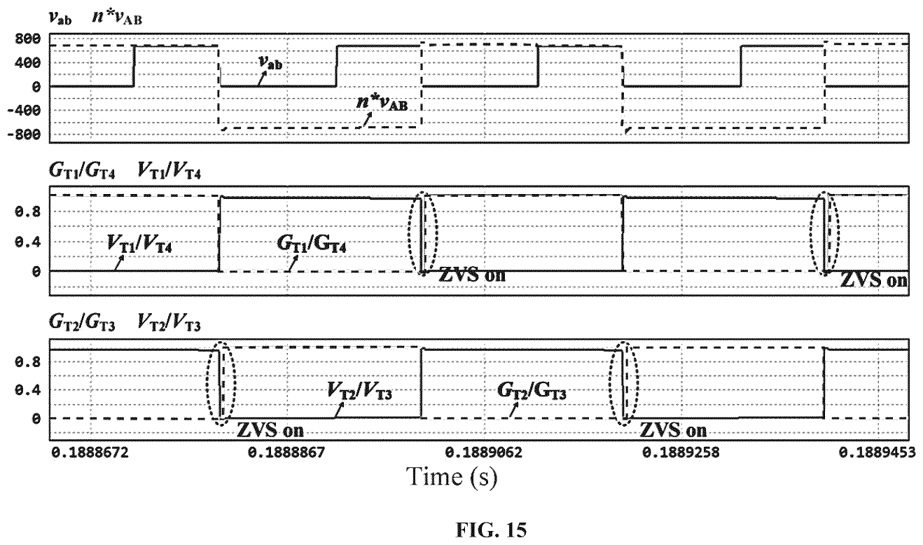

In an optional embodiment, FIG. 14 is a schematic diagram of related simulation waveforms under a signal modulation method for a high-frequency-link micro inverter according to an embodiment of the present application, and FIG. 15 is a schematic diagram of soft switching waveforms under a signal modulation method for a high-frequency-link micro inverter according to an embodiment of the present application. On the basis of the preceding embodiments, in conjunction with FIGS. 3, 14, and 15, the maximum output power of the micro photovoltaic inverter is 600 W, the input voltage Vₚᵥ is 22 V to 55 V, and the grid voltage v_{g} is 240 V_{ac}±10%. FIG. 14 shows the related simulation waveforms. The square wave signal having a duty cycle of 50% generated by the primary-side full-bridge circuit 10 is transmitted to the secondary-side side through the transformer module 20 and then sinusoidally modulated through the cycloconverter module 31 of the secondary-side side to finally obtain an output voltage v_{ab} which will be output to the filter module 32 later. FIG. 15 shows the soft switching waveforms under the signal modulation method for a high-frequency-link micro inverter. As can be seen from the simulation results, the preceding solution can effectively achieve the zero voltage turn-on of the primary-side switching transistors, thereby achieving ZVS and primary-side circulating current elimination and reducing the switching loss.

### Embodiment Two

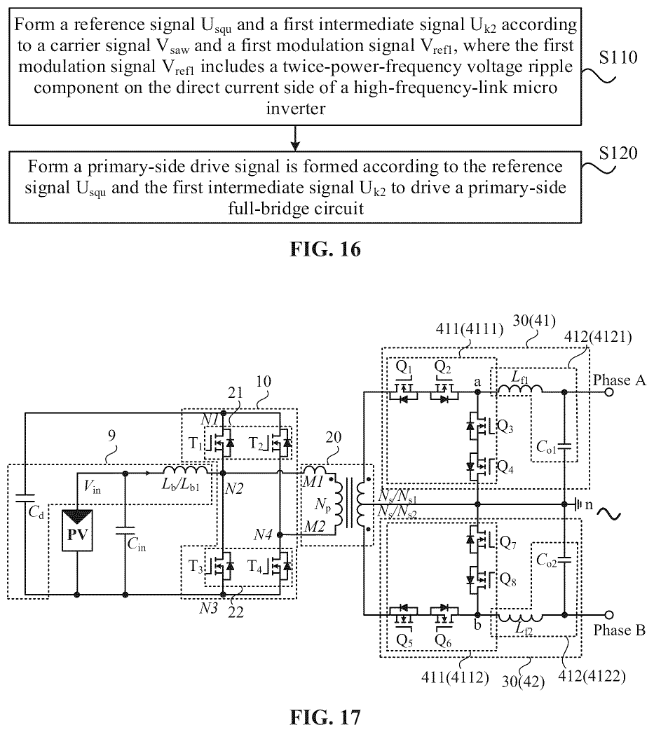

In the embodiment, the modulation signal V_{ref} includes a first modulation signal V_{ref1} and a second modulation signal V_{ref2}. FIG. 16 is a flowchart of another signal modulation method for a high-frequency-link micro inverter according to an embodiment of the present application. FIG. 17 is a structural diagram of a high-frequency-link micro inverter according to an embodiment of the present application. As shown in FIG. 17, the high-frequency-link micro inverter includes a primary-side full-bridge circuit 10, a transformer module 20, a secondary-side conversion circuit 30, and a boost module 9. The boost module 9 is connected to at least one bridge arm in the primary-side full-bridge circuit 10 to form a voltage conversion circuit. The primary-side full-bridge circuit 10 is connected to the primary-side winding Nₚ of the transformer module 20. The secondary-side conversion circuit 30 is connected to the secondary-side winding Nₛ of the transformer module 20. The embodiment herein may be applied to the case where the boost module 9 and the primary-side full-bridge circuit 10 in the high-frequency-link micro inverter form a voltage conversion circuit and includes steps S110 and S120.

In S110, a reference signal U_{squ} and a first intermediate signal Uₖ₂ are formed according to a carrier signal V_{saw} and a first modulation signal V_{ref1}, where the first modulation signal V_{ref1} includes a twice-power-frequency voltage ripple component on the direct current side of the high-frequency-link micro inverter.

As shown in FIG. 17, the instantaneous power imbalance between the direct current and alternating current sides of the high-frequency-link inverter is raised, resulting in the twice-power-frequency power ripple on the direct current side. The first modulation signal V_{ref1} may include a twice-power-frequency voltage ripple component on the direct current side of the high-frequency-link micro inverter. For example, the first modulation signal V_{ref1} may be a direct current reference signal. The carrier signal V_{saw} may include a triangular wave signal, a sawtooth wave signal or the like. When the reference signal U_{squ} and the first intermediate signal Uₖ₂ are formed according to the carrier signal V_{saw} and the first modulation signal V_{ref1}, the reference signal U_{squ} may be a square wave signal having a fixed pulse width, and the frequency of the reference signal U_{squ} is different from the frequency of the first intermediate signal Uₖ₂.

In S120, a primary-side drive signal is formed according to the reference signal U_{squ} and the first intermediate signal Uₖ₂ to drive the primary-side full-bridge circuit.

When the primary-side drive signal is to be formed according to the reference signal U_{squ} and the first intermediate signal Uₖ₂, the primary-side drive signal may be formed by performing a logical operation on the reference signal U_{squ} and the first intermediate signal Uₖ₂. The primary-side full-bridge circuit 10 includes multiple primary-side switching transistors. When the primary-side drive signal drives the primary-side full-bridge circuit 10, the primary-side drive signal may drive the multiple primary-side switching transistors to cause the multiple primary-side switching transistors to invert the input direct current. At this point, multiple primary-side drive signals may exist for driving the multiple primary-side switching transistors, respectively. The frequency of the reference signal is different from the frequency of the first intermediate signal Uₖ₂. When different primary-side drive signals are formed by performing different logical operations on the reference signal U_{squ} and the first intermediate signal Uₖ₂, different primary-side drive signals have different duty cycles. The boost module 9 forms a voltage conversion circuit with at least one bridge arm in the primary-side full-bridge circuit 10. When the primary-side full-bridge circuit 10 is driven to operate, the voltage conversion circuit may be activated to operate properly, thereby improving the gain of the high-frequency-link micro inverter through the voltage conversion circuit. By setting the duty cycles of the multiple primary-side drive signals, the gain of the voltage conversion circuit may be adjusted, thereby enabling the gain of the high-frequency-link micro inverter to be adjustable. Moreover, the twice-power-frequency power ripple in the primary-side full-bridge circuit 10 may be transferred to the boost module 9, thereby suppressing the twice-power-frequency power ripple on the direct current side of the high-frequency-link micro inverter. Meanwhile, the requirements for the first capacitor Cᵢₙ connected in parallel to the signal input terminal Vᵢₙ of the high-frequency-link micro inverter can be reduced, thereby reducing the volume of the high-frequency-link micro inverter and prolonging the service life of the high-frequency-link micro inverter.

In the solution of the embodiment herein, a reference signal U_{squ} and a first intermediate signal Uₖ₂ are formed according to a carrier signal V_{saw} and a first modulation signal V_{ref1}, where the first modulation signal V_{ref1} includes a twice-power-frequency voltage ripple component on the direct current side of the high-frequency-link micro inverter, and a primary-side drive signal is formed according to the reference signal U_{squ} and the first intermediate signal Uₖ₂ to drive the primary-side full-bridge circuit. After the primary-side full-bridge circuit and the boost module form a voltage conversion circuit, the voltage conversion circuit may be activated to operate as the primary-side full-bridge circuit 10 is driven by the primary-side drive signal, thereby improving the gain of the high-frequency-link micro inverter through the voltage conversion circuit. By setting the duty cycles of multiple primary-side drive signals, the gain of the voltage conversion circuit may be adjusted, thereby enabling the gain of the high-frequency-link micro inverter to be adjustable. Moreover, the twice-power-frequency power ripple in the primary-side full-bridge circuit may be transferred to the boost module, thereby suppressing the twice-power-frequency power ripple on the direct current side of the high-frequency-link micro inverter. Meanwhile, the requirements for the first capacitor connected in parallel to the signal input terminal of the high-frequency-link micro inverter can be reduced, thereby reducing the volume of the high-frequency-link micro inverter and prolonging the service life of the high-frequency-link micro inverter.

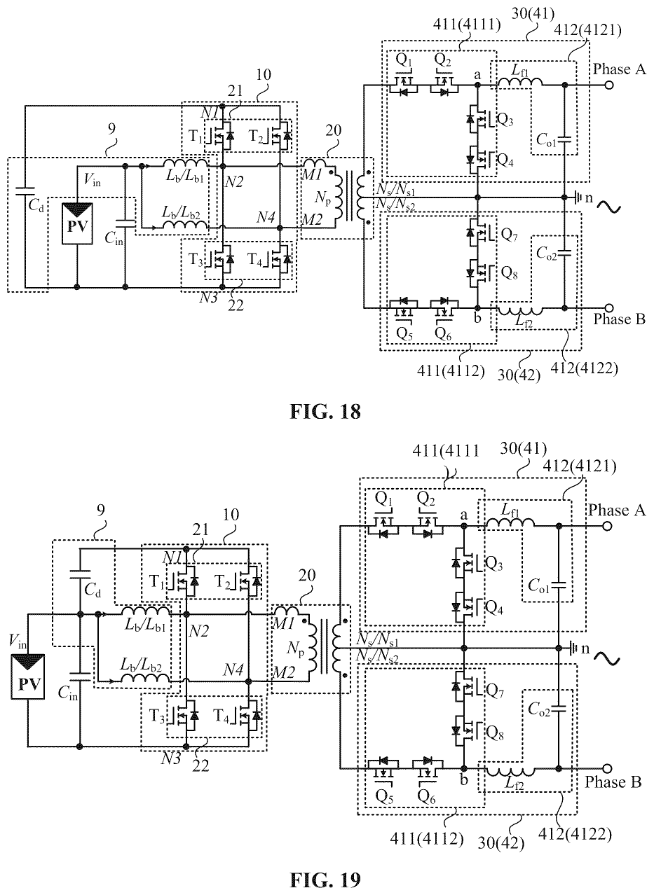

It is to be noted that the case where the boost module 9 includes a decoupling capacitor C_{d} and one boost inductor L_{b} which is a first boost inductor L_{b} is illustrated in FIG. 17 as an example. The decoupling capacitor C_{d} is connected between the first terminal N1 of a first bridge arm 21 and the first terminal N3 of a second bridge arm 22, and the first boost inductor L_{b} is connected between the first output terminal N2 of the primary-side full-bridge circuit 10 and the signal input terminal Vᵢₙ. FIG. 18 is a structural diagram of another high-frequency-link micro inverter according to an embodiment of the present application. As shown in FIG. 18, in other embodiments, the boost module 9 may further include two boost inductors L_{b} that are a first boost inductor L_{b1} and a second boost inductor L_{b2}, respectively. The first boost inductor L_{b1} is connected between the signal input terminal Vᵢₙ and the first output terminal N2 (the first node A) of the primary-side full-bridge circuit 10, and the second boost inductor L_{b2} is connected between the signal input terminal Vᵢₙ and the second output terminal N4 (the second node B) of the primary-side full-bridge circuit 10.

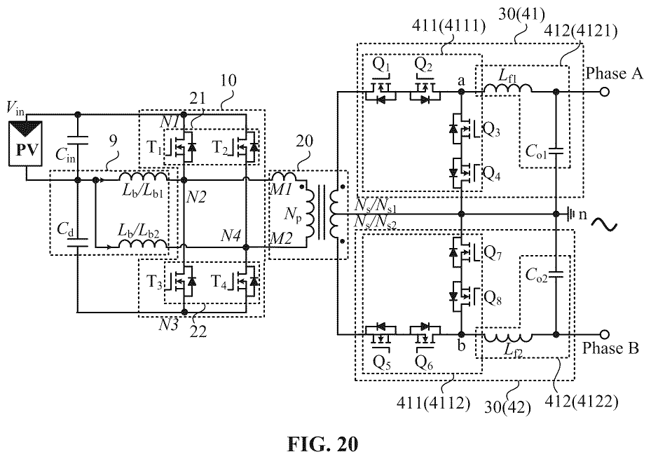

In addition, in FIGS. 17 and 18, the first electrode of the decoupling capacitor C_{d} is connected to the first terminal N1 of the first bridge arm 21, and the second electrode of the decoupling capacitor C_{d} is connected to the first terminal N3 of the second bridge arm 22. FIG. 19 is a structural diagram of another high-frequency-link micro inverter according to an embodiment of the present application. As shown in FIG. 19, in other embodiments, the high-frequency-link micro inverter further includes a first capacitor Cᵢₙ. The first electrode of the first capacitor Cᵢₙ and the first electrode of the decoupling capacitor C_{d} are connected to the signal input terminal Vᵢₙ, the second electrode of the decoupling capacitor C_{d} is connected to the first terminal N1 of the first bridge arm 21, and the second electrode of the first capacitor Cᵢₙ is connected to the first terminal N3 of the second bridge arm 22. Alternatively, FIG. 20 is a structural diagram of another high-frequency-link micro inverter according to an embodiment of the present application. As shown in FIG. 20, the second electrode of the decoupling capacitor C_{d} is connected to the first terminal N3 of the second bridge arm 22, and the second electrode of the first capacitor Cᵢₙ is connected to the first terminal N1 of the first bridge arm 21.

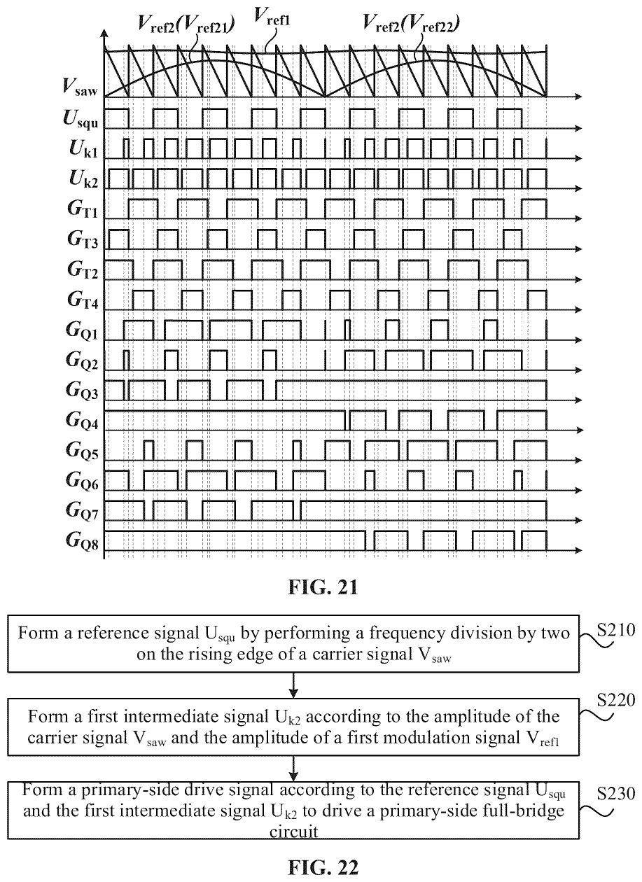

FIG. 21 is a schematic diagram of the waveforms of drive signals of a high-frequency-link micro inverter according to an embodiment of the present application. FIG. 22 is a flowchart of another signal modulation method for a high-frequency-link micro inverter according to an embodiment of the present application. Referring to FIGS. 17 to 22, the signal modulation method for a high-frequency-link micro inverter includes steps S210 to S230.

In S210, a reference signal U_{squ} is formed by performing a frequency division by two on the rising edge of a carrier signal V_{saw}.

As shown in FIG. 21, the rising edge of the carrier signal V_{saw} may characterize the frequency of the carrier signal V_{saw}. The reference signal U_{squ} may be formed by performing a frequency division by two on the rising edge of the carrier signal V_{saw}.

In S220, a first intermediate signal Uₖ₂ is formed according to the amplitude of the carrier signal V_{saw} and the amplitude of a first modulation signal V_{ref1}.

As shown in FIG. 21, the maximum amplitude of the carrier signal V_{saw} is greater than the amplitude of the first modulation signal V_{ref1}. When the first intermediate signal Uₖ₂ is to be formed, the amplitude of the carrier signal V_{saw} and the amplitude of the first modulation signal V_{ref1} may be compared. When the amplitude of the first modulation signal V_{ref1} is greater than the amplitude of the carrier signal V_{saw}, the first intermediate signal Uₖ₂ may be 1; when the amplitude of the first modulation signal V_{ref1} is less than the amplitude of the carrier signal V_{saw}, the first intermediate signal Uₖ₂ may be 0. In this manner, the waveform of the first intermediate signal Uₖ₂ may be determined according to the amplitude of the carrier signal V_{saw} and the amplitude of the first modulation signal V_{ref1}. When the first modulation signal V_{ref1} is a direct-current signal, the pulse width of the first intermediate signal Uₖ₂ is equal in different modulation cycles.

In S230, a primary-side drive signal is formed according to the reference signal U_{squ} and the first intermediate signal Uₖ₂ to drive the primary-side full-bridge circuit.

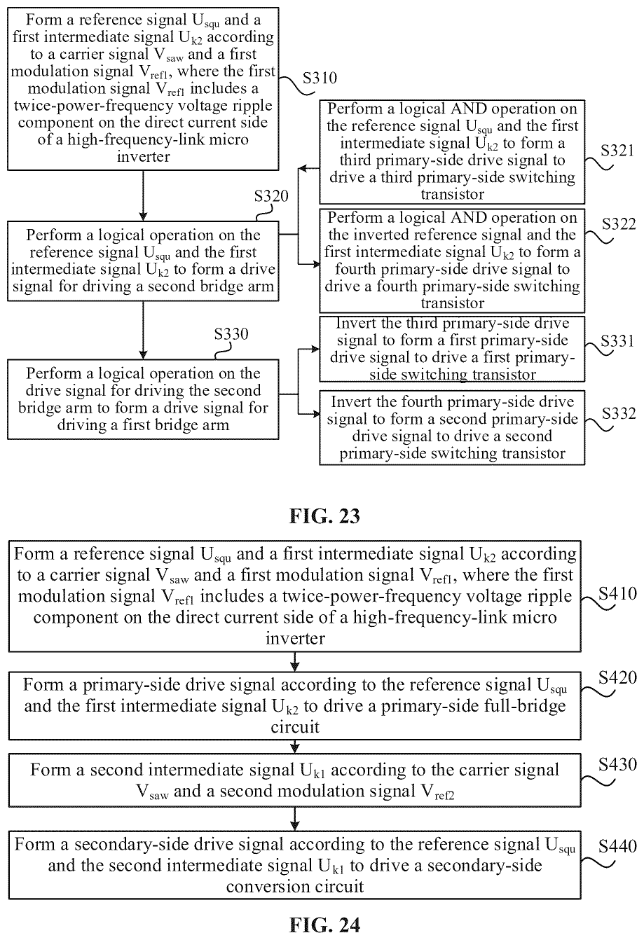

FIG. 23 is a flowchart of another signal modulation method for a high-frequency-link micro inverter according to an embodiment of the present application. Referring to FIGS. 17 to 21 and 23, in FIG. 21, G_{T1} is the waveform of a drive signal corresponding to the first primary-side switching transistor T₁, G_{T2} is the waveform of a drive signal corresponding to the second primary-side switching transistor T₂, G_{T3} is the waveform of a drive signal corresponding to the third primary-side switching transistor T₃, and G_{T4} is the waveform of a drive signal corresponding to the fourth primary-side switching transistor T₄. The boost module 9 includes a decoupling capacitor C_{d} and at least one boost inductor L_{b}. The primary-side full-bridge circuit 10 includes a first bridge arm 21 and a second bridge arm 22. The first bridge arm 21 includes a first primary-side switching transistor T₁ and a second primary-side switching transistor T₂, and the second bridge arm 22 includes a third primary-side switching transistor T₃ and a fourth primary-side switching transistor T₄. The first electrode of the first primary-side switching transistor T₁ is connected to the first electrode of the second primary-side switching transistor T₂, the second electrode of the first primary-side switching transistor T₁ and the second electrode of the third primary-side switching transistor T₃ are connected to the first terminal M1 of the primary-side winding Nₚ, the first electrode of the third primary-side switching transistor T₃ is connected to the first electrode of the fourth primary-side switching transistor T₄, and the second electrode of the second primary-side switching transistor T₂ and the second electrode of the fourth primary-side switching transistor T₄ are connected to the second terminal M2 of the primary-side winding Nₚ. The decoupling capacitor C_{d} is connected between the first electrode of the first primary-side switching transistor T₁ and the first electrode of the third primary-side switching transistor T₃, and at least one boost inductor L_{b} is connected to the second electrode of the first primary-side switching transistor T₁ and/or the second electrode of the second primary-side switching transistor T₂.

The following is described by using an example where the boost inductor L_{b} includes a first boost inductor L_{b1} and a second boost inductor L_{b2}, the first primary-side switching transistor T₁ and the third primary-side switching transistor T₃ also serve as the switching transistors in the voltage conversion circuit during the positive half-cycle of the modulation cycle, and the second primary-side switching transistor T₂ and the fourth primary-side switching transistor T₄ also serve as the switching transistors in the voltage conversion circuit during the negative half-cycle of the modulation cycle. The signal modulation method for a high-frequency-link micro inverter includes steps S310 to S330.

In S310, a reference signal U_{squ} and a first intermediate signal Uₖ₂ are formed according to a carrier signal V_{saw} and a first modulation signal V_{ref1}, where the first modulation signal V_{ref1} includes a twice-power-frequency voltage ripple component on the direct current side of the high-frequency-link micro inverter.

In S320, a logical operation is performed on the reference signal U_{squ} and the first intermediate signal Uₖ₂ to form a drive signal for driving the second bridge arm.

The drive signal of the second bridge arm 22 is used for driving the primary-side switching transistors constituting the second bridge arm 22, that is, the drive signal of the second bridge arm 22 is used for driving the third primary-side switching transistor T₃ and the fourth primary-side switching transistor T₄. The pulse widths of the drive signals corresponding to the third primary-side switching transistor T₃ and the fourth primary-side switching transistor T₄ may be equal, and the third primary-side switching transistor T₃ and the fourth primary-side switching transistor T₄ are turned on in time-sharing to achieve the inversion of the primary-side full-bridge circuit 10. The third primary-side switching transistor T3 and the fourth primary-side switching transistor T4 may also serve as the switching transistors in the voltage conversion circuit to achieve voltage conversion.

Optionally, continuing to refer to FIG. 23, the step where the logical operation is performed on the reference signal U_{squ} and the first intermediate signal Uₖ₂ to form the drive signal for driving the second bridge arm includes steps S321 to S322.

In S321, a logical AND operation is performed on the reference signal U_{squ} and the first intermediate signal Uₖ₂ to form a third primary-side drive signal to drive the third primary-side switching transistor.

The third primary-side drive signal is the drive signal G_{T3} driving the third primary-side switching transistor T₃. When the reference signal U_{squ} is acquired by performing a frequency division by two on the rising edge of the carrier signal V_{saw}, the frequency of the reference signal U_{squ} is one-half of the frequency of the first intermediate signal Uₖ₂, and the pulse width of the reference signal U_{squ} is equal to the cycle of the carrier signal V_{saw}. The pulse width of the first intermediate signal Uₖ₂ is less than the cycle of the carrier signal V_{saw}, the pulse width of the third primary-side drive signal G_{T3} formed by performing a logical AND operation on the reference signal U_{squ} and the first intermediate signal Uₖ₂ is equal to the pulse width of the first intermediate signal Uₖ₂, that is, the pulse width of the third primary-side drive signal G_{T3} is less than the cycle of the carrier signal V_{saw}, and the frequency of the third primary-side drive signal G_{T3} is equal to the frequency of the reference signal U_{squ}.

In S322, a logical AND operation is performed on the inverted reference signal and the first intermediate signal Uₖ₂ to form a fourth primary-side drive signal to drive the fourth primary-side switching transistor.

The fourth primary-side drive signal is the drive signal G_{T4} driving the fourth primary-side switching transistor T₄. The signal frequency of the inverted reference signal U_{squ} is equal to the frequency of the reference signal U_{squ}, and the pulse width is equal to the cycle of the carrier signal V_{saw}. The pulse width of the fourth primary-side drive signal G_{T4} formed by performing a logical AND operation on the inverted reference signal U_{squ} and the first intermediate signal Uₖ₂ is equal to the pulse width of the first intermediate signal Uₖ₂, that is, the pulse width of the fourth primary-side drive signal G_{T4} is less than the cycle of the carrier signal V_{saw}, and the frequency of the fourth primary-side drive signal G_{T4} is equal to the frequency of the reference signal U_{squ}. The effective level of the fourth primary-side drive signal G_{T4} and the effective level of the third primary-side drive signal G_{T3} are within different cycles of the carrier signal V_{saw}.

In S330, a logical operation is performed on the drive signal for driving the second bridge arm to form a drive signal for driving the first bridge arm.

The drive signal of the first bridge arm 21 is used for driving the primary-side switching transistors constituting the first bridge arm 21, that is, the drive signal of the first bridge arm 21 is used for driving the first primary-side switching transistor T₁ and the second primary-side switching transistor T₂. The pulse widths of the drive signals corresponding to the first primary-side switching transistor T₁ and the second primary-side switching transistor T₂ may be equal, and the first primary-side switching transistor T₁ and the second primary-side switching transistor T₂ are turned on in time-sharing to achieve the inversion of the primary-side full-bridge circuit 10. The first primary-side switching transistor T₁ and the second primary-side switching transistor T₂ may also serve as the switching transistors in the voltage conversion circuit to achieve voltage conversion.

Optionally, continuing to refer to FIG. 23, the step where the logical operation is performed on the drive signal for driving the second bridge arm to form the drive signal for driving the first bridge arm includes steps S331 and S332.

In S331, the third primary-side drive signal is inverted to form a first primary-side drive signal to drive the first primary-side switching transistor.

The first primary-side drive signal is the drive signal G_{T1} driving the first primary-side switching transistor T₁. The pulse width of the third primary-side drive signal G_{T3} is less than the cycle of the carrier signal V_{saw}, the pulse width of the first primary-side drive signal G_{T1} formed by inverting the third primary-side drive signal G_{T3} is greater than the cycle of the carrier signal V_{saw}, and the frequency of the first primary-side drive signal G_{T1} is equal to the frequency of the third primary-side drive signal G_{T3} and is the frequency of the reference signal U_{squ}. The sum of the pulse width of the third primary-side drive signal G_{T3} and the pulse width of the first primary-side drive signal G_{T1} is twice the cycle of the carrier signal V_{saw}.

In S332, the fourth primary-side drive signal is inverted to form a second primary-side drive signal to drive the second primary-side switching transistor.

The second primary-side drive signal is the drive signal G_{T2} driving the second primary-side switching transistor T₂. The pulse width of the fourth primary-side drive signal G_{T4} is less than the cycle of the carrier signal V_{saw}, the pulse width of the second primary-side drive signal G_{T2} formed by inverting the fourth primary-side drive signal G_{T4} is greater than the cycle of the carrier signal V_{saw}, and the frequency of the second primary-side drive signal G_{T2} is equal to the frequency of the fourth primary-side drive signal G_{T4} and is the frequency of the reference signal U_{squ}. The effective level of the first primary-side drive signal G_{T1} overlaps the effective level of the second primary-side drive signal G_{T2}. The sum of the pulse width of the fourth primary-side drive signal G_{T4} and the pulse width of the second primary-side drive signal G_{T2} is twice the cycle of the carrier signal V_{saw}.

In the preceding modulation process, by setting the pulse width of the third primary-side drive signal G_{T3} and the pulse width of the fourth primary-side drive signal G_{T4} to be less than the cycle of the carrier signal V_{saw}, the pulse width of the first primary-side drive signal G_{T1} and the pulse width of the second primary-side drive signal G_{T2} to be greater than the cycle of the carrier signal V_{saw}, and the effective level of the first primary-side drive signal G_{T1} to overlap the effective level of the second primary-side drive signal G_{T2}, when the switching transistors in the primary-side full-bridge circuit 10 also serve as the switching transistors in the voltage conversion circuit, the leakage inductance current on the direct current side of the high-frequency-link micro inverter may freewheel through the first primary-side switching transistor T₁ and the second primary-side switching transistor T₂ and charge the decoupling capacitor C_{d} through the boost inductor L_{b} in the boost module 9 and the signal input terminal Vᵢₙ to transfer the twice-power-frequency power ripple in the primary-side full-bridge circuit 10 to the decoupling capacitor C_{d}, thereby suppressing the twice-power-frequency power ripple on the direct current side of the high-frequency-link micro inverter. Meanwhile, the requirements for the first capacitor Cᵢₙ connected in parallel to the signal input terminal Vᵢₙ of the high-frequency-link micro inverter can be reduced, thereby reducing the volume of the high-frequency-link micro inverter and prolonging the service life of the high-frequency-link micro inverter.

FIG. 24 is a flowchart of another signal modulation method for a high-frequency-link micro inverter according to an embodiment of the present application. Referring to FIS. 17 to 21 and 24, the signal modulation method for a high-frequency-link micro inverter includes steps S410 to S440.

In S410, a reference signal U_{squ} and a first intermediate signal Uₖ₂ are formed according to a carrier signal V_{saw} and a first modulation signal V_{ref1}, where the first modulation signal V_{ref1} includes a twice-power-frequency voltage ripple component on the direct current side of the high-frequency-link micro inverter.

In S420, a primary-side drive signal is formed according to the reference signal U_{squ} and the first intermediate signal Uₖ₂ to drive the primary-side full-bridge circuit.

In S430, a second intermediate signal Uₖ₁ is formed according to the carrier signal V_{saw} and a second modulation signal V_{ref2}.

The switching transistors in the primary-side full-bridge circuit 10 and the boost module 9 constitute the voltage conversion circuit, that is, the switching transistors in the primary-side full-bridge circuit 10 also serve as the voltage converter circuit, so that the switching transistors in the primary-side full-bridge circuit 10 are no longer independent. At this point, the first modulation signal V_{ref1} is used for forming a primary-side drive signal and the second modulation signal V_{ref2} is used for forming a secondary-side drive signal so that the switching transistors in the primary-side full-bridge circuit 10 and the switching transistors in the secondary-side conversion circuit 30 are modulated independently, thereby ensuring the proper operation of the primary-side full-bridge circuit 10 and achieving the voltage conversion function of the voltage conversion circuit when the switching transistors in the primary-side full-bridge circuit 10 also serve as the voltage conversion circuit. The second modulation signal V_{ref2} may include a sine wave signal. When the second intermediate signal Uₖ₁ is to be formed according to the carrier signal V_{saw} and the second modulation signal V_{ref2}, the second intermediate signal Uₖ₁ may be formed according to the amplitude of the carrier signal V_{saw} and the amplitude of the second modulation signal V_{ref2}. As shown in FIG. 21, the maximum amplitude of the carrier signal V_{saw} is greater than the maximum amplitude of the second modulation signal V_{ref2}. When the second intermediate signal Uₖ₁ is to be formed, the amplitude of the carrier signal V_{saw} and the amplitude of the second modulation signal V_{ref2} may be compared. When the amplitude of the second modulation signal V_{ref2} is greater than the amplitude of the carrier signal V_{saw}, the second intermediate signal Uₖ₁ may be 1; when the amplitude of the second modulation signal V_{ref2} is less than the amplitude of the carrier signal V_{saw}, the second intermediate signal Uₖ₁ may be 0. In this manner, the waveform of the second intermediate signal Uₖ₁ may be determined according to the amplitude of the carrier signal V_{saw} and the amplitude of the second modulation signal V_{ref2}. When the second modulation signal V_{ref2} has a sinusoidal waveform, the pulse width of the second intermediate signal Uₖ₁ is not equal in different modulation cycles, that is, the duty cycle of the second intermediate signal Uₖ₁ is different in different modulation cycles.

It is to be noted that when the second modulation signal V_{ref2} is a sine wave signal, the second modulation signal V_{ref2} may include a first modulation sub-signal V_{ref21} and a second modulation sub-signal V_{ref22}, and the first modulation sub-signal V_{ref21} and the second modulation sub-signal V_{ref22} are 180 degrees out of phase. When the second intermediate signal Uₖ₁ is to be formed according to the amplitude of the carrier signal V_{saw} and the amplitude of the second modulation signal V_{ref2}, the second intermediate signal Uₖ₁ may be formed according to the amplitude of the first modulation sub-signal V_{ref21} and the amplitude of the second modulation sub-signal V_{ref2} when the first modulation sub-signal V_{ref21} is in the positive half-cycle, and the second intermediate signal Uₖ₁ may be formed according to the amplitude of the second modulation sub-signal V_{ref22} and the amplitude of the second modulation sub-signal V_{ref2} when the second modulation sub-signal V_{ref22} is in the positive half-cycle, so that the waveform of the second intermediate signal Uₖ₁ may be a square wave greater than zero.

In S440, a secondary-side drive signal is formed according to the reference signal U_{squ} and the second intermediate signal Uₖ₁ to drive the secondary-side conversion circuit.

When the secondary-side drive signal is to be formed according to the reference signal U_{squ} and the second intermediate signal Uₖ₁, the secondary-side drive signal may be formed by performing a logical operation on the reference signal U_{squ} and the second intermediate signal Uₖ₁ to drive the secondary-side conversion circuit 30 so that the secondary-side conversion circuit 30 can perform waveform conversion on the voltage output by the transformer module 20, thereby enabling the high-frequency-link micro inverter to output a power-frequency alternating-current signal.

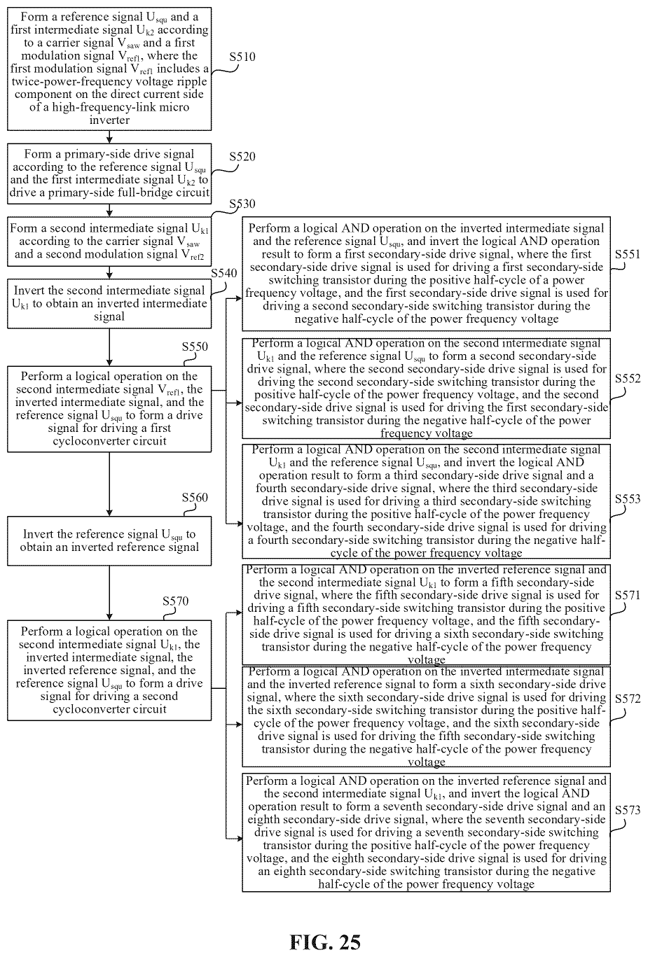

On the basis of the preceding solutions, FIG. 25 is a flowchart of another signal modulation method for a high-frequency-link micro inverter according to an embodiment of the present application. Continuing to refer to FIGS. 17 to 21 and 25, in FIG. 21, Goi is the waveform of a drive signal corresponding to the first secondary-side switching transistor Q₁, G_{Q2} is the waveform of a drive signal corresponding to the second secondary-side switching transistor Q₂, G_{Q3} is the waveform of a drive signal corresponding to the third secondary-side switching transistor Q₃, G_{Q4} is the waveform of a drive signal corresponding to the fourth secondary-side switching transistor Q₄, G_{Q5} is the waveform of a drive signal corresponding to the fifth secondary-side switching transistor Q₅, G_{Q6} is the waveform of a drive signal corresponding to the sixth secondary-side switching transistor Q₆, G_{Q7} is the waveform of a drive signal corresponding to the seventh secondary-side switching transistor Q₇, and G_{Q8} is the waveform of a drive signal corresponding to the eighth secondary-side switching transistor Q₈. The secondary-side winding N₈ includes a first secondary-side winding Nₛ₁ and a second secondary-side winding Nₛ₂, and the secondary-side conversion circuit 30 includes a first cycloconverter circuit 41 and a second cycloconverter circuit 42. The first cycloconverter circuit 41 is connected to the first secondary-side winding Nₛ₁, the second cycloconverter circuit 42 is connected to the second secondary-side winding Nₛ₂, and the first secondary-side winding Nₛ₁ and the second secondary-side winding Nₛ₂ are connected to the ground terminal n. As shown in FIG. 25, the signal modulation method for a high-frequency-link micro inverter includes steps S510 to S570.

In S510, a reference signal U_{squ} and a first intermediate signal Uₖ₂ are formed according to a carrier signal V_{saw} and a first modulation signal V_{ref1}, where the first modulation signal V_{ref1} includes a twice-power-frequency voltage ripple component on the direct current side of the high-frequency-link micro inverter.

In S520, a primary-side drive signal is formed according to the reference signal U_{squ} and the first intermediate signal Uₖ₂ to drive the primary-side full-bridge circuit.

In S530, a second intermediate signal Uₖ₁ is formed according to the carrier signal V_{saw} and a second modulation signal V_{ref2}.

In S540, the second intermediate signal Uₖ₁ is inverted to obtain an inverted intermediate signal.

The second intermediate signal Uₖ₁ is a square wave signal having a varying pulse width, and after the second intermediate signal Uₖ₁ is inverted, the inverted intermediate signal is also a square wave signal having a varying pulse width.

In S550, a logical operation is performed on the second intermediate signal Uₖ₁, the inverted intermediate signal, and the reference signal U_{squ} to form a drive signal for driving the first cycloconverter circuit.

The drive signal of the first cycloconverter circuit 41 is used for driving the switching transistors in the first cycloconverter circuit 41 to enable the first cycloconverter circuit 41 to perform waveform conversion on the voltage output by the transformer module 20 during the positive half-cycle.

Optionally, continuing to refer to FIGS. 17 to 21 and 25, the first cycloconverter circuit 41 includes a first cycloconverter module 4111 and a first filter module 4121. The first cycloconverter module 4111 includes a first secondary-side switching transistor Q₁, a second secondary-side switching transistor Q₂, a third secondary-side switching transistor Q₃, and a fourth secondary-side switching transistor Q₄. The first secondary-side switching transistor Q₁ is connected between the first secondary-side winding Nₛ₁ and the second secondary-side switching transistor Q₂, the second secondary-side switching transistor Q₂ and the third secondary-side switching transistor Q₃ are connected to the first filter module 4121, and the fourth secondary-side switching transistor Q₄ is connected between the third secondary-side switching transistor Q₃ and the ground terminal n. The first filter module 4121 includes a first filter inductor L_{f1} and a first filter capacitor Cₒ₁. The first terminal of the first filter inductor L_{f1} is connected to the second secondary-side switching transistor Q₂ and the third secondary-side switching transistor Q₃, the second terminal of the first filter inductor L_{f1} is connected to the first electrode of the first filter capacitor Cₒ₁ and serves as the first single-phase output terminal A of the high-frequency-link micro inverter, and the second electrode of the first filter capacitor Cₒ₁ is connected to the ground terminal n.

The step where the logical operation is performed on the second intermediate signal Uₖ₁, the inverted intermediate signal, and the reference signal U_{squ} to form the drive signal for driving the first cycloconverter circuit includes steps S551 to S553.

In S551, a logical AND operation is performed on the inverted intermediate signal and the reference signal U_{squ}, and the logical AND operation result is inverted to form a first secondary-side drive signal, where the first secondary-side drive signal is used for driving the first secondary-side switching transistor during the positive half-cycle of a power frequency voltage, and the first secondary-side drive signal is used for driving the second secondary-side switching transistor during the negative half-cycle of the power frequency voltage.

The pulse width of the second intermediate signal Uₖ₁ is less than the cycle of the carrier signal V_{saw}, the pulse width of the inverted intermediate signal is greater than the cycle of the carrier signal V_{saw}, the frequency of the reference signal U_{squ} is one-half of the frequency of the second intermediate signal Uₖ₁, and the pulse width of the reference signal U_{squ} is equal to the cycle of the carrier signal V_{saw}. The pulse width of the first secondary-side drive signal formed by performing the logical AND operation and inversion on the inverted intermediate signal and the reference signal U_{squ} is greater than the cycle of the carrier signal V_{saw}. The power frequency voltage is the output voltage of the high-frequency-link micro inverter. As shown in FIG. 21, the first secondary-side drive signal drives the first secondary-side switching transistor Q₁ during the positive half-cycle Td1 of the power frequency voltage, and the first secondary-side drive signal drives the second secondary-side switching transistor Q₂ during the negative half-cycle Td2 of the power frequency voltage so that the state of the first secondary-side switching transistor Q1 during the positive half-cycle Td1 of the power frequency voltage is the same as the state of the second secondary-side switching transistor Q₂ during the negative half-cycle Td2 of the power frequency voltage.

In S552, a logical AND operation is performed on the second intermediate signal Uₖ₁ and the reference signal U_{squ} to form a second secondary-side drive signal, where the second secondary-side drive signal is used for driving the second secondary-side switching transistor during the positive half-cycle of the power frequency voltage, and the second secondary-side drive signal is used for driving the first secondary-side switching transistor during the negative half-cycle of the power frequency voltage.

The waveform of the second secondary-side drive signal formed by performing the logical AND operation on the second intermediate signal Uₖ₁ and the reference signal U_{squ} is the same as the waveform of the second intermediate signal Uₖ₁ corresponding to the same cycle of the carrier signal V_{saw}. As shown in FIG. 7, the second secondary-side drive signal drives the second secondary-side switching transistor Q₂ during the positive half-cycle Td1 of the power frequency voltage, and the second secondary-side drive signal drives the first secondary-side switching transistor Q₁ during the negative half-cycle Td2 of the power frequency voltage so that the state of the second secondary-side switching transistor Q₂ during the positive half-cycle Td1 of the power frequency voltage is the same as the state of the first secondary-side switching transistor Q₁ during the negative half-cycle Td2 of the power frequency voltage.

In S553, a logical AND operation is performed on the second intermediate signal Uₖ₁ and the reference signal U_{squ}, and the logical AND operation result is inverted to form a third secondary-side drive signal and a fourth secondary-side drive signal, where the third secondary-side drive signal is used for driving the third secondary-side switching transistor during the positive half-cycle of the power frequency voltage, and the fourth secondary-side drive signal is used for driving the fourth secondary-side switching transistor during the negative half-cycle of the power frequency voltage.

The third secondary-side drive signal and the fourth secondary-side drive signal formed by performing the logical AND operation and inversion on the second intermediate signal Uₖ₁ and the reference signal U_{squ} are signals opposite to the second secondary-side drive signal. In this manner, the state of the third secondary-side switching transistor Q₃ driven by the third secondary-side drive signal during the positive half-cycle Td1 of the power frequency voltage is opposite to the state of the second secondary-side switching transistor Q₂, and the state of the fourth secondary-side switching transistor Q₄ driven by the fourth secondary-side drive signal during the negative half-cycle Td2 of the power frequency voltage is opposite to the state of the first secondary-side switching transistor Q₁.

In S560, the reference signal U_{squ} is inverted to obtain an inverted reference signal.

The reference signal U_{squ} is a square wave signal having the same pulse width, and the pulse width of the reference signal U_{squ} is equal to the cycle of the carrier signal V_{saw}. After the reference signal U_{squ} is inverted, the pulse width of the inverted reference signal is the same and is equal to the cycle of the carrier signal V_{saw}.

In S570, a logical operation is performed on the second intermediate signal Uₖ₁, the inverted intermediate signal, the inverted reference signal, and the reference signal U_{squ} to form a drive signal for driving the second cycloconverter circuit.

The drive signal of the second cycloconverter circuit 42 is used for driving the switching transistors in the second cycloconverter circuit 42 to enable the second cycloconverter circuit 42 to perform waveform conversion on the voltage output by the transformer module 20 during the negative half-cycle.

Optionally, continuing to refer to FIGS. 17 to 21 and 25, the second cycloconverter circuit 42 includes a second cycloconverter module 4112 and a second filter module 4122. The second cycloconverter module 4112 includes a fifth secondary-side switching transistor Q₅, a sixth secondary-side switching transistor Q₆, a seventh secondary-side switching transistor Q₇, and an eighth secondary-side switching transistor Q₈. The fifth secondary-side switching transistor Q₅ is connected between the second secondary-side winding Nₛ₂ and the sixth secondary-side switching transistor Q₆, the sixth secondary-side switching transistor Q₆ and the eighth secondary-side switching transistor Q₈ are connected to the second filter module 4122, and the seventh secondary-side switching transistor Q₇ is connected between the eighth secondary-side switching transistor Q₈ and the ground terminal n. The second filter module 4122 includes a second filter inductor L_{f2} and a second filter capacitor Cₒ₂. The first terminal of the second filter inductor L_{f2} is connected to the sixth secondary-side switching transistor Q₆ and the eighth secondary-side switching transistor Q₈, the second terminal of the second filter inductor L_{f2} is connected to the first electrode of the second filter capacitor Cₒ₂ and serves as the second single-phase output terminal B of the high-frequency-link micro inverter, and the second electrode of the second filter capacitor Cₒ₂ is connected to the ground terminal n.

The step where the logical operation is performed on the second intermediate signal Uₖ₁, the inverted intermediate signal, the inverted reference signal, and the reference signal U_{squ} to form the drive signal for driving the second cycloconverter circuit includes steps S571 to S573.

In S571, a logical AND operation is performed on the inverted reference signal and the second intermediate signal Uₖ₁ to form a fifth secondary-side drive signal, where the fifth secondary-side drive signal is used for driving the fifth secondary-side switching transistor during the positive half-cycle of the power frequency voltage, and the fifth secondary-side drive signal is used for driving the sixth secondary-side switching transistor during the negative half-cycle of the power frequency voltage.

The frequency of the reference signal U_{squ} is one-half of the frequency of the second intermediate signal Uₖ₁, and the pulse width of the reference signal U_{squ} is equal to the cycle of the carrier signal V_{saw}. The pulse width of the inverted reference signal is equal to the cycle of the carrier signal V_{saw}, and the frequency of the inverted reference signal U_{squ} is one-half of the frequency of the second intermediate signal Uₖ₁. The pulse width of the second intermediate signal Uₖ₁ is less than the cycle of the carrier signal V_{saw}, and the pulse width of the second intermediate signal Uₖ₁ varies in different cycles of the carrier signal V_{saw}. The waveform of the fifth secondary-side drive signal formed by performing the logical AND operation on the inverted reference signal and the second intermediate signal Uₖ₁ is the same as the waveform of the second intermediate signal Uₖ₁ in the same cycle of the carrier signal V_{saw}. As shown in FIG. 21, the fifth secondary-side drive signal drives the fifth secondary-side switching transistor Q₅ during the positive half-cycle Td1 of the power frequency voltage, and the fifth secondary-side drive signal drives the sixth secondary-side switching transistor Q₆ during the negative half-cycle Td2 of the power frequency voltage so that the state of the fifth secondary-side switching transistor Q₅ during the positive half-cycle Td1 of the power frequency voltage is the same as the state of the sixth secondary-side switching transistor Q₆ during the negative half-cycle Td2 of the power frequency voltage.

In S572, a logical AND operation is performed on the inverted intermediate signal and the inverted reference signal to form a sixth secondary-side drive signal, where the sixth secondary-side drive signal is used for driving the sixth secondary-side switching transistor during the positive half-cycle of the power frequency voltage, and the sixth secondary-side drive signal is used for driving the fifth secondary-side switching transistor during the negative half-cycle of the power frequency voltage.

The pulse width of the sixth secondary-side drive signal formed by performing the logical AND operation on the inverted intermediate signal and the inverted reference signal is greater than the cycle of the carrier signal V_{saw}. As shown in FIG. 7, the sixth secondary-side drive signal drives the sixth secondary-side switching transistor Q₆ during the positive half-cycle Td1 of the power frequency voltage, and the sixth secondary-side drive signal drives the fifth secondary-side switching transistor Q₅ during the negative half-cycle Td2 of the power frequency voltage so that the state of the sixth secondary-side switching transistor Q₆ during the positive half-cycle Td1 of the power frequency voltage is the same as the state of the fifth secondary-side switching transistor Q₅ during the negative half-cycle Td2 of the power frequency voltage.

In S573, a logical AND operation is performed on the inverted reference signal and the second intermediate signal Uₖ₁, and the logical AND operation result is inverted to form a seventh secondary-side drive signal and an eighth secondary-side drive signal, where the seventh secondary-side drive signal is used for driving the seventh secondary-side switching transistor during the positive half-cycle of the power frequency voltage, and the eighth secondary-side drive signal is used for driving the eighth secondary-side switching transistor during the negative half-cycle of the power frequency voltage.

The seventh secondary-side drive signal and the eighth secondary-side drive signal formed by performing the logical AND operation and inversion on the inverted reference signal and the second intermediate signal Uₖ₁ are signals opposite to the fifth secondary-side drive signal. In this manner, the state of the seventh secondary-side switching transistor Q₇ driven by the seventh secondary-side drive signal during the positive half-cycle Td1 of the power frequency voltage is opposite to the state of the fifth secondary-side switching transistor Q₅, and the state of the eighth secondary-side switching transistor Q₈ driven by the eighth secondary-side drive signal during the negative half-cycle Td2 of the power frequency voltage is opposite to the state of the fifth secondary-side switching transistor Q₅.

Continuing to refer to FIGS. 17 to 21, on the basis of the preceding solutions, when the drive signal for driving the first cycloconverter module is formed, the method further includes:
the third secondary-side switching transistor Q₃ and the seventh secondary-side switching transistor Q₇ are in an on-state during the negative half-cycle Td2 of the power frequency voltage;
when the drive signal for driving the second cycloconverter module is formed, the method further includes: the fourth secondary-side switching transistor Q₄ and the eighth secondary-side switching transistor Q₈ are in an on-state during the positive half-cycle Td1 of the power frequency voltage.

As shown in FIG. 21, the waveforms of the drive signals of the third secondary-side switching transistor Q₃ and the seventh secondary-side switching transistor Q₇ during the negative half-cycle Td2 of the power frequency voltage are at an effective level to enable the third secondary-side switching transistor Q₃ and the seventh secondary-side switching transistor Q₇ to be in the on-state, thereby reducing the switching loss of the secondary-side switching transistors during the positive half-cycle Td1 of the power frequency voltage. Similarly, the waveforms of the drive signals of the fourth secondary-side switching transistor Q₄ and the eighth secondary-side switching transistor Q₈ during the positive half-cycle Td1 of the power frequency voltage are at an effective level to enable the fourth secondary-side switching transistor Q₄ and the eighth secondary-side switching transistor Q₈ to be in the on-state, thereby reducing the switching loss of the secondary-side switching transistors during the negative half-cycle Td2 of the power frequency voltage.

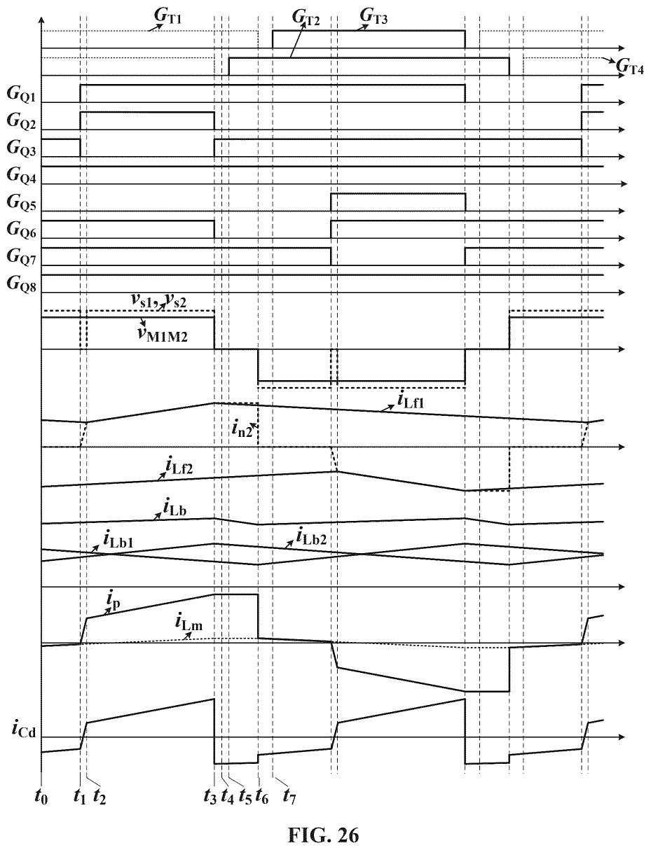

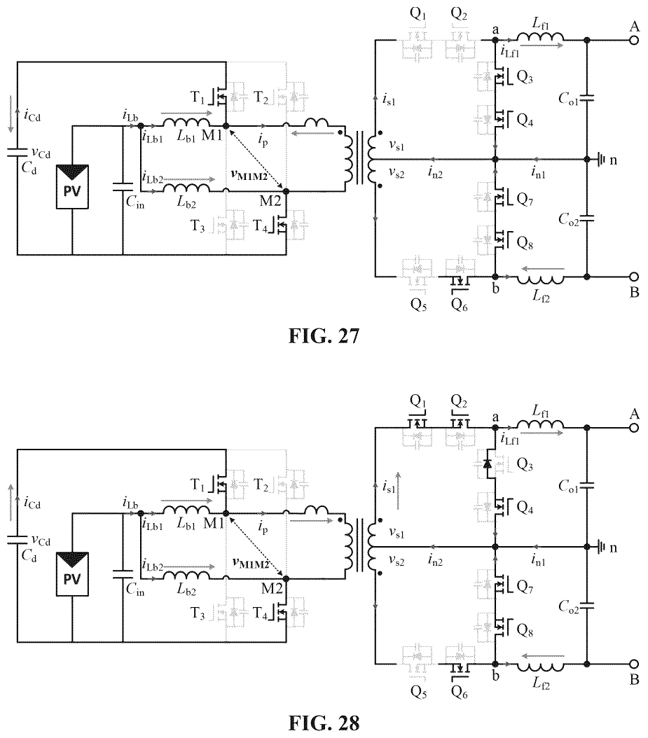

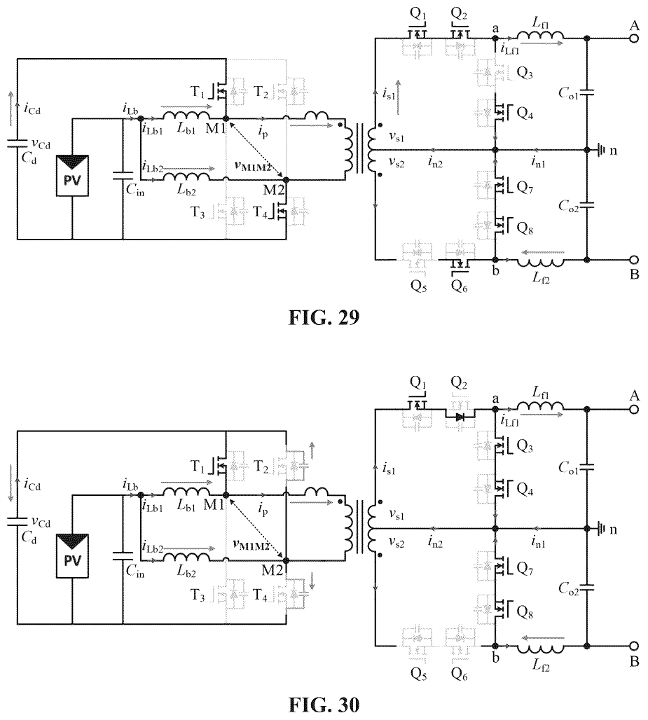

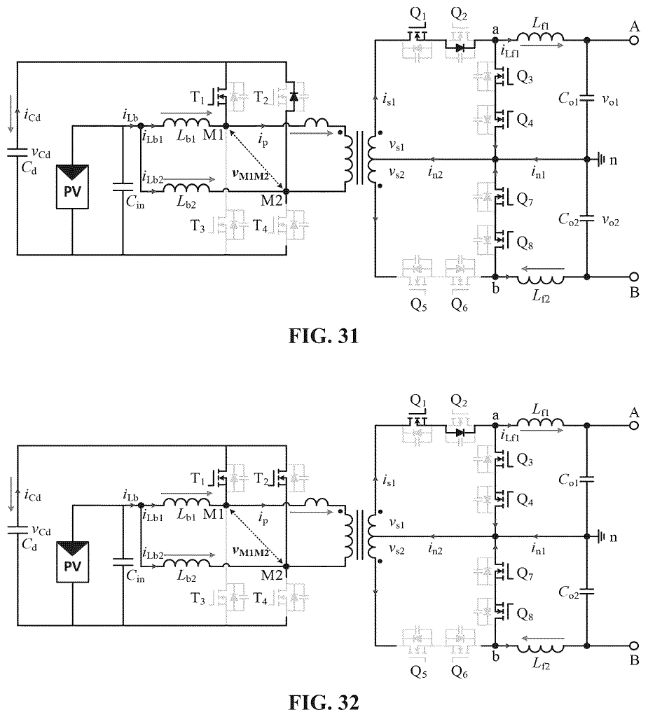

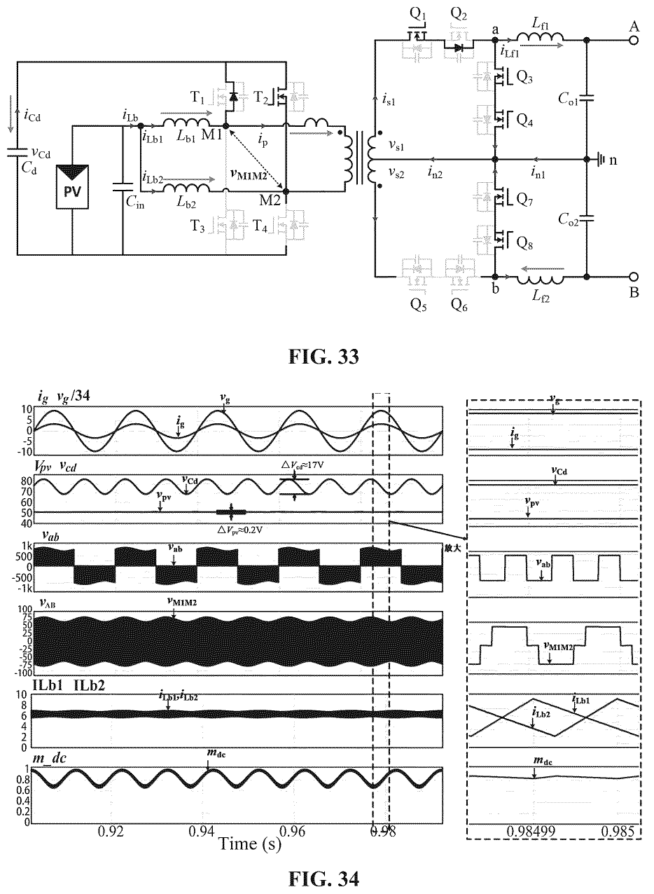

FIG. 26 is a schematic diagram of the waveforms of different signals of a high-frequency-link micro inverter during a positive half-cycle of a power frequency voltage according to an embodiment of the present application. In FIG. 26, vₛ₁ is the voltage across the first secondary-side winding Nₛ₁, vₛ₂ is the voltage across the second secondary-side winding Nₛ₂, v_{M1M2} is the square wave voltage generated by the primary-side full-bridge circuit 10, i_{Lb1} is the current in the first boost inductor L_{b1}, i_{Lb2} is the current in the second boost inductor L_{b2}, i_{Lb} is the sum of the current i_{Lb1} on the first boost inductor L_{b1} and the current i_{Lb2} on the second boost inductor L_{b2}, i_{Lf1} is the current in the first filter inductor L_{f1}, i_{Lf2} is the current in the second filter inductor L_{f2}, iₙ₂ is the current from the second terminal of the first secondary-side winding Nₛ₁ to the fourth secondary-side switching transistor Q₄, iₚ is the primary-side leakage inductance current of the transformer module 20, i_{Lm} is the magnetizing inductance current of the transformer module 20, i_{Cd} is the current of the decoupling capacitor C_{d}, and v_{Cd} is the voltage of the decoupling capacitor C_{d}. FIG. 27 is a structural diagram of a high-frequency-link micro inverter in an operating mode 1 [t₀-t₁] according to an embodiment of the present application, FIG. 28 is a structural diagram of a high-frequency-link micro inverter in an operating mode 2 [t₁-t₂] according to an embodiment of the present application, FIG. 29 is a structural diagram of a high-frequency-link micro inverter in an operating mode 3 [t₂-t₃] according to an embodiment of the present application, FIG. 30 is a structural diagram of a high-frequency-link micro inverter in an operating mode 4 [t₃-t₄] according to an embodiment of the present application, FIG. 31 is a structural diagram of a high-frequency-link micro inverter in an operating mode 5 [t₄-t₅] according to an embodiment of the present application, FIG. 32 is a structural diagram of a high-frequency-link micro inverter in an operating mode 6 [t₅-t₆] according to an embodiment of the present application, and FIG. 33 is a structural diagram of a high-frequency-link micro inverter in an operating mode 7 [t₆-t₇] according to an embodiment of the present application. The modulation process of the high-frequency-link micro inverter is described below in conjunction with FIGS. 17 to 21 and 25 to 33.

In the operating mode 1 [t₀-t₁], as shown in FIG. 27, before the time to, the high-frequency-link micro inverter has already reached a steady state. The first primary-side switching transistor T₁ and the fourth primary-side switching transistor T₄ are turned on, the second primary-side switching transistor T₂ and the third primary-side switching transistor T₃ are turned off, the third secondary-side switching transistor Q₃, the fourth secondary-side switching transistor Q₄, the sixth secondary-side switching transistor Q₆, the seventh secondary-side switching transistor Q₇, and the eighth secondary-side switching transistor Q₈ are turned on, and the first secondary-side switching transistor Q₁, the second secondary-side switching transistor Q₂, and the fifth secondary-side switching transistor Q₅ are turned off. At this point, the first boost inductor L_{b1} and the signal input terminal Vᵢₙ are discharged into the decoupling capacitor C_{d} through the first primary-side switching transistor T₁ to perform voltage conversion on the input signal. The second boost inductor L_{b2} stores power through the fourth primary-side switching transistor T₄. The first filter inductor L_{f1} freewheels through the third secondary-side switching transistor Q₃ and the fourth secondary-side switching transistor Q₄, and the second filter inductor L_{f2} freewheels through the seventh secondary-side switching transistor Q₇ and the eighth secondary-side switching transistor Q₈ so that the output voltage v_{ab} on the alternating current side of the high-frequency-link micro inverter is clamped to zero level, where v_{ab} is the voltage between the output terminal a of the first cycloconverter module 4111 and the output terminal b of the second cycloconverter module 4112. At the time t₁, the first secondary-side switching transistor Q₁ and the second secondary-side switching transistor Q₂ are turned on, the third secondary-side switching transistor Q₃ is turned off, and then the operating mode 1 [t₀-t₁] ends.

In the operating mode 2 [t₁-t₂], as shown in FIG. 28, the states of the switching transistors on the direct current side of the high-frequency-link micro inverter remain unchanged, the first secondary-side switching transistor Q₁, the second secondary-side switching transistor Q₂, the fourth secondary-side switching transistor Q₄, the sixth secondary-side switching transistor Q₆, the seventh secondary-side switching transistor Q₇, and the eighth secondary-side switching transistor Q₈ are turned on, and the third secondary-side switching transistor Q₃ and the fifth secondary-side switching transistor Q₅ are turned off. At this point, the current iₛ₁ provided by the first terminal of the first secondary-side winding Nₛ₁ is less than the current i_{Lf1} on the first filter inductor L_{f1}, and the body diode of the third secondary-side switching transistor Q₃ is turned on so that the output voltage v_{ab} on the alternating current side of the high-frequency-link micro inverter is still clamped to zero level, resulting in the loss of the duty cycle of the modulation signal corresponding to the operating mode 2 [t₁-t₂]. When the current iₛ₁ provided by the first terminal of the first secondary-side winding Nₛ₁ is equal to the current i_{Lf1} on the first filter inductor L_{f1}, the body diode of the third secondary-side switching transistor Q₃ is turned off, and then the operating mode 2 [t₁-t₂] ends.

In the operating mode 3 [t₂-t₃], as shown in FIG. 29, the body diode of the third secondary-side switching transistor Q₃ is turned off, and the states of other switching transistors remain unchanged. At this point, the first secondary-side winding Nₛ₁, the first secondary-side switching transistor Q₁, the second secondary-side switching transistor Q₂, the first filter inductor L_{f1}, and the first filter capacitor Cₒ₁ form a loop, the power on the input side of the high-frequency-link micro inverter is transferred to the output side, the current i_{Lf1} on the first filter inductor L_{f1} starts to increase until the fourth primary-side switching transistor T₄ is turned off at the time t₃, and then the operating mode 3 [t₂-t₃] ends.

In the operating mode 4 [t₃-t₄], as shown in FIG. 30, the first primary-side switching transistor T₁ is turned on, the second primary-side switching transistor T₂, the third primary-side switching transistor T₃, and the fourth primary-side switching transistor T₄ are turned off, the first secondary-side switching transistor Q₁, the third secondary-side switching transistor Q₃, the fourth secondary-side switching transistor Q₄, the seventh secondary-side switching transistor Q₇, and the eighth secondary-side switching transistor Q₈ are turned on, and the second secondary-side switching transistor Q₂, the fifth secondary-side switching transistor Q₅, and the sixth secondary-side switching transistor Q₆ are turned off. At this point, the output capacitor of the fourth primary-side switching transistor T₄ starts to charge, and meanwhile, the output capacitor of the second primary-side switching transistor T₂ starts to discharge to charge the decoupling capacitor C_{d}. The third secondary-side switching transistor Q₃, the fourth secondary-side switching transistor Q₄, the seventh secondary-side switching transistor Q₇, and the eighth secondary-side switching transistor Q₈ are turned on, the first filter inductor L_{f1} freewheels through the third secondary-side switching transistor Q₃ and the fourth secondary-side switching transistor Q₄, and the second filter inductor L_{f2} freewheels through the seventh secondary-side switching transistor Q₇ and the eighth secondary-side switching transistor Q₈ so that the output voltage v_{ab} on the alternating current side of the high-frequency-link micro inverter is clamped to zero level.

In the operating mode 5 [t₄-t₅], the output capacitor of the fourth primary-side switching transistor T₄ has been fully charged, and the output capacitor of the second primary-side switching transistor T₂ has been fully discharged. At this point, the leakage inductance current iₚ freewheels through the body diode of the second primary-side switching transistor T₂ to achieve the zero-voltage turn-on of the second primary-side switching transistor T₂. The output voltage v_{ab} on the alternating current side of the high-frequency-link micro inverter is maintained at the zero level.

In the operating mode 6 [t₅-t₆], the second primary-side switching transistor T₂ is turned on at zero-voltage, the leakage inductance current iₚ freewheels through the first primary-side switching transistor T₁ and the second primary-side switching transistor T₂, and the first boost inductor L_{b1}, the second boost inductor L_{b2}, and the signal input terminal Vᵢₙ charge the decoupling capacitor C_{d} through the first primary-side switching transistor T₁ and the second primary-side switching transistor T₂, thereby increasing the output voltage of the decoupling capacitor C_{d}. When the decoupling capacitor C_{d} is discharged, the first-stage voltage conversion can be achieved, thereby increasing the gain of the high-frequency-link micro inverter. When the gain of the high-frequency-link micro inverter is required to remain unchanged, the requirements for the transformation ratio of the transformer module can be reduced, thereby reducing the efficiency loss caused by the parasitic parameters of the transformer module and increasing the efficiency of the high-frequency-link micro inverter. Moreover, the twice-power-frequency power ripple in the primary-side full-bridge circuit may be transferred to the boost module, thereby suppressing the twice-power-frequency power ripple on the direct current side of the high-frequency-link micro inverter. Meanwhile, the requirements for the first capacitor connected in parallel to the signal input terminal of the high-frequency-link micro inverter can be reduced, thereby reducing the volume of the high-frequency-link micro inverter and prolonging the service life of the high-frequency-link micro inverter. At this point, the output voltage v_{ab} on the alternating current side of the high-frequency-link micro inverter is maintained at the zero level.

In the operating mode 7 [t₆-t₇], the first primary-side switching transistor T₁ is turned off, and the current iₛ₁, which is supplied by the first terminal of the first secondary-side winding Nₛ₁ and induced by the leakage inductance current iₚ, freewheels to zero through the body diode of the first secondary-side switching transistor Q₁, the body diode of the second secondary-side switching transistor Q₂, the third secondary-side switching transistor Q₃, and the fourth secondary-side switching transistor Q₃. At the time t₇, the third primary-side switching transistor T₃ is turned on, and the high-frequency-link micro inverter enters the operating modes corresponding to the negative half-cycle of the power frequency voltage. The specific operating modes are similar to the operating modes during the positive half-cycle of the power frequency voltage, which is not repeated herein.

On the basis of the preceding solutions, FIG. 34 is a schematic diagram of waveform simulation of a high-frequency-link micro inverter according to an embodiment of the present application. The boost module 9 in the high-frequency-link micro inverter includes a first boost inductor L_{b1} and a second boost inductor L_{b2}, and at this point, the voltage conversion circuit composed of the boost module 9 and the primary-side full-bridge circuit 10 is an interleaved parallel boost circuit. The first electrode of the decoupling capacitor C_{d} is connected to the first terminal N1 of the first bridge arm 21, and the second electrode of the decoupling capacitor C_{d} is connected to the first terminal N3 of the second bridge arm 22. The grid voltage v_{g}/34 is 240 VAC±10%, the voltage Vₚᵥ of the input signal is 22 V to 55 V, the first capacitor Cᵢₙ is 10 uF, the decoupling capacitor C_{d} is 1300 uF, the maximum output power of the high-frequency-link micro inverter is 600 W, i_{g} is the grid current, v_{cd} is the voltage across the decoupling capacitor C_{d}, and v_{M1M2} is the square wave voltage generated by the primary-side full-bridge circuit 10. As can be seen from FIG. 20, by modulating the switching transistors in the primary-side full-bridge circuit 10, the voltage ripple in the first capacitor Cᵢₙ may be only ΔVₚᵥ=0.2 V, and the voltage ripple in the decoupling capacitor C_{d} is ΔV_{cd}~17 V. In this manner, the twice-power-frequency power ripple on the direct current side can be transferred to the decoupling capacitor C_{d}, and the requirements for the capacitance of the first capacitor Cᵢₙ can be reduced. In addition, m_{dc} is the modulating wave of the primary-side full-bridge circuit 10, which changes with the voltage ripple in the decoupling capacitor C_{d}, that is, with the twice-power-frequency power ripple. Further, as can be seen from the current i_{Lb1} in the first boost inductor L_{b1} and the current i_{Lb2} in the second boost inductor L_{b2}, the first boost inductor L_{b1} and the second boost inductor L_{b2} each carry a current for half the modulation cycle, with a phase difference of 180 degrees between them. When the transformer module 20 performs second-stage voltage conversion on the first voltage signal, the two cycloconverter modules 411 invert the input voltage signal so that the voltage v_{ab} between the output terminal a of the first cycloconverter module 4111 and the output terminal b of the second cycloconverter module 4112 becomes an alternating current square wave voltage. Then, the alternating current square wave voltage signal is filtered through the first filter module 4121 and the second filter module 4122 so that the waveform of the voltage v_{ab} between the first single-phase output terminal A and the second single-phase output terminal B tends to be sinusoidal.

The modulation signal V_{ref} in Embodiment One is also the second modulation signal V_{ref2} in Embodiment Two, and the intermediate signal Uₖ in Embodiment One is also the second intermediate signal Uₖ₁ in Embodiment Two.

### Embodiment Three

The embodiment provides a signal modulation apparatus for a high-frequency-link micro inverter. The signal modulation apparatus for a high-frequency-link micro inverter is connected to the topology of the high-frequency-link micro inverter. Continuing to refer to FIG. 3, the high-frequency-link micro inverter includes a primary-side full-bridge circuit 10, a transformer module 20, and a secondary-side conversion circuit 30. The primary-side full-bridge circuit 10 is connected to the primary-side winding Nₚ of the transformer module 20. The secondary-side conversion circuit 30 is connected to the secondary-side winding Nₛ of the transformer module 20.

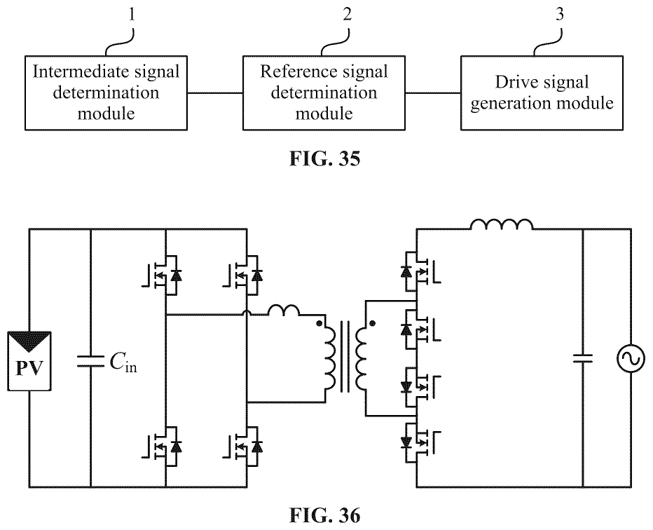

FIG. 35 is a structural diagram of a signal modulation apparatus for a high-frequency-link micro inverter according to an embodiment. On the basis of the preceding embodiments, in conjunction with FIGS. 3 and 35, the signal modulation apparatus for a high-frequency-link micro inverter provided in the embodiment herein includes an intermediate signal determination module 1, a reference signal determination module 2, and a drive signal generation module 3. The intermediate signal determination module 1 is configured to generate an intermediate signal according to a carrier signal and a modulation signal. The reference signal determination module 2 is configured to determine a reference signal according to the carrier signal. The drive signal generation module 3 is configured to generate a drive signal according to the carrier signal, the reference signal, and the intermediate signal, where the drive signal is used for driving the primary-side full-bridge circuit 10 and the secondary-side conversion circuit 30 to cause the high-frequency-link micro inverter to output at least a two-phase alternating-current voltage.

The signal modulation apparatus for a high-frequency-link micro inverter provided in the embodiment herein, generates, through the intermediate signal determination module 1, an intermediate signal according to a carrier signal and a modulation signal, determines, through the reference signal determination module 2, a reference signal according to the carrier signal, and generates, through the drive signal generation module 3, a drive signal according to the carrier signal, the reference signal, and the intermediate signal, the drive signal is used for driving the primary-side full-bridge circuit 10 and the secondary-side conversion circuit 30 to cause the high-frequency-link micro inverter to output at least a two-phase alternating-current voltage. The drive signal generated by the signal modulation apparatus for a high-frequency-link micro inverter provided in the embodiment herein is transmitted to the primary-side switching transistors in the primary-side full-bridge circuit 10 and the secondary-side switching transistors in the secondary-side conversion circuit 30 to enable the primary-side switching transistors in the primary-side full-bridge circuit 10 to achieve a full-range ZVS, thereby achieving primary-side circulating current elimination, obtaining a voltage spike suppression capability, improving the energy transmission efficiency and power density of the high-frequency-link micro inverter, and solving the problems of a narrow ZCS operational range and a low winding utilization rate of the transformer module caused when the drive signal generated by the existing signal modulation apparatus for a high-frequency-link micro inverter drives the topology of the high-frequency-link micro inverter.

In the case where the modulation signal is a second modulation signal, the intermediate signal is a second intermediate signal.

In an embodiment, the high-frequency-link micro inverter further includes a boost module 9. The boost module 9 is connected to at least one bridge arm in the primary-side full-bridge circuit 10 to form a voltage conversion circuit. The primary-side full-bridge circuit 10 is connected to the primary-side winding of the transformer module 20. The secondary-side conversion circuit 30 is connected to the secondary-side winding of the transformer module 20. The signal modulation apparatus for a high-frequency-link micro inverter is connected to the primary-side full-bridge circuit 10.

In the case where the modulation signal includes a first modulation signal and a second modulation signal, the intermediate signal includes a first intermediate signal and a second intermediate signal.

On the basis of the preceding solutions, the intermediate signal determination module 1 includes a first signal formation module and a second signal formation module. The first signal formation module is configured to form the first intermediate signal according to the amplitude of the carrier signal and the amplitude of the first modulation signal, where the first modulation signal includes a twice-power-frequency voltage ripple component on the direct current side of the high-frequency-link micro inverter. The second signal formation module is configured to form the second intermediate signal according to the amplitude of the carrier signal and the amplitude of the second modulation signal.

The reference signal determination module 2 includes a reference signal determination unit configured to obtain the reference signal by performing a frequency division by two on the rising edge of the carrier signal.

The drive signal generation module 3 includes a primary-side drive signal generation module and a secondary-side drive signal generation module. The primary-side drive signal generation module is configured to, in the case where the modulation signal is the second modulation signal, determine a primary-side drive signal according to the carrier signal, where the primary-side drive signal is used for driving the primary-side full-bridge circuit 10 to generate a square wave signal; and in the case where the modulation signal includes the first modulation signal and the second modulation signal, form a primary-side drive signal according to the carrier signal and the first intermediate signal to drive the primary-side full-bridge circuit 10. The secondary-side drive signal generation module is configured to form a secondary-side drive signal according to the reference signal and the second intermediate signal, where the secondary-side drive signal is used for driving the secondary-side conversion circuit 30 to perform waveform conversion on the voltage output by the transformer module 20.

On the basis of the preceding solutions, the primary-side full-bridge circuit 10 includes a first bridge arm 21 and a second bridge arm 22. The first bridge arm 21 includes a first primary-side switching transistor T₁ and a second primary-side switching transistor T₂, and the second bridge arm 22 includes a third primary-side switching transistor T₃ and a fourth primary-side switching transistor T₄. The first electrode of the first primary-side switching transistor T₁ is connected to the first electrode of the second primary-side switching transistor T₂, the second electrode of the first primary-side switching transistor T₁and the second electrode of the third primary-side switching transistor T₃ are connected to the first terminal M1 of the primary-side winding Nₚ, the first electrode of the third primary-side switching transistor T₃ is connected to the first electrode of the fourth primary-side switching transistor T₄, and the second electrode of the second primary-side switching transistor T₂ and the second electrode of the fourth primary-side switching transistor T₄ are connected to the second terminal M2 of the primary-side winding Nₚ.

In the case where the modulation signal is the second modulation signal, the primary-side drive signal generation module includes a first-fourth primary-side drive signal sub-unit, a second primary-side drive signal sub-unit, and a third primary-side drive signal sub-unit. The first-fourth primary-side drive signal sub-unit is configured to perform a frequency division by two on the rising edge of the carrier signal to obtain a first primary-side drive signal and a fourth primary-side drive signal of the primary-side full-bridge circuit 10. The second primary-side drive signal sub-unit is configured to invert the fourth primary-side drive signal to obtain a second primary-side drive signal. The third primary-side drive signal sub-unit is configured to invert the first primary-side drive signal to obtain a third primary-side drive signal. The first primary-side drive signal is used for driving a first primary-side switching transistor T₁ of the primary-side full-bridge circuit 10, the second primary-side drive signal is used for driving a second primary-side switching transistor T₂ of the primary-side full-bridge circuit 10, the third primary-side drive signal is used for driving a third primary-side switching transistor T₃ of the primary-side full-bridge circuit 10, and the fourth primary-side drive signal is used for driving a fourth primary-side switching transistor T₄ of the primary-side full-bridge circuit 10.

In the case where the modulation signal includes the first modulation signal and the second modulation signal, the primary-side drive signal generation module includes a second bridge arm drive formation unit and a first bridge arm drive formation unit. The second bridge arm drive formation unit is configured to perform a logical operation on the reference signal and the first intermediate signal to form a drive signal for driving the second bridge arm 22. The first bridge arm drive formation unit is configured to perform a logical operation on the drive signal for driving the second bridge arm 22 to form a drive signal for driving the first bridge arm 21.

On the basis of the preceding solutions, the second bridge arm drive formation unit includes: a third primary-side drive signal sub-unit configured to perform a logical AND operation on the reference signal and the first intermediate signal to form a third primary-side drive signal to drive the third primary-side switching transistor T₃ and a fourth primary-side drive signal sub-unit configured to invert the reference signal and perform a logical AND operation on the inverted reference signal and the first intermediate signal to form a fourth primary-side drive signal to drive the fourth primary-side switching transistor T₄; and/or the first bridge arm drive formation unit includes: a first primary-side drive signal sub-unit configured to invert the third primary-side drive signal to form a first primary-side drive signal to drive the first primary-side switching transistor T₁, and a second primary-side drive signal sub-unit configured to invert the fourth primary-side drive signal to form a second primary-side drive signal to drive the second primary-side switching transistor T₂.

On the basis of the preceding solutions, the signal modulation apparatus for a high-frequency-link micro inverter is also connected to the secondary-side conversion circuit 30. The signal modulation apparatus for a high-frequency-link micro inverter further includes a secondary-side drive signal formation module configured to form a secondary-side drive signal according to the reference signal and the second intermediate signal to drive the secondary-side conversion circuit 30.

On the basis of the preceding solutions, the secondary-side winding Nₛ includes a first secondary-side winding Nₛ₁ and a second secondary-side winding Nₛ₂, and the secondary-side conversion circuit 30 includes a first cycloconverter circuit 41 and a second cycloconverter circuit 42. The first cycloconverter circuit 41 includes a first cycloconverter module 4111 and a first filter module 4121, and the first cycloconverter module 4111 is connected to the first secondary-side winding Nₛ₁. The second cycloconverter circuit 42 includes a second cycloconverter module 4112 and a second filter module 4122, and the second cycloconverter module 4112 is connected to the second secondary-side winding Nₛ₂. The first secondary-side winding Nₛ₁ and the second secondary-side winding Nₛ₂ are connected to the ground terminal n. The secondary-side drive signal generation module includes an inverted intermediate signal formation unit, a first cycle drive signal formation unit, an inverted reference signal formation unit, and a second cycle drive signal formation unit. The inverted intermediate signal formation unit is configured to invert the second intermediate signal to obtain an inverted intermediate signal. The first cycle drive signal formation unit is configured to perform a logical operation on the second intermediate signal, the inverted intermediate signal, and the reference signal to form a drive signal for driving the first cycloconverter module 4111. The inverted reference signal formation unit is configured to invert the reference signal to obtain an inverted reference signal. The second cycle drive signal formation unit is configured to perform a logical operation on the second intermediate signal, the inverted intermediate signal, the inverted reference signal, and the reference signal to form a drive signal for driving a second cycloconverter module 4112.

On the basis of the preceding solutions, the first cycloconverter module 4111 includes a first secondary-side switching transistor Q₁, a second secondary-side switching transistor Q₂, a third secondary-side switching transistor Q₃, and a fourth secondary-side switching transistor Q₄. The first secondary-side switching transistor Q₁ is connected between the first secondary-side winding Nₛ₁ and the second secondary-side switching transistor Q₂, the second secondary-side switching transistor Q₂ and the third secondary-side switching transistor Q₃ are connected to the first filter module 4121, and the fourth secondary-side switching transistor Q₄ is connected between the third secondary-side switching transistor Q₃ and the ground terminal n. The first cycle drive signal formation unit includes a first secondary-side drive signal formation sub-unit, a second secondary-side drive signal formation sub-unit, and a third-fourth secondary-side drive signal formation sub-unit. The first secondary-side drive signal formation sub-unit is configured to perform a logical AND operation on the inverted intermediate signal and the reference signal and invert the logical AND operation result to form a first secondary-side drive signal, where the first secondary-side drive signal is used for driving the first secondary-side switching transistor Q₁ during the positive half-cycle of a power frequency voltage, and the first secondary-side drive signal is used for driving the second secondary-side switching transistor Q₂ during the negative half-cycle of the power frequency voltage. The second secondary-side drive signal formation sub-unit is configured to perform a logical AND operation on the second intermediate signal and the reference signal to form a second secondary-side drive signal, where the second secondary-side drive signal is used for driving the second secondary-side switching transistor Q₂ during the positive half-cycle of the power frequency voltage, and the second secondary-side drive signal is used for driving the first secondary-side switching transistor Q₁ during the negative half-cycle of the power frequency voltage. The third-fourth secondary-side drive signal formation sub-unit is configured to perform a logical AND operation on the second intermediate signal and the reference signal and invert the logical AND operation result to form a third secondary-side drive signal and a fourth secondary-side drive signal, where the third secondary-side drive signal is used for driving the third secondary-side switching transistor Q₃ during the positive half-cycle of the power frequency voltage, and the fourth secondary-side drive signal is used for driving the fourth secondary-side switching transistor Q₄ during the negative half-cycle of the power frequency voltage.

On the basis of the preceding solutions, the second cycloconverter module 4112 includes a fifth secondary-side switching transistor Q₅, a sixth secondary-side switching transistor Q₆, a seventh secondary-side switching transistor Q₇, and an eighth secondary-side switching transistor Q₈. The fifth secondary-side switching transistor Q₅ is connected between the second secondary-side winding Nₛ₂ and the sixth secondary-side switching transistor Q₆, the sixth secondary-side switching transistor Q₆ and the eighth secondary-side switching transistor Q₈ are connected to the second filter module 4122, and the seventh secondary-side switching transistor Q₇ is connected between the eighth secondary-side switching transistor Q₈ and the ground terminal n. The second cycle drive signal formation unit includes a fifth secondary-side drive signal formation sub-unit, a sixth secondary-side drive signal formation sub-unit, and a seventh-eighth secondary-side drive signal formation sub-unit. The fifth secondary-side drive signal formation sub-unit is configured to perform a logical AND operation on the inverted reference signal and the second intermediate signal to form a fifth secondary-side drive signal, where the fifth secondary-side drive signal is used for driving the fifth secondary-side switching transistor Q₅ during the positive half-cycle of the power frequency voltage, and the fifth secondary-side drive signal is used for driving the sixth secondary-side switching transistor Q₆ during the negative half-cycle of the power frequency voltage. The sixth secondary-side drive signal formation sub-unit is configured to perform a logical AND operation on the inverted intermediate signal and the inverted reference signal to form a sixth secondary-side drive signal, where the sixth secondary-side drive signal is used for driving the sixth secondary-side switching transistor Q₆ during the positive half-cycle of the power frequency voltage, and the sixth secondary-side drive signal is used for driving the fifth secondary-side switching transistor Q₅ during the negative half-cycle of the power frequency voltage. The seventh-eighth secondary-side drive signal formation sub-unit is configured to perform a logical AND operation on the inverted reference signal and the second intermediate signal and invert the logical AND operation result to form a seventh secondary-side drive signal and an eighth secondary-side drive signal, where the seventh secondary-side drive signal is used for driving the seventh secondary-side switching transistor Q₇ during the positive half-cycle of the power frequency voltage, and the eighth secondary-side drive signal is used for driving the eighth secondary-side switching transistor Q₈ during the negative half-cycle of the power frequency voltage.

On the basis of the preceding solutions, the signal modulation apparatus for a high-frequency-link micro inverter further includes a turn-on control module. The turn-on control module is configured to, when the first cycle drive signal formation unit forms the drive signal for driving the first cycloconverter module 4111, maintain the third secondary-side drive signal and the seventh secondary-side drive signal at a turn-on level during the negative half-cycle of the power frequency voltage to control the third secondary-side switching transistor Q₃ and the seventh secondary-side switching transistor Q₇ to be in an on-state, and when the second cycle drive signal formation unit forms the drive signal for driving the second cycloconverter module 4112, maintain the fourth secondary-side drive signal and the eighth secondary-side drive signal at a turn-on level during the positive half-cycle of the power frequency voltage to control the fourth secondary-side switching transistor Q₄ and the eighth secondary-side switching transistor Q₈ to be in an on-state.

In the solution of the embodiment herein, the first signal formation module forms a first intermediate signal according to the amplitude of the carrier signal and the amplitude of the first modulation signal, where the first modulation signal includes a twice-power-frequency voltage ripple component on the direct current side of the high-frequency-link micro inverter; the primary-side drive signal generation module determines, in the case where the modulation signal is the second modulation signal, a primary-side drive signal according to the carrier signal, where the primary-side drive signal is used for driving the primary-side full-bridge circuit to generate a square wave signal, and forms, in the case where the modulation signal includes the first modulation signal and the second modulation signal, a primary-side drive signal according to the carrier signal and the first intermediate signal to drive the primary-side full-bridge circuit. After the primary-side full-bridge circuit and the boost module form a voltage conversion circuit, the voltage conversion circuit may be activated to operate as the primary-side full-bridge circuit is driven by the primary-side drive signal, thereby improving the gain of the high-frequency-link micro inverter through the voltage conversion circuit. By setting the duty cycles of multiple primary-side drive signals, the gain of the voltage conversion circuit may be adjusted, thereby enabling the gain of the high-frequency-link micro inverter to be adjustable. Moreover, the twice-power-frequency power ripple in the primary-side full-bridge circuit may be transferred to the boost module, thereby suppressing the twice-power-frequency power ripple on the direct current side of the high-frequency-link micro inverter. Meanwhile, the requirements for the first capacitor connected in parallel to the signal input terminal of the high-frequency-link micro inverter can be reduced, thereby reducing the volume of the high-frequency-link micro inverter and prolonging the service life of the high-frequency-link micro inverter.

### Embodiment Four

As shown in FIG. 3, a circuit of a high-frequency-link micro inverter disclosed in the embodiment herein includes a primary-side full-bridge circuit 10, a transformer module 20, and a secondary-side conversion circuit 30. The secondary-side conversion circuit 30 is connected to the secondary-side winding Nₛ of the transformer module 20. The primary-side full-bridge circuit 10 is configured to provide a first voltage signal for the primary-side winding Nₚ of the transformer module 20. The transformer module 20 is configured to perform second-stage voltage conversion on the first voltage signal. The secondary-side conversion circuit 30 is configured to perform waveform conversion on a voltage signal output by the secondary-side winding Nₛ of the transformer module 20.

In an embodiment, the circuit of a high-frequency-link micro inverter further includes a boost module 9. As shown in FIG. 17, the boost module 9 is connected to at least one bridge arm in the primary-side full-bridge circuit 10, and the boost module 9 is configured to perform first-stage voltage conversion on an input signal provided by a voltage conversion circuit formed by the boost module 9 and the at least one bridge arm for a signal input terminal Vᵢₙ.

The high-frequency-link micro inverter may be applied to photovoltaic power generation systems. The signal input terminal Vᵢₙ of the high-frequency-link micro inverter may be connected to the output terminal of a photovoltaic (PV) panel to enable the input signal provided by the signal input terminal Vᵢₙ to be a direct-current signal. The primary-side full-bridge circuit 10 may be an H-bridge circuit. The primary-side full-bridge circuit 10 includes two bridge arms. Each bridge arm is provided with switching transistors, and the output terminal of each bridge arm is connected to the primary-side winding Nₚ of the transformer module 20. By controlling the conduction states of the switching transistors on each bridge arm, direct current inversion may be achieved so that the primary-side full-bridge circuit 10 outputs a high-frequency alternating current square wave to the primary-side winding Nₚ of the transformer module 20. The boost module 9 is connected to at least one bridge arm in the primary-side full-bridge circuit 10 so that the boost module 9 and switching transistors on the bridge arm may form a voltage conversion circuit. The voltage conversion circuit may perform first-stage voltage conversion on an input signal provided for the signal input terminal Vᵢₙ, and the formed first voltage signal is transmitted to the primary-side winding Nₚ of the transformer module 20. For example, the voltage conversion circuit may function as a first-stage boost circuit and perform boost conversion on the input signal to form the first voltage signal. The transformer module 20 performs second-stage voltage conversion on the first voltage signal input from the primary-side winding Nₚ, where the transformation ratio of the transformer module 20 may be determined according to the turns ratio of the primary-side winding Nₚ to the secondary-side winding Nₛ, and then outputs the converted signal to the secondary-side conversion circuit 30 through the secondary-side winding Nₛ. The secondary-side conversion circuit 30 performs waveform conversion on the voltage signal output from the secondary-side winding Nₛ, thereby achieving direct current inversion.

Continuing to refer to FIG. 17, the primary-side full-bridge circuit 10 includes a first bridge arm 21 and a second bridge arm 22. The first bridge arm 21 includes a first primary-side switching transistor T₁ and a second primary-side switching transistor T₂, and the second bridge arm 22 includes a third primary-side switching transistor T₃ and a fourth primary-side switching transistor T₄. The first electrode of the first primary-side switching transistor T₁ is connected to the first electrode of the second primary-side switching transistor T₂ and serves as the first terminal N1 of the first bridge arm 21, the second electrode of the first primary-side switching transistor T₁ is connected to the second electrode of the third primary-side switching transistor T₃ and serves as the first output terminal N2 of the primary-side full-bridge circuit 10, the first electrode of the third primary-side switching transistor T₃ is connected to the first electrode of the fourth primary-side switching transistor T₄ and serves as the first terminal N3 of the second bridge arm 22, and the second electrode of the second primary-side switching transistor T₂ is connected to the second electrode of the fourth primary-side switching transistor T₄ and serves as the second output terminal N4 of the primary-side full-bridge circuit 10. The boost module 9 includes a decoupling capacitor C_{d} and at least one boost inductor L_{b}. The decoupling capacitor C_{d} is connected between the first terminal N1 of the first bridge arm 21 and the first terminal N3 of the second bridge arm 22, the first output terminal N2 of the primary-side full-bridge circuit 10 is connected to the first terminal M1 of the primary-side winding Nₚ, the second output terminal N4 of the primary-side full-bridge circuit 10 is connected to the second terminal M2 of the primary-side winding Nₚ, and the boost inductor L_{b} is connected between the first output terminal N2 of the primary-side full-bridge circuit 10 and the signal input terminal Vᵢₙ and/or the boost inductor L_{b} is connected between the second output terminal N4 of the primary-side full-bridge circuit 10 and the signal input terminal Vᵢₙ.

The first primary-side switching transistor T₁ and the second primary-side switching transistor T₂ on the first bridge arm 21 may constitute the upper bridge arm of the primary-side full-bridge circuit 10, and the third primary-side switching transistor T₃ and the fourth primary-side switching transistor T₄ on the second bridge arm 22 may constitute the lower bridge arm of the primary-side full-bridge circuit 10. The first terminal N1 of the first bridge arm 21 may serve as the first terminal of the primary-side full-bridge circuit 10, and the first terminal N3 of the second bridge arm 22 may serve as the second terminal of the primary-side full-bridge circuit 10. The case where the boost module 9 includes a decoupling capacitor C_{d} and one boost inductor L_{b} is illustrated in FIG. 17 as an example. The decoupling capacitor C_{d} is connected between the first terminal N1 of the first bridge arm 21 and the first terminal N3 of the second bridge arm 22. When the number of boost inductors L_{b} is one, the boost inductor L_{b} is connected between the first output terminal N2 of the primary-side full-bridge circuit 10 and the signal input terminal Vᵢₙ or the boost inductor L_{b} is connected between the second output terminal N4 of the primary-side full-bridge circuit 10 and the signal input terminal Vᵢₙ. When the number of boost inductors L_{b} is two, one boost inductor L_{b} is connected between the first output terminal N2 of the primary-side full-bridge circuit 10 and the signal input terminal Vᵢₙ, and the other boost inductor L_{b} is connected between the second output terminal N4 of the primary-side full-bridge circuit 10 and the signal input terminal Vᵢₙ. When the signal input terminal Vᵢₙ provides an input signal, if the boost inductor L_{b} is connected between the first output terminal N2 of the primary-side full-bridge circuit 10 and the signal input terminal Vᵢₙ, the third primary-side switching transistor T₃ on the lower bridge arm may be controlled to be turned on so that the first-stage voltage conversion of the input signal can be achieved through the boost inductor L_{b}, the decoupling capacitor C_{d}, the diode connected in parallel with the first primary-side switching transistor T₁, and the third primary-side switching transistor T₃. If the boost inductor L_{b} is connected between the second output terminal N4 of the primary-side full-bridge circuit 10 and the signal input terminal Vᵢₙ, the fourth primary-side switching transistor T₄ on the lower bridge arm may be controlled to be turned on so that the first-stage voltage conversion of the input signal can be achieved through the boost inductor L_{b}, the decoupling capacitor C_{d}, the diode connected in parallel with the second primary-side switching transistor T₄, and the fourth primary-side switching transistor T₄. The decoupling capacitor C_{d} outputs the first voltage signal to the primary-side full-bridge circuit 10, the primary-side full-bridge circuit 10 performs alternating current conversion on the first voltage signal and then outputs the first voltage signal to the primary-side winding Nₚ of the transformer module 20, and the transformer module 20 performs second-stage voltage conversion on the first voltage signal, thereby achieving the two-stage voltage conversion of the input signal. In addition, the direct current side of the high-frequency-link micro inverter exhibits twice-power-frequency ripples. When the boost module 9 shares the switching transistors in the primary-side full-bridge circuit 10 to form the voltage conversion circuit, the switching transistors in the primary-side full-bridge circuit 10 may be modulated by using a direct current reference waveform including twice-power-frequency ripples so that the twice-power-frequency ripples on the direct current side may be transferred to the decoupling capacitor C_{d}, thereby achieving twice-power-frequency power decoupling on the direct current side of the high-frequency-link micro inverter, suppressing the twice-power-frequency voltage ripples voltage.

For example, as shown in FIG. 17, the boost module 9 includes one boost inductor L_{b} that is a first boost inductor L_{b1}. The first boost inductor L_{b1} is connected between the first output terminal N2 of the primary-side full-bridge circuit 10 and the signal input terminal Vᵢₙ and may perform first-stage voltage conversion on the input signal when the third primary-side switching transistor T₃ is turned on. Alternatively, in other embodiments, the first boost inductor L_{b1} may also be connected between the second output terminal N4 of the primary-side full-bridge circuit 10 and the signal input terminal Vᵢₙ and may perform first-stage voltage conversion on the input signal when the fourth primary-side switching transistor T₄ is turned on.

FIG. 18 is a structural diagram of another high-frequency-link micro inverter according to an embodiment of the present application. As shown in FIG. 18, the boost module 9 includes a first boost inductor L_{b1} and a second boost inductor L_{b2}. The first boost inductor L_{b1} is connected between the signal input terminal Vᵢₙ and the first output terminal N2 of the primary-side full-bridge circuit 10, and the second boost inductor L_{b2} is connected between the signal input terminal Vᵢₙ and the second output terminal N4 of the primary-side full-bridge circuit 10.

When the boost module 9 includes both the first boost inductor L_{b1} and the second boost inductor L_{b2}, the first boost inductor L_{b1} and the second boost inductor L_{b2} are connected between the signal input terminal Vᵢₙ and the first output terminal N2 of the primary-side full-bridge circuit 10 and between the signal input terminal Vᵢₙ and the second output terminal N4 of the primary-side full-bridge circuit 10, respectively, the first boost inductor L_{b1} may perform first-stage voltage conversion on the input signal when the third primary-side switching transistor T₃ is turned on, and the second boost inductor L_{b2} may perform first-stage voltage conversion on the input signal when the fourth primary-side switching transistor T₄ is turned on. At this point, the voltage conversion circuit features two voltage conversion loops, thereby improving the equivalent switching frequency of the voltage conversion circuit. In the case where the voltage transformation ratio of the voltage conversion circuit is required to remain unchanged, the volume and weight of the boost inductor L_{b} can be reduced compared with the case where only one boost inductor L_{b} is set, thereby facilitating the reduction in the volume and weight of the high-frequency-link micro inverter.

Continuing to refer to FIGS. 17 and 18, the first electrode of the decoupling capacitor C_{d} is connected to the first terminal N1 of the first bridge arm 21, and the second electrode of the decoupling capacitor C_{d} is connected to the first terminal N3 of the second bridge arm 22.

The first electrode of the decoupling capacitor C_{d} is connected to the first terminal N1 of the first bridge arm 21, and the second electrode of the decoupling capacitor C_{d} is connected to the first terminal N3 of the second bridge arm 22. In this case, the voltage conversion circuit composed of the decoupling capacitor C_{d}, the boost inductor L_{b}, and the switching transistors in the primary-side full-bridge circuit 10 is a boost circuit or an interleaved parallel boost circuit. The voltage conversion circuit may boost the input voltage to achieve the first-stage voltage conversion.

FIG. 19 is a structural diagram of another high-frequency-link micro inverter according to an embodiment of the present application. As shown in FIG. 19, the high-frequency-link micro inverter further includes a first capacitor Cᵢₙ. The first electrode of the first capacitor Cᵢₙ and the first electrode of the decoupling capacitor C_{d} are connected to the signal input terminal Vᵢₙ, the second electrode of the decoupling capacitor C_{d} is connected to the first terminal N1 of the first bridge arm 21, and the second electrode of the first capacitor Cᵢₙ is connected to the first terminal N3 of the second bridge arm 22.

The first capacitor Cᵢₙ and the decoupling capacitor C_{d} may be connected in series between the first terminal N1 of the first bridge arm 21 and the first terminal N3 of the second bridge arm 22, and the connection node of the first capacitor Cᵢₙ and the decoupling capacitor C_{d} is connected to the signal input terminal Vᵢₙ. When the signal input terminal Vᵢₙ provides an input signal, the input signal passes through the boost inductor L_{b} and the switching transistors in the primary-side full-bridge circuit 10 and then is divided by the first capacitor Cᵢₙ and the decoupling capacitor C_{d} so that the voltage conversion circuit composed of the decoupling capacitor C_{d}, the first capacitor Cᵢₙ, the boost inductor L_{b}, and the switching transistors in the primary-side full-bridge circuit 10 becomes a buck-boost circuit. In this manner, the capacitance ratio of the first capacitor Cᵢₙ to the decoupling capacitor C_{d} may be adjusted as required, and the voltage transformation ratio of the voltage conversion circuit may be adjusted, thereby further improving the gain adjustability of the high-frequency-link micro inverter.

FIG. 20 is a structural diagram of another high-frequency-link micro inverter according to an embodiment of the present application. As shown in FIG. 20, the second electrode of the decoupling capacitor C_{d} is connected to the first terminal N3 of the second bridge arm 22, and the second electrode of the first capacitor Cᵢₙ is connected to the first terminal N1 of the first bridge arm 21.

FIG. 20 differs from FIG. 19 in the series order of the first capacitor Cᵢₙ and the decoupling capacitor C_{d}. In FIG. 20, the voltage conversion circuit composed of the decoupling capacitor C_{d}, the first capacitor Cᵢₙ, the boost inductor L_{b}, and the switching transistors in the primary-side full-bridge circuit 20 is also a buck-boost circuit, and the voltage transformation ratio of the voltage conversion circuit may be adjusted by adjusting the capacitance ratio of the first capacitor Cᵢₙ to the decoupling capacitor C_{d}, thereby further improving the gain adjustability of the high-frequency-link micro inverter.

It is to be noted that the case where the first capacitor Cᵢₙ and the decoupling capacitor C_{d} are connected in series when the boost module 9 includes two boost inductors L_{b} is illustrated in FIGS. 19 and 20 as an example. In other embodiments, when the boost module 9 includes one boost inductor L_{b}, the first capacitor Cᵢₙ and the decoupling capacitor C_{d} may also be set to be connected in series, and at this point, the decoupling capacitor C_{d}, the first capacitor Cᵢₙ, the boost inductor L_{b}, and the switching transistors in the primary-side full-bridge circuit 10 may also form a buck-boost circuit, which will not be repeated herein.

Continuing to refer to FIGS. 17 to 20, the transformer module 20 includes two secondary-side windings Nₛ, and the secondary-side conversion circuit 30 includes two cycloconverter circuits 41. Each of the secondary-side windings Nₛ is connected to a respective one of the cycloconverter circuits 41, and each cycloconverter circuit is used for performing waveform conversion on the voltage during the half-cycle.

The transformer module 20 may be a single three-winding high-frequency transformer. The primary-side side of the transformer has a single primary-side winding Nₚ, the secondary-side side of the transformer has two secondary-side windings Nₛ, and each secondary-side winding Nₛ is correspondingly connected to one cycloconverter circuit 41. In the modulation process, the two cycloconverter circuits 41 may be controlled to operate in the positive half-cycle and the negative half-cycle of the modulation cycle, respectively, so that the voltage signal can be modulated in the whole modulation cycle, thereby improving the voltage utilization rate of the high-frequency-link micro inverter.

In other embodiments, the transformer module 20 may be set to include a first transformer and a second transformer, and the secondary-side conversion circuit 30 may be set to include two cycloconverter circuits. The primary-side full-bridge circuit 10 is connected to the primary-side winding of the first transformer and the primary-side winding of the second transformer, the secondary-side winding of the first transformer and the secondary-side winding of the second transformer are each connected to a respective one of the cycloconverter circuits, and each cycloconverter circuit is configured to perform waveform conversion on the voltage during a corresponding half-cycle.

The first terminal of the primary-side winding of the first transformer and the first terminal of the primary-side winding of the second transformer may both be connected to the first output terminal of the primary-side full-bridge circuit, the second terminal of the primary-side winding of the first transformer and the second terminal of the primary-side winding of the second transformer may both be connected to the second output terminal of the primary-side full-bridge circuit, and the first terminal of the primary-side winding of the first transformer and the second terminal of the primary-side winding of the second transformer are dotted terminals. The secondary-side winding of the first transformer is connected to one cycloconverter circuit, and the secondary-side winding of the second transformer is connected to the other cycloconverter circuit. In the modulation process, the voltage signal can also be modulated in the whole modulation cycle by controlling the two cycloconverter circuits to operate in the positive half-cycle and the negative half-cycle of the modulation cycle, respectively, thereby improving the voltage utilization rate of the high-frequency-link micro inverter.

Continuing to refer to FIGS. 17 to 20, the cycloconverter circuit 41 includes a cycloconverter module 411 and a filter module 412. The first input terminal of the cycloconverter module 411 is connected to the first terminal of the secondary-side winding Nₛ, the output terminal of the cycloconverter module 411 is connected to the first input terminal of the filter module 412, the output terminal of the filter module 412 serves as the single-phase output terminal of the high-frequency-link micro inverter, and the second terminal of the secondary-side winding Nₛ, the second input terminal of the cycloconverter module 411, and the second input terminal of the filter module 412 are connected to the ground terminal n. The terminal of the secondary-side winding Nₛ and the first terminal of the primary-side winding Nₚ are dotted terminals.

The two cycloconverter modules 411 may be a first cycloconverter module 4111 and a second cycloconverter module 4112, respectively. The output terminal a of the first cycloconverter module 4111 is connected to the first input terminal of the corresponding filter module 412, and the output terminal of the filter module 412 serves as the first single-phase output terminal A of the high-frequency-link micro inverter. Similarly, the output terminal b of the second cycloconverter module 4112 is connected to the first input terminal of the corresponding filter module 412, and the output terminal of the filter module 412 serves as the second single-phase output terminal B of the high-frequency-link micro inverter. When the terminal of the secondary-side winding Nₛ and the first terminal of the primary-side winding Nₚ are dotted terminals, the first cycloconverter module 4111 may perform voltage modulation during the positive half-cycle of the modulation cycle, the second cycloconverter module 4112 may perform voltage modulation during the negative half-cycle of the modulation cycle, and the filter modules 412 connected to the cycloconverter modules 411 perform waveform conversion on the modulated voltage, thereby achieving direct current inversion.

Continuing to refer to FIGS. 17 to 20, the cycloconverter module 411 includes a first secondary-side switching transistor, a second secondary-side switching transistor, a third secondary-side switching transistor, and a fourth secondary-side switching transistor. The first electrode of the first secondary-side switching transistor serves as the first input terminal of the cycloconverter module 411, the second electrode of the first secondary-side switching transistor is connected to the first electrode of the second secondary-side switching transistor, the second electrode of the second secondary-side switching transistor is connected to the first electrode of the third secondary-side switching transistor and serves as the output terminal of the cycloconverter module 411, the second electrode of the third secondary-side switching transistor is connected to the first electrode of the fourth secondary-side switching transistor, and the second electrode of the fourth secondary-side switching transistor serves as the second input terminal of the cycloconverter module 411. The filter module 412 includes a filter inductor and a filter capacitor. The first terminal of the filter inductor serves as the first input terminal of the filter module 412, the second terminal of the filter inductor is connected to the first electrode of the filter capacitor and serves as the output terminal of the filter module 412, and the second electrode of the filter capacitor serves as the second input terminal of the filter module 412.

When the two cycloconverter modules 411 are the first cycloconverter module 4111 and the second cycloconverter module 4112, respectively, there are correspondingly two filter modules 412, that is, a first filter module 4121 and a second filter module 4122. The first filter module 4121 includes a first filter inductor L_{f1} and a first filter capacitor Cₒ₁, and the second filter module 4122 includes a second filter inductor L_{f2} and a second filter capacitor Cₒ₂. The first to fourth secondary-side switching transistors in the first cycloconverter module 4111 are denoted as Q₁, Q₂, Q₃, and Q₄, respectively, and the first to fourth secondary-side switching transistors in the second cycloconverter module 4112 are denoted as Q₅, Q₆, Q₈, and Q₇, respectively. The first electrode of the first secondary-side switching transistor Q₁ in the first cycloconverter module 4111 serves as the first input terminal of the first cycloconverter module 4111 and is connected to the first terminal of the first secondary-side winding Nₛ₁, and the first electrode of the fifth secondary-side switching transistor Q₅ in the second cycloconverter module 4112 serves as the first input terminal of the second cycloconverter module 4112 and is connected to the first terminal of the second secondary-side winding Nₛ₂. The second electrode of the second secondary-side switching transistor Q₂ in the first cycloconverter module 4111 serves as the output terminal a of the first cycloconverter module 4111 and is connected to the first terminal of the first filter inductor L_{f1}, and the second terminal of the first filter inductor L_{f1} is connected to the first electrode of the first filter capacitor Cₒ₁ and serves as the first single-phase output terminal A of the high-frequency-link micro inverter. Similarly, the second electrode of the second secondary-side switching transistor Q₆ in the second cycloconverter module 4112 serves as the output terminal b of the second cycloconverter module 4112 and is connected to the first terminal of the second filter inductor L_{f2}, and the second terminal of the second filter inductor L_{f2} is connected to the first electrode of the second filter capacitor Cₒ₂ and serves as the second single-phase output terminal B of the high-frequency-link micro inverter. The second electrode of the fourth secondary-side switching transistor Q₄ in the first cycloconverter module 4111, the second electrode of the fourth secondary-side switching transistor Q₇ in the second cycloconverter module 4112, the second electrode of the first filter capacitor Cₒ₁, and the second electrode of the second filter capacitor Cₒ₂ are connected to the ground terminal n.

In the modulation process of the high-frequency-link micro inverter, the first cycloconverter module 4111 may be controlled to operate during the positive half-cycle of the modulation cycle so that the electrical signal output by the transformer module 20 is modulated through the first cycloconverter module 4111 and then goes through waveform conversion through the first filter module 4121 to complete the modulation of the electrical signal during the positive half-cycle. The second cycloconverter module 4112 may be controlled to operate during the negative half-cycle of the modulation cycle so that the electrical signal output by the transformer module 20 is modulated through the second cycloconverter module 4112 and then goes through waveform conversion through the second filter module 4122 to complete the modulation of the electrical signal during the negative half-cycle.

In addition, the high-frequency-link micro inverter provided in the embodiment of the present application exhibits voltage source characteristics and may be applied to both grid-connected and off-grid systems. That is, the output terminal of the high-frequency-link micro inverter may be connected to loads to achieve loaded operation, and the output terminal of the high-frequency-link micro inverter may also be connected to the grid to achieve grid-connected operation. The high-frequency-link micro inverter has two cycloconverter circuits 41 so that the high-frequency-link micro inverter has a phase-split output structure. When the high-frequency-link micro inverter is applied to off-grid systems, different single-phase output terminals of the high-frequency-link micro inverter may be loaded separately or simultaneously and may simultaneously output two voltage levels, that is, the voltage of the first single-phase output terminal A or the second single-phase output terminal B to the ground terminal n and the voltage between the first single-phase output terminal A and the second single-phase output terminal B. The amplitude of the voltage of the first single-phase output terminal A or the second single-phase output terminal B to the ground terminal n equals half of the amplitude of the voltage between the first single-phase output terminal A and the second single-phase output terminal B.

### Embodiment Five

### Example 1

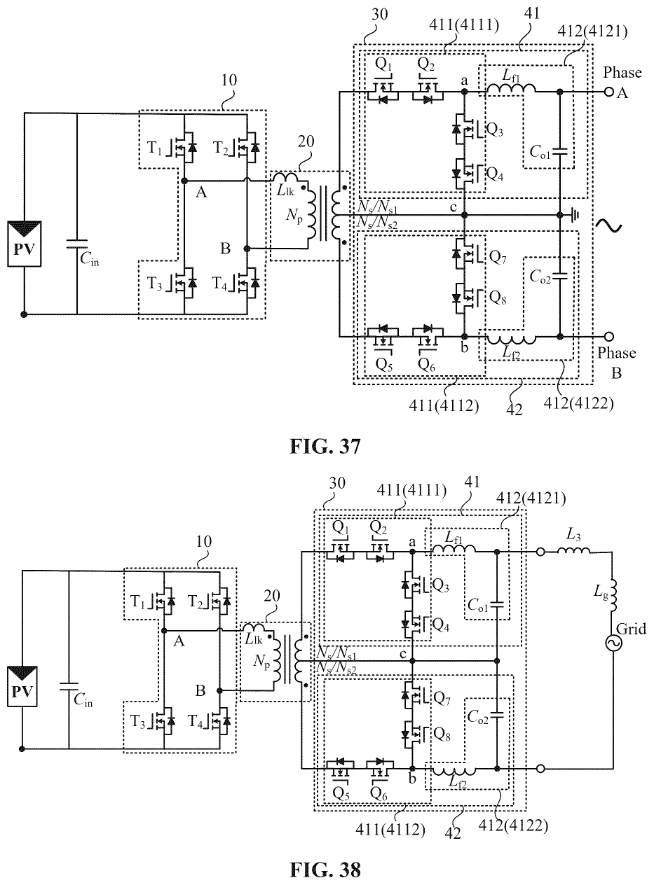

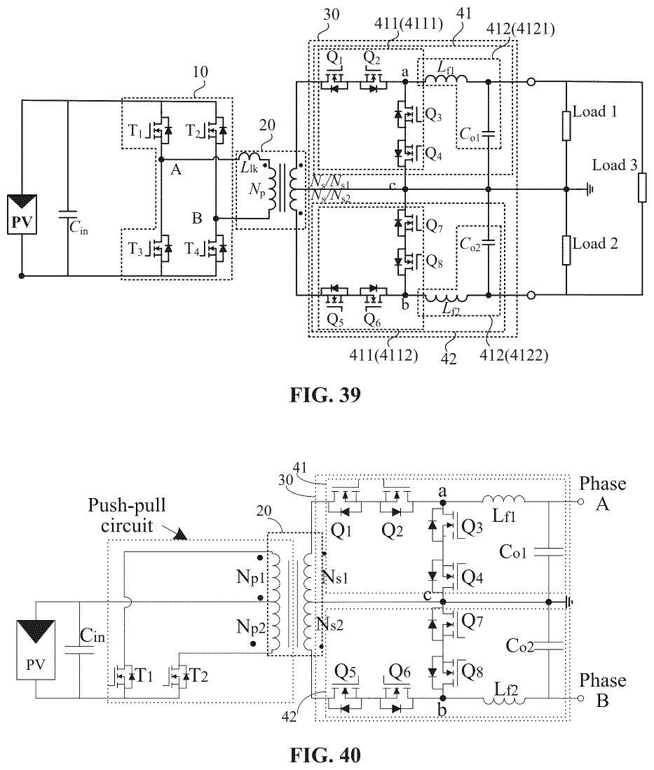

As shown in FIG. 37, the embodiment of the present application further provides a high-frequency-link micro inverter. The input of the photovoltaic (PV) panel passes through the first capacitor Cᵢₙ and then is connected to the primary-side full-bridge circuit 10, and the output is connected to the transformer module 20 for boosting. The input is input to the primary-side winding Nₚ of the transformer module 20, and the output is output from two secondary-side windings (which are defined as the first secondary-side winding Nₛ₁ and the second secondary-side winding Nₛ₂, respectively) on the secondary-side side of the transformer module 20. The output at one terminal of each of the two secondary-side windings is shorted together, and the other terminal and the first terminal of the primary-side winding are dotted terminals. The outputs from the two secondary-side windings are each connected to one half-wave cycloconverter circuit of the secondary-side conversion circuit 30, filtered by the LC filter, and then connected to the grid or loaded separately. In the embodiment herein, the two secondary-side windings have the same number of turns, and the secondary-side conversion circuit 30 employs a combination of two half-wave cycloconverter circuits (that is, the first cycloconverter circuit 41 and the second cycloconverter circuit 42, respectively) so that the positive and negative half-cycle energy of a high-frequency square wave (or an alternating current wave such as a triangular wave or a sine wave) from the primary-side winding Nₚ may be transferred to the output side, thereby improving the voltage utilization rate.

Moreover, the two half-wave cycloconverter circuits of the secondary-side conversion circuit 30 constitute a new split-phase output structure. In such a structure, the first cycloconverter circuit 41 includes the first cycloconverter module 4111 and the first filter module 4121, the second cycloconverter circuit 42 includes the second cycloconverter module 4112 and the second filter module 4122, the first filter capacitor Cₒ₁ and the second filter capacitor Cₒ₂ of the LC filter may be loaded separately or collectively, and the output voltage may be naturally balanced. In the conventional full-bridge high-frequency-link inverter, to achieve balanced split-phase voltage output, an additional third bridge arm needs to be added to control the neutral current, resulting in an increase in the complexity and costs of the topology. In the topology herein, the neutral line current may be controlled by using the third secondary-side switching transistor Q₃, the fourth secondary-side switching transistor Q₄, the seventh secondary-side switching transistor Q₇, and the eighth secondary-side switching transistor Q₈ without additional switching devices, thereby achieving the balance of two-phase output voltages.

During the positive half-cycle of the power frequency voltage, a turn-on command is sent to the first secondary-side switching transistor Q₁ and the sixth secondary-side switching transistor Q₆ to maintain the two secondary-side switching transistors always on, and a turn-off command is sent to the second secondary-side switching transistor Q₂ and the fifth secondary-side switching transistor Q₅ to maintain the two secondary-side switching transistors always off. During the positive half-cycle of the switch cycle, a turn-off command is sent to the third secondary-side switching transistor Q₃ and the fourth secondary-side switching transistor Q₄, and a turn-on command is sent to the seventh secondary-side switching transistor Q₇ and the eighth secondary-side switching transistor Q₈. When the output voltage v_{AB} of the primary-side full-bridge circuit is positive, the output voltage v_{ac} of the first cycloconverter module 4111 is positive, and energy is output to the grid from the first secondary-side winding Nₛ₁. When the output voltage v_{AB} of the primary-side full-bridge circuit 10 is zero, the secondary-side current freewheels along the first secondary-side switching transistor Q₁, the anti-parallel diode of the second secondary-side switching transistor Q₂, the eighth secondary-side switching transistor Q₈, the seventh secondary-side switching transistor Q₇, and the first secondary-side winding Nₛ₁. During the negative half-cycle of the switch cycle, a turn-off command is sent to the seventh secondary-side switching transistor Q₇ and the eighth secondary-side switching transistor Q₈, and a turn-on command is sent to the third secondary-side switching transistor Q₃ and the fourth secondary-side switching transistor Q₄. When the output voltage v_{AB} of the primary-side full-bridge circuit is negative, the output voltage v_{cb} of the second cycloconverter module 4112 is positive, and energy is output to the grid from the second secondary-side winding Nₛ₂. When the output voltage v_{AB} of the primary-side full-bridge circuit 10 is zero, the secondary-side current freewheels along the fourth secondary-side switching transistor Q₄, the third secondary-side switching transistor Q₃, the sixth secondary-side switching transistor Q₆, the anti-parallel diode of the fifth secondary-side switching transistor Q₅, and the second secondary-side winding Nₛ₂.

During the negative half-cycle of the power frequency voltage, a turn-off command is sent to the first secondary-side switching transistor Q₁ and the sixth secondary-side switching transistor Q₆ to maintain the two secondary-side switching transistors always off, and a turn-on command is sent to the second secondary-side switching transistor Q₂ and the fifth secondary-side switching transistor Q₅ to maintain the two secondary-side switching transistors always on. During the positive half-cycle of the switch cycle, a turn-off command is sent to the seventh secondary-side switching transistor Q₇ and the eighth secondary-side switching transistor Q₈, and a turn-on command is sent to the third secondary-side switching transistor Q₃ and the fourth secondary-side switching transistor Q₄. When the output voltage v_{AB} of the primary-side full-bridge circuit is positive, v_{cb} is negative, and energy is output to the grid from the second secondary-side winding Nₛ₂. When the output voltage v_{AB} of the primary-side full-bridge circuit 10 is zero, the secondary-side current freewheels along the fifth secondary-side switching transistor Q₅, the anti-parallel diode of the sixth secondary-side switching transistor Q₆, the third secondary-side switching transistor Q₃, the fourth secondary-side switching transistor Q₄, and the second secondary-side winding Nₛ₂. During the negative half-cycle of the switch cycle, a turn-off command is sent to the third secondary-side switching transistor Q₃ and the fourth secondary-side switching transistor Q₄, and a turn-on command is sent to the seventh secondary-side switching transistor Q₇ and the eighth secondary-side switching transistor Q₈. When the output voltage v_{AB} of the primary-side full-bridge circuit is negative, v_{cb} is negative, and energy is output to the grid from the first secondary-side winding Nₛ₁. When the output voltage v_{AB} of the primary-side full-bridge circuit 10 is zero, the secondary-side current freewheels along the seventh secondary-side switching transistor Q₇, the eighth secondary-side switching transistor Q₈, the second secondary-side switching transistor Q₂, the anti-parallel diode of the first secondary-side switching transistor Q₁, and the first secondary-side winding Nₛ₁.

In addition to the H-bridge conversion topology shown in FIG. 37, the conversion topology of the primary-side side may also employ other forms of conversion topologies, such as a half-bridge topology or a push-pull circuit shown in FIG. 40.

### Example 2

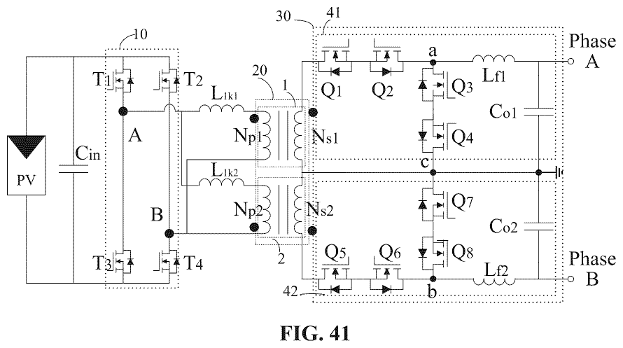

As shown in FIG. 41, the high-frequency-link micro inverter disclosed in the embodiment herein is different from that in Example 1 in that, in the embodiment herein, a first transformer module 1 and a second transformer module 2 that are independent of each other are in the transformer module 20 and the high-frequency square wave output from the primary-side full-bridge circuit 10 is simultaneously loaded on the primary-side windings of the first transformer module 1 and the second transformer module 2. The secondary-side winding Nₛ₁ of the first transformer module 1 has one terminal shorted to one terminal of the secondary-side winding Nₛ₂ of the second transformer module 2, the other terminal of the secondary-side winding of the first transformer module 1 and the first terminal of the primary-side winding of the first transformer module 1 are dotted terminals, and the other terminal of the secondary-side winding of the second transformer module 2 and the second terminal of the primary-side winding of the second transformer module 2 are dotted terminals. The outputs from the secondary-side windings of the first transformer module 1 and the second transformer module 2 are each connected to one half-wave cycloconverter circuit of the secondary-side conversion circuit 30, filtered by the LC filter, and then connected to the grid or loaded separately.

Other structures and operating principles thereof in the embodiment herein are the same as those in Example 1, and the details are not repeated herein. This listing of the claims replaces all others previously submitted in this application:

1. A high-frequency-link micro inverter, comprising a primary-side full-bridge circuit, a transformer module, and a secondary-side conversion circuit;
wherein the primary-side full-bridge circuit is connected to a primary-side winding of the transformer module, and the primary-side full-bridge circuit is configured to provide a first voltage signal for the primary-side winding of the transformer module; the transformer module is configured to perform second-stage voltage conversion on the first voltage signal; the secondary-side conversion circuit is connected to a secondary-side winding of the transformer module, and the secondary-side conversion circuit is configured to perform waveform conversion on a voltage signal output by the secondary-side winding of the transformer module.

2. The high-frequency-link micro inverter according to claim 1, further comprising a boost module, wherein the boost module is connected to at least one bridge arm in the primary-side full-bridge circuit to form a voltage conversion circuit, and the boost module is configured to perform first-stage voltage conversion on an input signal provided by the voltage conversion circuit for a signal input terminal.

3. The high-frequency-link micro inverter according to claim 2, wherein the at least one bridge arm comprises a first bridge arm and a second bridge arm; the first bridge arm comprises a first primary-side switching transistor and a second primary-side switching transistor, and the second bridge arm comprises a third primary-side switching transistor and a fourth primary-side switching transistor; a first electrode of the first primary-side switching transistor is connected to a first electrode of the second primary-side switching transistor and serves as a first terminal of the first bridge arm, a second electrode of the first primary-side switching transistor is connected to a second electrode of the third primary-side switching transistor and serves as a first output terminal of the primary-side full-bridge circuit, a first electrode of the third primary-side switching transistor is connected to a first electrode of the fourth primary-side switching transistor and serves as a first terminal of the second bridge arm, and a second electrode of the second primary-side switching transistor is connected to a second electrode of the fourth primary-side switching transistor and serves as a second output terminal of the primary-side full-bridge circuit;
the boost module comprises a decoupling capacitor and at least one boost inductor; the decoupling capacitor is connected between the first terminal of the first bridge arm and the first terminal of the second bridge arm, the first output terminal of the primary-side full-bridge circuit is connected to a first terminal of the primary-side winding, the second output terminal of the primary-side full-bridge circuit is connected to a second terminal of the primary-side winding, and at least one of the following is satisfied: the boost inductor is connected between the first output terminal of the primary-side full-bridge circuit and the signal input terminal or the boost inductor is connected between the second output terminal of the primary-side full-bridge circuit and the signal input terminal.

4. The high-frequency-link micro inverter according to claim 1, wherein the transformer module comprises two secondary-side windings, and the secondary-side conversion circuit comprises two cycloconverter circuits that are a first cycloconverter circuit and a second cycloconverter circuit, respectively; each of the secondary-side windings is connected to a respective one of the cycloconverter circuits, and each of the cycloconverter circuits is configured to perform waveform conversion on the voltage signal during a corresponding half-cycle.

5. The high-frequency-link micro inverter according to claim 1, wherein the transformer module comprises a first transformer and a second transformer, and the secondary-side conversion circuit comprises two cycloconverter circuits that are a first cycloconverter circuit and a second cycloconverter circuit, respectively; the primary-side full-bridge circuit is connected to a primary-side winding of the first transformer and a primary-side winding of the second transformer, a secondary-side winding of the first transformer and a secondary-side winding of the second transformer are each connected to a respective one of the cycloconverter circuits, and each of the cycloconverter circuits is configured to perform waveform conversion on the voltage signal during a corresponding half-cycle.

6. The high-frequency-link micro inverter according to claim 4, wherein the first cycloconverter circuit comprises a first cycloconverter module and a first filter module, and the second cycloconverter circuit comprises a second cycloconverter module and a second filter module;
a first input terminal of the first cycloconverter module is connected to a first terminal of one of the secondary-side windings, an output terminal of the first cycloconverter module is connected to a first input terminal of the first filter module, an output terminal of the first filter module serves as one single-phase output terminal of the high-frequency-link micro inverter, and a second terminal of the one of the secondary-side windings, a second input terminal of the first cycloconverter module, and a second input terminal of the first filter module are grounded;
a first input terminal of the second cycloconverter module is connected to a first terminal of the other of the secondary-side windings, an output terminal of the second cycloconverter module is connected to a first input terminal of the second filter module, an output terminal of the second filter module serves as another single-phase output terminal of the high-frequency-link micro inverter, and a second terminal of the other of the secondary-side windings, a second input terminal of the second cycloconverter module, and a second input terminal of the second filter module are grounded;
wherein a first terminal of a secondary-side winding of the secondary-side windings and a first terminal of a primary-side winding of the primary-side windings are dotted terminals.

7. The high-frequency-link micro inverter according to claim 6, wherein the first cycloconverter module comprises a first secondary-side switching transistor, a second secondary-side switching transistor, a third secondary-side switching transistor, and a fourth secondary-side switching transistor; a first electrode of the first secondary-side switching transistor serves as the first input terminal of the first cycloconverter module, a second electrode of the first secondary-side switching transistor is connected to a first electrode of the second secondary-side switching transistor, a second electrode of the second secondary-side switching transistor is connected to a first electrode of the third secondary-side switching transistor and serves as the output terminal of the first cycloconverter module, a second electrode of the third secondary-side switching transistor is connected to a first electrode of the fourth secondary-side switching transistor, and a second electrode of the fourth secondary-side switching transistor serves as the second input terminal of the first cycloconverter module; the second cycloconverter module comprises a fifth secondary-side switching transistor, a sixth secondary-side switching transistor, a seventh secondary-side switching transistor, and an eighth secondary-side switching transistor; a first electrode of the fifth secondary-side switching transistor serves as the first input terminal of the second cycloconverter module, a second electrode of the fifth secondary-side switching transistor is connected to a first electrode of the sixth secondary-side switching transistor, a second electrode of the sixth secondary-side switching transistor is connected to a first electrode of the eighth secondary-side switching transistor and serves as the output terminal of the second cycloconverter module, a second electrode of the eighth secondary-side switching transistor is connected to a first electrode of the seventh secondary-side switching transistor, and a second electrode of the seventh secondary-side switching transistor serves as the second input terminal of the second cycloconverter module;
the first filter module comprises a first filter inductor and a first filter capacitor; a first terminal of the first filter inductor serves as the first input terminal of the first filter module, a second terminal of the first filter inductor is connected to a first electrode of the first filter capacitor and serves as the output terminal of the first filter module, and a second electrode of the first filter capacitor serves as the second input terminal of the first filter module;
the second filter module comprises a second filter inductor and a second filter capacitor; a first terminal of the second filter inductor serves as the first input terminal of the second filter module, a second terminal of the second filter inductor is connected to a first electrode of the second filter capacitor and serves as the output terminal of the second filter module, and a second electrode of the second filter capacitor serves as the second input terminal of the second filter module.

8. A signal modulation method for a high-frequency-link micro inverter, applied to the high-frequency-link micro inverter and comprising:
forming an intermediate signal according to a carrier signal and a modulation signal;
obtaining a reference signal according to the carrier signal; and
forming a drive signal according to the carrier signal, the reference signal, and the intermediate signal, wherein the drive signal is used for driving a primary-side full-bridge circuit and a secondary-side conversion circuit to cause the high-frequency-link micro inverter to output at least a two-phase alternating-current voltage.

9. The method according to claim 8, wherein in response to the modulation signal being a second modulation signal, the intermediate signal is a second intermediate signal, and forming the drive signal according to the carrier signal, the reference signal, and the intermediate signal comprises:
determining a primary-side drive signal according to the carrier signal, wherein the primary-side drive signal is used for driving the primary-side full-bridge circuit to generate a square wave signal; and
forming a secondary-side drive signal according to the reference signal and the second intermediate signal, wherein the secondary-side drive signal is used for driving the secondary-side conversion circuit to perform waveform conversion on a voltage output by a transformer module.

10. The method according to claim 8, wherein in response to the modulation signal comprising a first modulation signal and a second modulation signal, the intermediate signal comprises a first intermediate signal and a second intermediate signal, and forming the intermediate signal according to the carrier signal and the modulation signal comprises:
forming the first intermediate signal according to an amplitude of the carrier signal and an amplitude of the first modulation signal, wherein the first modulation signal comprises a twice-power-frequency voltage ripple component on a direct current side of the high-frequency-link micro inverter; and
forming the second intermediate signal according to the amplitude of the carrier signal and an amplitude of the second modulation signal.

11. The method according to claim 8, wherein obtaining the reference signal according to the carrier signal comprises:
obtaining the reference signal by performing a frequency division by two on a rising edge of the carrier signal.

12. The method according to claim 10, wherein forming the drive signal according to the carrier signal, the reference signal, and the intermediate signal comprises:
forming a primary-side drive signal according to the reference signal and the first intermediate signal to drive the primary-side full-bridge circuit; and
forming a secondary-side drive signal according to the reference signal and the second intermediate signal to drive the secondary-side conversion circuit.

13. The method according to claim 9, wherein
determining the primary-side drive signal of the primary-side full-bridge circuit according to the carrier signal comprises:
performing a frequency division by two on a rising edge of the carrier signal to obtain a first primary-side drive signal and a fourth primary-side drive signal of the primary-side full-bridge circuit;
inverting the first primary-side drive signal to obtain a third primary-side drive signal; and
inverting the fourth primary-side drive signal to obtain a second primary-side drive signal;
wherein the first primary-side drive signal is used for driving a first primary-side switching transistor of the primary-side full-bridge circuit, the second primary-side drive signal is used for driving a second primary-side switching transistor of the primary-side full-bridge circuit, the third primary-side drive signal is used for driving a third primary-side switching transistor of the primary-side full-bridge circuit, and the fourth primary-side drive signal is used for driving a fourth primary-side switching transistor of the primary-side full-bridge circuit.

14. The method according to claim 12, wherein
forming the primary-side drive signal according to the reference signal and the first intermediate signal comprises:
performing a logical operation on the reference signal and the first intermediate signal to form a drive signal for driving a second bridge arm; and
performing a logical operation on the drive signal for driving the second bridge arm to form a drive signal for driving a first bridge arm.

15. The method according to claim 14, wherein at least one of the following is satisfied:
performing the logical operation on the reference signal and the first intermediate signal to form the drive signal for driving the second bridge arm comprises:
performing a logical AND operation on the reference signal and the first intermediate signal to form a third primary-side drive signal to drive a third primary-side switching transistor; and
inverting the reference signal, and performing a logical AND operation on the inverted reference signal and the first intermediate signal to form a fourth primary-side drive signal to drive a fourth primary-side switching transistor; or
performing the logical operation on the drive signal for driving the second bridge arm to form the drive signal for driving the first bridge arm comprises:
inverting the third primary-side drive signal to form a first primary-side drive signal to drive a first primary-side switching transistor; and
inverting the fourth primary-side drive signal to form a second primary-side drive signal to drive a second primary-side switching transistor.

16. The method according to claim 9, wherein
forming the secondary-side drive signal according to the reference signal and the second intermediate signal comprises:
inverting the second intermediate signal to obtain an inverted intermediate signal;
performing a logical operation on the second intermediate signal, the inverted intermediate signal, and the reference signal to form a drive signal for driving a first cycloconverter module;
inverting the reference signal to obtain an inverted reference signal; and
performing a logical operation on the second intermediate signal, the inverted intermediate signal, the inverted reference signal, and the reference signal to form a drive signal for driving a second cycloconverter module.

17. The method according to claim 16, wherein
performing the logical operation on the second intermediate signal, the inverted intermediate signal, and the reference signal to form the drive signal for driving the first cycloconverter module comprises:
performing a logical AND operation on the inverted intermediate signal and the reference signal, and inverting a logical AND operation result to generate a first secondary-side drive signal, wherein the first secondary-side drive signal is used for driving a first secondary-side switching transistor during a positive half-cycle of a power frequency voltage, and the first secondary-side drive signal is used for driving a second secondary-side switching transistor during a negative half-cycle of the power frequency voltage;
performing a logical AND operation on the second intermediate signal and the reference signal to form a second secondary-side drive signal, wherein the second secondary-side drive signal is used for driving the second secondary-side switching transistor during the positive half-cycle of the power frequency voltage, and the second secondary-side drive signal is used for driving the first secondary-side switching transistor during the negative half-cycle of the power frequency voltage; and
performing a logical AND operation on the second intermediate signal and the reference signal, and inverting a logical AND operation result to form a third secondary-side drive signal and a fourth secondary-side drive signal, wherein the third secondary-side drive signal is used for driving a third secondary-side switching transistor during the positive half-cycle of the power frequency voltage, and the fourth secondary-side drive signal is used for driving a fourth secondary-side switching transistor during the negative half-cycle of the power frequency voltage.

18. The method according to claim 17, wherein
performing the logical operation on the second intermediate signal, the inverted intermediate signal, the inverted reference signal, and the reference signal to form the drive signal for driving the second cycloconverter module comprises:
performing a logical AND operation on the inverted reference signal and the second intermediate signal to form a fifth secondary-side drive signal, wherein the fifth secondary-side drive signal is used for driving a fifth secondary-side switching transistor during the positive half-cycle of the power frequency voltage, and the fifth secondary-side drive signal is used for driving a sixth secondary-side switching transistor during the negative half-cycle of the power frequency voltage;
performing a logical AND operation on the inverted intermediate signal and the inverted reference signal to form a sixth secondary-side drive signal, wherein the sixth secondary-side drive signal is used for driving the sixth secondary-side switching transistor during the positive half-cycle of the power frequency voltage, and the sixth secondary-side drive signal is used for driving the fifth secondary-side switching transistor during the negative half-cycle of the power frequency voltage; and
performing a logical AND operation on the inverted reference signal and the second intermediate signal, and inverting a logical AND operation result to form a seventh secondary-side drive signal and an eighth secondary-side drive signal, wherein the seventh secondary-side drive signal is used for driving a seventh secondary-side switching transistor during the positive half-cycle of the power frequency voltage, and the eighth secondary-side drive signal is used for driving an eighth secondary-side switching transistor during the negative half-cycle of the power frequency voltage.

19. The method according to claim 18, when forming the drive signal for driving the first cycloconverter module, further comprising:
maintaining the third secondary-side drive signal and the seventh secondary-side drive signal at a turn-on level during the negative half-cycle of the power frequency voltage to control the third secondary-side switching transistor and the seventh secondary-side switching transistor to be in an on-state;
wherein when forming the drive signal for driving the second cycloconverter module, the method further comprises:
maintaining the fourth secondary-side drive signal and the eighth secondary-side drive signal at a turn-on level during the positive half-cycle of the power frequency voltage to control the fourth secondary-side switching transistor and the eighth secondary-side switching transistor to be in an on-state.

20. A signal modulation apparatus for a high-frequency-link micro inverter, connected to the high-frequency-link micro inverter and comprising: at least one processor; and a memory communicatively connected to the at least one processor; wherein the memory stores instructions are configured to, when executed by the at least one processor, cause the at least one processor to perform steps in the following modules:
an intermediate signal determination module, configured to form an intermediate signal according to a carrier signal and a modulation signal;
a reference signal determination module, configured to obtain a reference signal according to the carrier signal; and
a drive signal generation module, configured to generate a drive signal according to the carrier signal, the reference signal, and the intermediate signal, wherein the drive signal is used for driving a primary-side full-bridge circuit and a secondary-side conversion circuit to cause the high-frequency-link micro inverter to output at least a two-phase alternating-current voltage.
